(19) United States
(12) Patent Application Publication
(10) Pub. No.: US 2023/0299904 A1
(43) Pub. Date: Sep. 21, 2023

(54) METHOD AND DEVICE IN NODES USED FOR WIRELESS COMMUNICATIO

(71) Applicant: Xiaobo ZHANG, Shanghai (CN)

(72) Inventor: Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/136,351

(22) Filed: Apr. 19, 2023

Related U.S. Application Data
(63) Continuation of application No. PCT/CN2021/123489, filed on Oct. 13, 2021.

(30) Foreign Application Priority Data
Oct. 22, 2020 (CN) 202011137665.9
Oct. 30, 2020 (CN) 202011190796.3

(51) Int. Cl. H04L 5/00; H04L 1/1812; H04W 72/02

(52) U.S. Cl. CPC H04L 5/0046; H04L 1/1812; H04W 72/02

(57) ABSTRACT

The present application discloses a method and a device in a node for wireless communications. A first receiver receives a first signaling; a first transmitter transmits a first signal in a first radio resource pool, the first signal carries a first bit block and a second bit block; herein, the first signaling is used to determine the first radio resource pool; a first condition is a condition related to a size relation between a first number and a first threshold, and at least one of a number of bit(s) comprised in the first bit block or a number of bit(s) comprised in the second bit block is used to determine the first number; a third bit block is used to generate the first signal, the first bit block and the second bit block are used to generate the third bit block.

### CROSS REFERENCE TO RELATED APPLICATIONS

This application is the continuation of the international patent application No. PCT/CN2021/123489, filed on October 13,2021, and claims the priority benefit of Chinese Patent Application No.202011137665.9, filed on October 22,2020; and claims the priority benefit of Chinese Patent Application No. 202011190796.3, filed on October 30,2020, the full disclosure of which is incorporated herein by reference.

### BACKGROUND

### Technical Field

The present application relates to transmission methods and devices in wireless communication systems, and in particular to a method and device of radio signal transmission in a wireless communication system supporting cellular networks.

### Related Art

In a 5G system, Enhance Mobile Broadband (eMBB) and Ultra Reliable and Low Latency Communication (URLLC) are two typical service types. Targeting requirements for lower target BLER of URLLC traffic, a new Modulation and Coding Scheme (MCS) table has been defined in 3rd Generation Partner Project (3GPP) New Radio (NR) Release 15. For the purpose of supporting more demanding Ultra Reliable and Low Latency Communication (URLLC) traffics in 5G system, for example, with higher reliability (e.g., a target BLER is 10^-6) or with lower delay (e.g., 0.5-1 ms), in 3GPP NR Release 16, a DCI signaling can indicate a scheduled PDSCH is of Low Priority or High Priority, where the high Priority corresponds to URLLC traffics, and the low Priority corresponds to eMBB traffics. When a low-priority transmission overlaps with a high-priority transmission in time domain, the high-priority one is performed, and the low-priority one is dropped.

A Work Item (WI) of URLLC enhancement in NR Release 17 was approved at 3GPP RAN Plenary, where a focus of study is the multiplexing of different Intra-UE (that is, User Equipment) traffics.

### SUMMARY

After introducing the multiplexing of different intra-UE priority traffics, the UE can multiplex Uplink Control Information (UCI) with different priorities onto a Physical Uplink Control Channel (PUCCH) for transmission; how to reasonably implement the multiplexing according to different transmission performance requirements of UCIs with different priorities (such as Hybrid Automatic Repeat reQuest ACKnowledgement (HARQ-ACK)) or Scheduling Request (SR) or Channel State Information (CSI) reporting) is a key problem to be solved.

To address the above problem, the present application provides a solution. It should be noted that though the present application only took the Uplink for example in the statement above, it is also applicable to other transmission scenarios of Downlink and Sidelink, where similar technical effects can be achieved. Additionally, the adoption of a unified solution for various scenarios (including but not limited to Uplink, Downlink and Sidelink) contributes to the reduction of hardcore complexity and costs. It should be noted that embodiments in a User Equipment (UE) in the present application and characteristics of the embodiments may be applied to a base station if no conflict is incurred, and vice versa. And the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:
receiving a first signaling; and
transmitting a first signal in a first radio resource pool, the first signal carrying a first bit block and a second bit block;
herein, the first signaling is used to determine the first radio resource pool; a first condition is a condition related to a size relation between a first number and a first threshold, and at least one of a number of bit(s) comprised in the first bit block or a number of bit(s) comprised in the second bit block is used to determine the first number; a third bit block is used to generate the first signal, the first bit block and the second bit block are used to generate the third bit block, and whether the first condition is met is used to determine whether bit(s) in the first bit block and bit(s) in the second bit block are separately input into different channel codings to obtain the third bit block.

In one embodiment, a problem to be solved in the present application comprises: how to transmit UCIs with different categories (such as different priorities) in a same PUCCH (or PUSCH).

In one embodiment, a problem to be solved in the present application comprises: how to determine the encoding method for control information of different categories (such as different priorities) transmitted in a channel based on a payload size of control information.

In one embodiment, characteristics of the above method comprise: determining whether control information of different categories (such as different priorities) that are multiplexed into a same channel is separately encoded based on a payload size of control information to be reported.

In one embodiment, advantages of the above method comprise: determining whether to separately execute channel codings for different types of control information based on a payload size of control information (such as UCI), thus optimizing the allocation of transmission resources.

In one embodiment, advantages of the above method comprise: avoiding the excessive occupation of transmission resources reserved for high-priority control information by the transmission of low-priority control information.

In one embodiment, advantages of the above method comprise: dynamically optimizing the tradeoff between transmission performance and resource utilization.

In one embodiment, advantages of the above method comprise: enhancing the flexibility of multiplexing.

In one embodiment, advantages of the above method comprise: improving the system performance.

According to one aspect of the present application, the above method is characterized in that

the first number is equal to a number of bit(s) comprised in the second bit block; the first condition comprises: the number of bit(s) comprised in the second bit block is not greater than the first threshold.

According to one aspect of the present application, the above method is characterized in that

when the first condition is met, the third bit block comprises outputs after all bits in the first bit block and all bits in the second bit block are input into a same channel coding; when the first condition is not met, the third bit block comprises outputs after bit(s) in the first bit block and bit(s) in the second bit block are separately input into different channel codings.

In one embodiment, characteristics of the above method comprise: when a payload of low-priority control information is small, joint coding increases coding gains; when a payload of low-priority control information is large, using different code rates to encode separately avoids the excessive occupation of transmission resources reserved for high-priority control information by the transmission of low-priority control information.

According to one aspect of the present application, the above method is characterized in that

when the first condition is met, the third bit block comprises all bits in the first bit block and all bits in the second bit block; when the first condition is not met, the third bit block comprises outputs after bit(s) in the first bit block and bit(s) in the second bit block are separately input into different channel codings.

According to one aspect of the present application, the above method is characterized in that

a second condition is a condition related to a size relation between a second number and a second threshold, and at least one of a number of bit(s) comprised in the first bit block or a number of bit(s) comprised in the second bit block is used to determine the second number; whether the second condition is met is used to determine whether a sum of a number of bit(s) comprised in the first bit block and a number of bit(s) comprised in the second bit block or a third number is used to determine a first radio resource pool set, the third number is equal to a number of bit(s) comprised in the first bit block plus a first intermediate quantity, and a number of bit(s) comprised in the second bit block is used to determine the first intermediate quantity; the first radio resource pool set comprises the first radio resource pool.

In one embodiment, characteristics of the above method comprise: determining how to determine a PUCCH resource set based on a payload size of control information to be reported.

In one embodiment, advantages of the above method comprise: determining a PUCCH resource set reasonably based on whether to separately execute codings, avoiding the waste of uplink transmission resources.

According to one aspect of the present application, the above method is characterized in that

the second bit block comprises a Hybrid Automatic Repeat reQuest ACKnowledgement (HARQ-ACK) bit(s), the first bit block comprises Scheduling Request (SR) bit(s), and the first condition comprises: a number of bit(s) comprised in the second bit block is not greater than the first threshold; when a number of bit(s) comprised in the second bit block is not greater than the first threshold, the third bit block comprises all bits in the first bit block and all or partial bits in the second bit block; when a number of bit(s) comprised in the second bit block is greater than the first threshold, the third bit block comprises outputs after bit(s) in the first bit block and bit(s) in the second bit block are separately input into different channel codings.

According to one aspect of the present application, the above method is characterized in that

the first bit block comprises a HARQ-ACK bit, the second bit block comprises an SR bit, and the first condition comprises: a number of bit(s) comprised in the first bit block is not greater than the first threshold; when a number of bit(s) comprised in the first bit block is not greater than the first threshold, the third bit block comprises all bits in the first bit block and all bits in the second bit block; when a number of bit(s) comprised in the first bit block is greater than the first threshold, the third bit block comprises a first coded bit sequence and a second coded bit sequence, all bits in the first bit block are input into a channel coding to obtain the first coded bit sequence, an output after the second bit block is through a first processing is input into another channel coding to obtain the second coded bit sequence, and the first processing comprises one or multiple of logical AND, logical OR, XOR, deleting bit, precoding, inserting repeated bits, or zero padding operations.

In one embodiment, characteristics of the above method comprise: using the first processing to adjust a number of bit(s) to find a suitable channel coding.

In one embodiment, characteristics of the above method comprise: using the first processing to adjust a number of bit(s) to reduce the impact of missing detection of DCI.

According to one aspect of the present application, the above method is characterized in that

when a number of bit(s) comprised in the second bit block is not greater than the first threshold: bits in the third bit block are used to generate the first signal after being used to determine a sequence cyclic shift based on a mapping relation.

According to one aspect of the present application, the above method is characterized in that

the first threshold is equal to 2.

According to one aspect of the present application, the above method is characterized in comprising:
receiving a first signaling group;
herein, the first signaling group comprises the first signaling; herein, two signalings in the first signaling group are respectively used to determine the first bit block and the second bit block.

According to one aspect of the present application, the above method is characterized in that

a third radio resource pool is reserved for the first bit block, and a second radio resource pool is reserved for the second bit block; the third radio resource pool and the second radio resource pool are overlapping in time domain.

The present application provides a method in a second node for wireless communications, comprising:
transmitting a first signaling; and
receiving a first signal in a first radio resource pool, the first signal carrying a first bit block and a second bit block;
herein, the first signaling is used to determine the first radio resource pool; a first condition is a condition related to a size relation between a first number and a first threshold, and at least one of a number of bit(s) comprised in the first bit block or a number of bit(s) comprised in the second bit block is used to determine the first number; a third bit block is used to generate the first signal, the first bit block and the second bit block are used to generate the third bit block, and whether the first condition is met is used to determine whether bit(s) in the first bit block and bit(s) in the second bit block are separately input into different channel codings to obtain the third bit block.

According to one aspect of the present application, the above method is characterized in that

the first number is equal to a number of bit(s) comprised in the second bit block; the first condition comprises: the number of bit(s) comprised in the second bit block is not greater than the first threshold.

According to one aspect of the present application, the above method is characterized in that

when the first condition is met, the third bit block comprises outputs after all bits in the first bit block and all bits in the second bit block are input into a same channel coding; when the first condition is not met, the third bit block comprises outputs after bit(s) in the first bit block and bit(s) in the second bit block are separately input into different channel codings.

According to one aspect of the present application, the above method is characterized in that

when the first condition is met, the third bit block comprises all bits in the first bit block and all bits in the second bit block; when the first condition is not met, the third bit block comprises outputs after bit(s) in the first bit block and bit(s) in the second bit block are separately input into different channel codings.

According to one aspect of the present application, the above method is characterized in that

a second condition is a condition related to a size relation between a second number and a second threshold, and at least one of a number of bit(s) comprised in the first bit block or a number of bit(s) comprised in the second bit block is used to determine the second number; whether the second condition is met is used to determine whether a sum of a number of bit(s) comprised in the first bit block and a number of bit(s) comprised in the second bit block or a third number is used to determine a first radio resource pool set, the third number is equal to a number of bit(s) comprised in the first bit block plus a first intermediate quantity, and a number of bit(s) comprised in the second bit block is used to determine the first intermediate quantity; the first radio resource pool set comprises the first radio resource pool.

According to one aspect of the present application, the above method is characterized in that

the second bit block comprises a Hybrid Automatic Repeat reQuest ACKnowledgement (HARQ-ACK) bit(s), the first bit block comprises Scheduling Request (SR) bit(s), and the first condition comprises: a number of bit(s) comprised in the second bit block is not greater than the first threshold; when a number of bit(s) comprised in the second bit block is not greater than the first threshold, the third bit block comprises all bits in the first bit block and all or partial bits in the second bit block; when a number of bit(s) comprised in the second bit block is greater than the first threshold, the third bit block comprises outputs after bit(s) in the first bit block and bit(s) in the second bit block are separately input into different channel codings.

According to one aspect of the present application, the above method is characterized in that

the first bit block comprises a HARQ-ACK bit, the second bit block comprises an SR bit, and the first condition comprises: a number of bit(s) comprised in the first bit block is not greater than the first threshold; when a number of bit(s) comprised in the first bit block is not greater than the first threshold, the third bit block comprises all bits in the first bit block and all bits in the second bit block; when a number of bit(s) comprised in the first bit block is greater than the first threshold, the third bit block comprises a first coded bit sequence and a second coded bit sequence, all bits in the first bit block are input into a channel coding to obtain the first coded bit sequence, an output after the second bit block is through a first processing is input into another channel coding to obtain the second coded bit sequence, and the first processing comprises one or multiple of logical AND, logical OR, XOR, deleting bit, precoding, inserting repeated bits, or zero padding operations.

According to one aspect of the present application, the above method is characterized in that

when a number of bit(s) comprised in the second bit block is not greater than the first threshold: bits in the third bit block are used to generate the first signal after being used to determine a sequence cyclic shift based on a mapping relation.

According to one aspect of the present application, the above method is characterized in that

the first threshold is equal to 2.

According to one aspect of the present application, the above method is characterized in comprising:
transmitting a first signaling group;
herein, the first signaling group comprises the first signaling; herein, two signalings in the first signaling group are respectively used to determine the first bit block and the second bit block.

According to one aspect of the present application, the above method is characterized in that

a third radio resource pool is reserved for the first bit block, and a second radio resource pool is reserved for the second bit block; the third radio resource pool and the second radio resource pool are overlapping in time domain.

The present application provides a first node for wireless communications, comprising:
a first receiver, receiving a first signaling; and
a first transmitter, transmitting a first signal in a first radio resource pool, the first signal carrying a first bit block and a second bit block;
herein, the first signaling is used to determine the first radio resource pool; a first condition is a condition related to a size relation between a first number and a first threshold, and at least one of a number of bit(s) comprised in the first bit block or a number of bit(s) comprised in the second bit block is used to determine the first number; a third bit block is used to generate the first signal, the first bit block and the second bit block are used to generate the third bit block, and whether the first condition is met is used to determine whether bit(s) in the first bit block and bit(s) in the second bit block are separately input into different channel codings to obtain the third bit block.

The present application provides a second node for wireless communications, comprising:
a second transmitter, transmitting a first signaling; and
a second receiver, receiving a first signal in a first radio resource pool, the first signal carrying a first bit block and a second bit block;
herein, the first signaling is used to determine the first radio resource pool; a first condition is a condition related to a size relation between a first number and a first threshold, and at least one of a number of bit(s) comprised in the first bit block or a number of bit(s) comprised in the second bit block is used to determine the first number; a third bit block is used to generate the first signal, the first bit block and the second bit block are used to generate the third bit block, and whether the first condition is met is used to determine whether bit(s) in the first bit block and bit(s) in the second bit block are separately input into different channel codings to obtain the third bit block.

In one embodiment, the method in the present application is advantageous in the following aspects:
-determining whether to respectively perform channel codings for different types of control information based on a payload size of control information (such as UCI), thus optimizing the allocation of transmission resources;
-avoiding the excessive occupation of transmission resources reserved for high-priority control information by the transmission of low-priority control information;
-optimizing the tradeoff between coding gain and effective utilization of resources;
-enhancing the flexibility of multiplexing;
-improving the system performance;
-avoiding the waste of uplink transmission resources.

After introducing the multiplexing of intra-UE traffics with different priorities, the UE can multiplex Uplink Control Information (UCI) with different priorities onto a Physical Uplink Shared CHannel (PUSCH) for transmission; how to achieve the aforementioned multiplexing while ensuring the transmission performance of high-priority Hybrid Automatic Repeat reQuest ACKnowledgement (HARQ-ACK) is a key issue that needs to be solved.

To address the above problem, the present application provides a solution. It should be noted that though the present application only took the Uplink for example in the statement above, it is also applicable to other transmission scenarios of Downlink and Sidelink, where similar technical effects can be achieved. Additionally, the adoption of a unified solution for various scenarios (including but not limited to Uplink, Downlink and Sidelink) contributes to the reduction of hardcore complexity and costs. It should be noted that the embodiments in a User Equipment (UE) in the present application and characteristics of the embodiments may be applied to a base station if no conflict is incurred, and vice versa. And the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:
receiving a first signaling; and
transmitting a first signal in a first time-frequency resource pool, the first signal carrying a third bit block and a fourth bit block;
herein, the first signaling is used to determine the first time-frequency resource pool; the first time-frequency resource pool is reserved for the fourth bit block; a first bit block comprises first-type HARQ-ACK bit(s), and a second bit block comprises second-type HARQ-ACK bit(s); the second-type HARQ-ACK bit(s) comprised in the second bit block comprises Code-Block-Group (CBG)-based second-type HARQ-ACK bit(s); the first bit block and the second bit block are used to determine the third bit block; the first signaling is used to determine a first offset value; a first calculation amount is related to at least first two of a first offset value, a number of bit(s) comprised in the first bit block and a number of bit(s) comprised in the second bit block; when the first calculation amount is not greater than a second calculation amount, the third bit block comprises the CBG-based second-type HARQ-ACK bit(s) comprised in the second bit block; when the first calculation amount is greater than a second calculation amount, the third bit block does not comprise at least part of the CBG-based second-type HARQ-ACK bit(s) in the second bit block and the third bit block comprises Transport-Block (TB)-based second-type HARQ-ACK bit(s) related to the second bit block.

In one embodiment, a problem to be solved in the present application comprises: how to report issues of UCIs with different priorities in a same PUSCH while ensuring the transmission performance of high-priority UCIs (such as HARQ-ACK information).

In one embodiment, a problem to be solved in the present application comprises: how to report issues of UCIs with different priorities in a same PUCCH while ensuring the transmission performance of high-priority UCIs (such as HARQ-ACK information).

In one embodiment, characteristics of the above method comprise: if carrying (all) the second bit block(s) in the first signal results in a decrease in the transmission performance of the first bit block (such as code rate is increased or occupation of transmission resources becomes less, etc.), partial or all CBG-based second-type HARQ-ACK bits in the second bit block are dropped to be transmitted, and the first signal carries a corresponding TB-based second-type HARQ-ACK bit.

In one embodiment, characteristics of the above method comprise: if carrying (all) the second bit block(s) in the first signal does not result in a decrease in the transmission performance of the first bit block (such as code rate is increased or occupation of transmission resources becomes less, etc.), the first signal carries the second bit block.

In one embodiment, characteristics of the above method comprise: determining how to report the second-type HARQ-ACK bit based on a number of resources available for transmitting a UCI.

In one embodiment, characteristics of the above method comprise: if a number of resources available for transmitting a UCI is insufficient to support reporting all low-priority HARQ-ACK information while ensuring the transmission performance of high-priority HARQ-ACK information, the first node drops a transmission of CBG-based low-priority HARQ-ACK information and instead transmits TB-based low-priority HARQ-ACK information to reduce a number of reported low-priority HARQ-ACK information bit(s).

In one embodiment, advantages of the above method include: optimizing the reporting of a low-priority HARQ-ACK while ensuring the transmission performance of a high-priority UCI (such as HARQ-ACK information).

In one embodiment, advantages of the above method include: reducing unnecessary waste of retransmission resources incurred by all or partial low-priority HARQ-ACK information being dropped to be transmitted.

In one embodiment, advantages of the above method comprise: enhancing the flexibility of multiplexing.

In one embodiment, advantages of the above method comprise: improving the system performance.

According to one aspect of the present application, the above method is characterized in comprising:
monitoring a first Transport Block (TB);
herein, the first TB comprises multiple CBGs, the second bit block comprises multiple CBG-based second-type HARQ-ACK bits indicating whether the multiple CBGs in the first TB are correctly received; when the first calculation amount is not greater than the second calculation amount, the third bit block comprises the multiple CBG-based second-type HARQ-ACK bits indicating whether the multiple CBGs in the first TB are correctly received comprised in the second bit block; when the first calculation amount is greater than the second calculation amount, a number of the second-type HARQ-ACK bit(s) generated for the first TB comprised in the third bit block is equal to 1.

According to one aspect of the present application, the above method is characterized in that

the second calculation amount is equal to a minimum value between a result after a first intermediate quantity is rounding to an integer and a result after a second intermediate quantity is rounding to an integer; the first intermediate quantity is linearly associated with a number of bit(s) comprised in the first bit block.

In one embodiment, characteristics of the above method comprise: a total number of HARQ-ACK bit(s) that can be carried by the first signal does not exceed a number of bit(s) comprised in the first bit block multiplied by a parameter value not less than 1.

According to one aspect of the present application, the above method is characterized in that

a priority corresponding to the fourth bit block is used to determine the first intermediate quantity.

According to one aspect of the present application, the above method is characterized in that

the first calculation amount is greater than the second calculation amount; the first bit block comprises a CBG-based first-type HARQ-ACK bit; the first offset value is used to determine a third calculation amount; when the third calculation amount is not greater than the second calculation amount, the third bit block comprises the CBG-based first-type HARQ-ACK bit comprised in the first bit block, and a number of the first-type HARQ-ACK bit(s) comprised in the third bit block is equal to a number of the first-type HARQ-ACK bit(s) comprised in the first bit block; when the third calculation amount is greater than the second calculation amount, a number of the first-type HARQ-ACK bit(s) comprised in the third bit block is less than a number of the first-type HARQ-ACK bit(s) comprised in the first bit block.

According to one aspect of the present application, the above method is characterized in that

the first-type HARQ-ACK bit corresponds to a first priority, and the second-type HARQ-ACK bit corresponds to a second priority; the first priority is different from the second priority.

According to one aspect of the present application, the above method is characterized in that

a first radio resource pool is reserved for at least one of the first bit block or the second bit block; the first radio resource pool overlaps with the first time-frequency resource pool in time domain.

The present application provides a method in a second node for wireless communications, comprising:
transmitting a first signaling; and
receiving a first signal in a first time-frequency resource pool, the first signal carrying a third bit block and a fourth bit block;
herein, the first signaling is used to determine the first time-frequency resource pool; the first time-frequency resource pool is reserved for the fourth bit block; a first bit block comprises first-type HARQ-ACK bit(s), and a second bit block comprises second-type HARQ-ACK bit(s); the second-type HARQ-ACK bit(s) comprised in the second bit block comprises CBG-based second-type HARQ-ACK bit(s); the first bit block and the second bit block are used to determine the third bit block; the first signaling is used to determine a first offset value; a first calculation amount is related to at least first two of a first offset value, a number of bit(s) comprised in the first bit block and a number of bit(s) comprised in the second bit block; when the first calculation amount is not greater than a second calculation amount, the third bit block comprises the CBG-based second-type HARQ-ACK bit(s) comprised in the second bit block; when the first calculation amount is greater than a second calculation amount, the third bit block does not comprise at least part of CBG-based second-type HARQ-ACK bit(s) in the second bit block and the third bit block comprises TB-based second-type HARQ-ACK bit(s) related to the second bit block.

According to one aspect of the present application, the above method is characterized in comprising:
transmitting a first TB;
herein, the first TB comprises multiple CBGs, the second bit block comprises multiple CBG-based second-type HARQ-ACK bits indicating whether the multiple CBGs in the first TB are correctly received; when the first calculation amount is not greater than the second calculation amount, the third bit block comprises the multiple CBG-based second-type HARQ-ACK bits indicating whether the multiple CBGs in the first TB are correctly received comprised in the second bit block; when the first calculation amount is greater than the second calculation amount, a number of the second-type HARQ-ACK bit(s) generated for the first TB comprised in the third bit block is equal to 1.

According to one aspect of the present application, the above method is characterized in that

the second calculation amount is equal to a minimum value between a result after a first intermediate quantity is rounding to an integer and a result after a second intermediate quantity is rounding to an integer; the first intermediate quantity is linearly associated with a number of bit(s) comprised in the first bit block.

According to one aspect of the present application, the above method is characterized in that

a priority corresponding to the fourth bit block is used to determine the first intermediate quantity.

According to one aspect of the present application, the above method is characterized in that

the first calculation amount is greater than the second calculation amount; the first bit block comprises a CBG-based first-type HARQ-ACK bit; the first offset value is used to determine a third calculation amount; when the third calculation amount is not greater than the second calculation amount, the third bit block comprises the CBG-based first-type HARQ-ACK bit comprised in the first bit block, and a number of the first-type HARQ-ACK bit(s) comprised in the third bit block is equal to a number of the first-type HARQ-ACK bit(s) comprised in the first bit block; when the third calculation amount is greater than the second calculation amount, a number of the first-type HARQ-ACK bit(s) comprised in the third bit block is less than a number of the first-type HARQ-ACK bit(s) comprised in the first bit block.

According to one aspect of the present application, the above method is characterized in that

the first-type HARQ-ACK bit corresponds to a first priority, and the second-type HARQ-ACK bit corresponds to a second priority; the first priority is different from the second priority.

According to one aspect of the present application, the above method is characterized in that

a first radio resource pool is reserved for at least one of the first bit block or the second bit block; the first radio resource pool overlaps with the first time-frequency resource pool in time domain.

The present application provides a first node for wireless communications, comprising:
a first receiver, receiving a first signaling; and
a first transmitter, transmitting a first signal in a first time-frequency resource pool, the first signal carrying a third bit block and a fourth bit block;
herein, the first signaling is used to determine the first time-frequency resource pool; the first time-frequency resource pool is reserved for the fourth bit block; a first bit block comprises first-type HARQ-ACK bit(s), and a second bit block comprises second-type HARQ-ACK bit(s); the second-type HARQ-ACK bit(s) comprised in the second bit block comprises CBG-based second-type HARQ-ACK bit(s); the first bit block and the second bit block are used to determine the third bit block; the first signaling is used to determine a first offset value; a first calculation amount is related to at least first two of a first offset value, a number of bit(s) comprised in the first bit block and a number of bit(s) comprised in the second bit block; when the first calculation amount is not greater than a second calculation amount, the third bit block comprises the CBG-based second-type HARQ-ACK bit(s) comprised in the second bit block; when the first calculation amount is greater than a second calculation amount, the third bit block does not comprise at least part of CBG-based second-type HARQ-ACK bit(s) in the second bit block and the third bit block comprises TB-based second-type HARQ-ACK bit(s) related to the second bit block.

The present application provides a second node for wireless communications, comprising:
a second transmitter, transmitting a first signaling; and
a second receiver, receiving a first signal in a first time-frequency resource pool, the first signal carrying a third bit block and a fourth bit block;
herein, the first signaling is used to determine the first time-frequency resource pool; the first time-frequency resource pool is reserved for the fourth bit block; a first bit block comprises first-type HARQ-ACK bit(s), and a second bit block comprises second-type HARQ-ACK bit(s); the second-type HARQ-ACK bit(s) comprised in the second bit block comprises CBG-based second-type HARQ-ACK bit(s); the first bit block and the second bit block are used to determine the third bit block; the first signaling is used to determine a first offset value; a first calculation amount is related to at least first two of a first offset value, a number of bit(s) comprised in the first bit block and a number of bit(s) comprised in the second bit block; when the first calculation amount is not greater than a second calculation amount, the third bit block comprises the CBG-based second-type HARQ-ACK bit(s) comprised in the second bit block; when the first calculation amount is greater than a second calculation amount, the third bit block does not comprise at least part of CBG-based second-type HARQ-ACK bit(s) in the second bit block and the third bit block comprises TB-based second-type HARQ-ACK bit(s) related to the second bit block.

In one embodiment, the method in the present application is advantageous in the following aspects:
ensuring the transmission performance of high-priority UCI (such as HARQ-ACK information);
optimizing the reporting of low-priority HARQ-ACK while ensuring the transmission performance of high-priority UCI (such as HARQ-ACK information);
reducing unnecessary waste of retransmission resources incurred by all or partial low-priority HARQ-ACK information being dropped to be transmitted;
enhancing the flexibility of multiplexing;
improving the system performance.

### BRIEF DESCRIPTION OF THE DRAWINGS

Other features, objects and advantages of the present application will become more apparent from the detailed description of non-restrictive embodiments taken in conjunction with the following drawings:

FIG. 1A illustrates a flowchart of the processing of a first node according to one embodiment of the present application;

FIG. 1B illustrates a flowchart of the processing of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5A illustrates a flowchart of signal transmission according to one embodiment of the present application;

FIG. 5B illustrates a flowchart of radio signal transmission according to one embodiment of the present application;

FIG. 6A illustrates a schematic diagram of a relation between a first condition and a size relation of a first number and a first threshold according to one embodiment of the present application;

FIG. 6B illustrates a schematic diagram of relations among a first node, a second TB group and a second bit block according to one embodiment of the present application;

FIG. 7A illustrates a schematic diagram of relations among a number of bit(s) comprised in a first bit block, a number of bit(s) comprised in a second bit block and a first number according to one embodiment of the present application;

FIG. 7B illustrates a schematic diagram of a procedure of determining a relation between a third bit block and a first TB according to one embodiment of the present application;

FIG. 8A illustrates a schematic diagram of a procedure of a first condition being used to determine a third bit block according to one embodiment of the present application;

FIG. 8B illustrates a schematic diagram of relations among a first signaling, a first offset value, a first calculation amount, a first bit block and a second bit block according to one embodiment of the present application;

FIG. 9A illustrates a schematic diagram of a procedure of a first condition being used to determine a third bit block according to one embodiment of the present application;

FIG. 9B illustrates a schematic diagram of relations among a second calculation amount, a first intermediate quantity, a second intermediate quantity and a first bit block according to one embodiment of the present application;

FIG. 10A illustrates a schematic diagram of relations among a number of bit(s) comprised in a first bit block, a number of bit(s) comprised in a second bit block, a second number, a second threshold, a second condition, a third number and a first radio resource pool set according to one embodiment of the present application;

FIG. 10B illustrates a schematic diagram of a procedure of determining a relation between a third bit block and a first bit block according to one embodiment of the present application;

FIG. 11A illustrates a schematic diagram of relations among a first signaling group, two signalings, a first bit block and a second bit block according to one embodiment of the present application;

FIG. 11B illustrates a schematic diagram of relations among a first node, a second signaling, a third signaling, a second bit block and a first bit block according to one embodiment of the present application;

FIG. 12A illustrates a schematic diagram of relations among a third radio resource pool, a second radio resource pool, a first bit block and a second bit block according to one embodiment of the present application;

FIG. 12B illustrates a schematic diagram of relations among a first time-frequency resource pool, a first radio resource pool, a first bit block and a second bit block according to one embodiment of the present application;

FIG. 13A illustrates a schematic diagram of a relation between a first bit block and a first priority as well as a relation between a second bit block and a second priority according to one embodiment of the present application;

FIG. 13B illustrates a schematic diagram of a relation between a first-type HARQ-ACK bit and a first priority as well as a relation between a second-type HARQ-ACK bit and a second priority according to one embodiment of the present application;

FIG. 14A illustrates a structure block diagram of a processor in a first node according to one embodiment of the present application;

FIG. 14B illustrates a structure block diagram of a processor in a first node according to one embodiment of the present application;

FIG. 15A illustrates a structure block diagram of a processor in second node according to one embodiment of the present application;

FIG. 15B illustrates a structure block diagram of a processor in second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1A

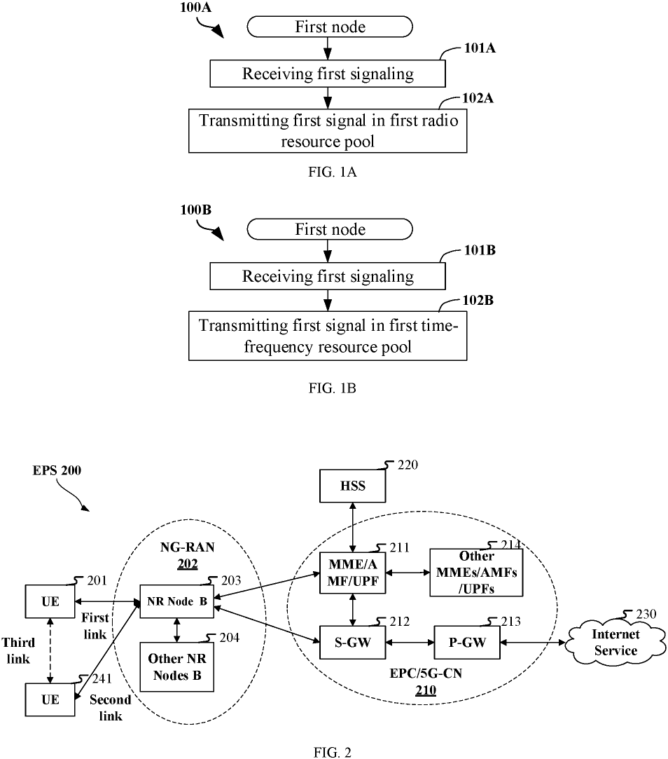

Embodiment 1A illustrates a processing flowchart of a first node according to one embodiment of the present application, as shown in FIG. 1A.

In Embodiment 1A, the first node in the present application receives a first signaling in step 101A; transmits a first signal in a first radio resource pool in step 102A.

In embodiment 1A, the first signal carries a first bit block and a second bit block; the first signaling is used to determine the first radio resource pool; a first condition is a condition related to a size relation between a first number and a first threshold, and at least one of a number of bit(s) comprised in the first bit block or a number of bit(s) comprised in the second bit block is used to determine the first number; a third bit block is used to generate the first signal, the first bit block and the second bit block are used to generate the third bit block, and whether the first condition is met is used to determine whether bit(s) in the first bit block and bit(s) in the second bit block are separately input into different channel codings to obtain the third bit block.

In one embodiment, the first signal comprises a radio signal.

In one embodiment, the first signal comprises a radio-frequency signal.

In one embodiment, the first signal comprises a baseband signal.

In one embodiment, the first signaling is dynamically-configured.

In one embodiment, the first signaling comprises a layer 1 (L1) signaling.

In one embodiment, the first signaling comprises an L1 control signaling.

In one embodiment, the first signaling comprises a physical-layer signaling.

In one embodiment, the first signaling comprises one or multiple fields in a physical-layer signaling.

In one embodiment, the first signaling comprises a higher-layer signaling.

In one embodiment, the first signaling comprises one or multiple fields in a higher-layer signaling.

In one embodiment, the first signaling comprises a Radio Resource Control (RRC) signaling.

In one embodiment, the first signaling comprises a Medium Access Control layer Control Element (MAC CE) signaling.

In one embodiment, the first signaling comprises one or multiple fields in an RRC signaling.

In one embodiment, the first signaling comprises one or multiple fields in a MAC CE signaling.

In one embodiment, the first signaling comprises Downlink Control Information (DCI).

In one embodiment, the first signaling comprises one or multiple fields in a DCI.

In one embodiment, the first signaling comprises Sidelink Control Information (SCI).

In one embodiment, the first signaling comprises one or multiple fields in an SCI.

In one embodiment, the first signaling comprises one or multiple fields in an Information Element (IE).

In one embodiment, the first signaling is a DownLink Grant Signalling.

In one embodiment, the first signaling is an UpLink Grant Signalling.

In one embodiment, the first signaling is transmitted on a downlink physical layer control channel (i.e., a downlink channel only capable of bearing a physical-layer signaling).

In one embodiment, the downlink physical-layer control channel in the present application is a Physical Downlink Control CHannel (PDCCH).

In one subembodiment of the above embodiment, the downlink physical layer control channel in the present application is a short PDCCH (sPDCCH).

In one embodiment, the downlink physical layer control channel in the present application is a Narrow Band PDCCH (NB-PDCCH).

In one embodiment, the first signaling is DCI format 1_0, and for the specific meaning of the DCI format 1_0, refer to section 7.3.1.2 in 3GPP TS38.212.

In one embodiment, the first signaling is DCI format 1_1, and for the specific meaning of the DCI format 1_1, refer to section 7.3.1.2 in 3GPP TS38.212.

In one embodiment, the first signaling is DCI format 1_2, and for the specific meaning of the DCI format 1_2, refer to section 7.3.1.2 in 3GPP TS38.212.

In one embodiment, the first signaling is DCI format 0_0, and for the specific meaning of the DCI format 0_0, refer to section 7.3.1.1 in 3GPP TS38.212.

In one embodiment, the first signaling is DCI format 0_1, and for the specific meaning of the DCI format 0_1, refer to section 7.3.1.1 in 3GPP TS38.212.

In one embodiment, the first signaling is DCI format 0_2, and for the specific meaning of the DCI format 0_2, refer to section 7.3.1.1 in 3GPP TS38.212.

In one embodiment, the meaning of the phrase that the first signal carries a first bit block and a second bit block comprises: the first signal comprises an output after all or partial bits in the first bit block are sequentially through part or all of CRC Insertion, Segmentation, code-block level CRC Insertion, Channel Coding, Rate Matching, Concatenation, Scrambling, Modulation, Layer Mapping, Precoding, Mapping to Resource Element, generation of multi-carrier symbol and Modulation and Upconversion, and the first signal comprises an output after all or partial bits in the second bit block are sequentially through part or all of CRC Insertion, Segmentation, code-block level CRC Insertion, Channel Coding, Rate Matching, Concatenation, Scrambling, Modulation, Layer Mapping, Precoding, Mapping to Resource Element, generation of multi-carrier symbol and Modulation and Upconversion.

In one embodiment, the meaning of the phrase that the first signal carries a first bit block and a second bit block comprises that: the first signal comprises an output after all or partial bits in the first bit block and all or partial bits in the second bit block are sequentially through part or all of CRC Insertion, Segmentation, Code Block-level CRC Insertion, Channel Coding, Rate Matching, Concatenation, Scrambling, Modulation, Layer Mapping, Precoding, Mapping to Resource Element, Multicarrier symbol Generation and Modulation and Upconversion.

In one embodiment, the meaning of the phrase that the first signal carries a first bit block and a second bit block comprises that: the first bit block and the second bit block are used to generate a third bit block, and the third bit block is used to generate the first signal.

In one embodiment, the meaning of the phrase that the first signal carries a first bit block and a second bit block comprises that: the first bit block and the second bit block are used to generate a third bit block, and the first signal comprises an output after the third bit block is through at least mapping to resource element, multicarrier symbol generation and modulation and upconversion.

In one embodiment, the meaning of the phrase that the first signal carries a first bit block and a second bit block comprises that: the first bit block and the second bit block are used to generate a third bit block, and the first signal comprises an output after the third bit block is sequentially through part or all of CRC Insertion, Segmentation, Code Block-level CRC Insertion, Channel Coding, Rate Matching, Concatenation, Scrambling, Sequence generation, (Sequence) Modulation, Spreading, Layer Mapping, Precoding, Mapping to Resource Element, Multicarrier symbol Generation and Modulation and Upconversion.

In one embodiment, the first radio resource pool comprises a positive integer number of time-frequency resource element(s) in time-frequency domain.

In one embodiment, the first radio resource pool comprises a positive integer number of Resource Element(s) (RE(s)) in time-frequency domain.

In one embodiment, the RE occupies a multicarrier symbol in time domain, and a subcarrier in frequency domain.

In one embodiment, the time-frequency resource element in the present application is an RE.

In one embodiment, the time-frequency resource element in the present application comprises a subcarrier in frequency domain.

In one embodiment, the time-frequency resource element in the present application comprises a multicarrier symbol in time domain.

In one embodiment, the multicarrier symbol in the present application is an Orthogonal Frequency Division Multiplexing (OFDM) symbol.

In one embodiment, the multicarrier symbol in the present application is a Single Carrier- Frequency Division Multiple Access (SC-FDMA) symbol.

In one embodiment, the multicarrier symbol in the present application is a Discrete Fourier Transform Spread OFDM (DFT-S-OFDM) symbol.

In one embodiment, the first radio resource pool comprises a positive integer number of subcarrier(s) in frequency domain.

In one embodiment, the first radio resource pool comprises a positive integer number of Physical resource block(s) (PRB(s)) in frequency domain.

In one embodiment, the first radio resource pool comprises a positive integer number of Resource Block(s) (RB(s)) in frequency domain.

In one embodiment, the first radio resource pool comprises a positive integer number of multi-carrier symbol(s) in time domain.

In one embodiment, the first radio resource pool comprises a positive integer number of slot(s) in time domain.

In one embodiment, the first radio resource pool comprises a positive integer number of sub-slot(s) in time domain.

In one embodiment, the first radio resource pool comprises a positive integer number of ms(s) in time domain.

In one embodiment, the first radio resource pool comprises a positive integer number of continuous multi-carrier symbol(s) in time domain.

In one embodiment, the first radio resource pool comprises a positive integer number of discontinuous slot(s) in time domain.

In one embodiment, the first radio resource pool comprises a positive integer number of continuous slot(s) in time domain.

In one embodiment, the first radio resource pool comprises a positive integer number of sub-frame(s) in time domain.

In one embodiment, the first radio resource pool is configured by a physical-layer signaling.

In one embodiment, the first radio resource pool is configured by a higher-layer signaling.

In one embodiment, the first radio resource pool is configured by a Radio Resource Control (RRC) signaling.

In one embodiment, the first radio resource pool is configured by a Medium Access Control layer Control Element (MAC CE) signaling.

In one embodiment, the first radio resource pool is reserved for an uplink physical-layer channel.

In one embodiment, the first radio resource pool comprises time-frequency resources reserved for an uplink physical layer channel.

In one embodiment, the first radio resource pool comprises time-frequency resources occupied by an uplink physical layer channel.

In one embodiment, the first radio resource pool is reserved for a Physical Uplink Shared CHannel (PUSCH).

In one embodiment, the first radio resource pool comprises time-frequency resources reserved for a PUSCH.

In one embodiment, the first radio resource pool comprises time-frequency resources occupied by a PUSCH.

In one embodiment, the first radio resource pool is reserved for a Physical Uplink Control CHannel (PUCCH).

In one embodiment, the first radio resource pool comprises radio resources reserved for a PUCCH.

In one embodiment, the first radio resource pool comprises a PUCCH resource.

In one embodiment, the first radio resource pool is reserved for a Physical Sidelink Shared CHannel (PSSCH).

In one embodiment, the first signaling indicates the first radio resource pool.

In one embodiment, the first signaling explicitly indicates the first radio resource pool.

In one embodiment, the first signaling implicitly indicates the first radio resource pool.

In one embodiment, the first signaling indicates frequency-domain resources comprised in the first radio resource pool.

In one embodiment, the first signaling indicates time-domain resources comprised in the first radio resource pool.

In one embodiment, the first signaling indicates an index of the first radio resource pool.

In one embodiment, the first signaling is used to configure a period characteristic associated with the first radio resource pool.

In one embodiment, the implicitly indicating in the present application comprises: it is indicated implicitly via a signaling format.

In one embodiment, the implicitly indicating in the present application comprises: it is indicated implicitly via an RNTI.

In one embodiment, the first radio resource pool is reserved for a fourth bit block.

In one embodiment, the first signal also carries a fourth bit block.

In one embodiment, the first signaling comprises scheduling information of a fourth bit block.

In one embodiment, the fourth bit block comprises a positive integer number of bit(s).

In one embodiment, the fourth bit block comprises a Transport Block (TB).

In one embodiment, the fourth bit block comprises one Code Block (CB).

In one embodiment, the fourth bit block comprises a Code Block Group (CBG).

In one embodiment, the first signaling comprises first scheduling information; the first scheduling information comprises at least one of occupied time-domain resources, occupied frequency-domain resources, a Modulation and Coding Scheme (MCS), configuration information of DeModulation Reference Signals (DMRS), a Hybrid Automatic Repeat request (HARQ) process number, a Redundancy Version (RV), a New Data Indicator (NDI), a periodicity, a transmission antenna port, or a corresponding Transmission Configuration Indicator (TCI) state.

In one embodiment, the phrase of being used for in the present application comprises: being used by the first node for.

In one embodiment, the phrase of being used for in the present application comprises: being used by a transmitting end of the first signal for.

In one embodiment, the phrase of being used for in the present application comprises: being used by a receiving end of the first signal for.

In one embodiment, the first bit block comprises control information.

In one embodiment, the first bit block comprises a UCI.

In one embodiment, the first bit block comprises a HARQ-ACK.

In one embodiment, the first bit block comprises a positive integer number of bit(s).

In one embodiment, the first bit block comprises a positive integer number of ACK(s) or NACK(s).

In one embodiment, the first bit block comprises a HARQ-ACK codebook.

In one embodiment, the first bit block comprises a HARQ-ACK sub-codebook.

In one embodiment, the first bit block comprises a Scheduling Request (SR).

In one embodiment, the first bit block comprises a positive SR.

In one embodiment, the first bit block comprises SR corresponding to priority index 1.

In one embodiment, the first bit block comprises SR corresponding to priority index 0.

In one embodiment, the first bit block comprises a high-priority SR.

In one embodiment, the first bit block comprises a low-priority SR.

In one embodiment, the first bit block comprises a Channel State Information (CSI) reporting.

In one embodiment, the second bit block comprises control information.

In one embodiment, the second bit block comprises a UCI.

In one embodiment, the second bit block comprises a HARQ-ACK.

In one embodiment, the second bit block comprises a positive integer number of bit(s).

In one embodiment, the second bit block comprises a positive integer number of ACK(s) or NACK(s).

In one embodiment, the second bit block comprises a HARQ-ACK codebook.

In one embodiment, the second bit block comprises a HARQ-ACK sub-codebook.

In one embodiment, the second bit block comprises an SR.

In one embodiment, the second bit block comprises a positive SR.

In one embodiment, the second bit block comprises an SR corresponding to priority index 1.

In one embodiment, the second bit block comprises an SR corresponding to priority index 0.

In one embodiment, the second bit block comprises a high-priority SR.

In one embodiment, the second bit block comprises a low-priority SR.

In one embodiment, the second bit block comprises a CSI reporting.

In one embodiment, the first bit block comprises a HARQ-ACK bit corresponding to priority index 1, and the second bit block comprises an SR corresponding to priority index 0.

In one embodiment, the first bit block comprises a HARQ-ACK bit corresponding to priority index 0, and the second bit block comprises an SR corresponding to priority index 1.

In one embodiment, the second bit block comprises a HARQ-ACK bit corresponding to priority index 1, and the second bit block comprises an SR corresponding to priority index 0.

In one embodiment, the second bit block comprises a HARQ-ACK bit corresponding to priority index 0, and the first bit block comprises an SR corresponding to priority index 1.

In one embodiment, the third bit block comprises control information.

In one embodiment, the third bit block comprises a UCI.

In one embodiment, the third bit block comprises a HARQ-ACK.

In one embodiment, the third bit block comprises a positive integer number of bit(s).

In one embodiment, the third bit block comprises a positive integer number of ACK(s) or NACK(s).

In one embodiment, the third bit block comprises a HARQ-ACK codebook.

In one embodiment, the third bit block comprises a HARQ-ACK sub-codebook.

In one embodiment, the third bit block comprises an SR.

In one embodiment, the third bit block comprises an SR corresponding to priority index 1.

In one embodiment, the third bit block comprises an SR corresponding to priority index 0.

In one embodiment, the third bit block comprises a high-priority SR.

In one embodiment, the third bit block comprises a low-priority SR.

In one embodiment, the third bit block comprises a CSI reporting.

In one embodiment, the third bit block comprises an encoded bit.

In one embodiment, the first bit block comprises a first-type UCI.

In one embodiment, the second bit block comprises a second-type UCI.

In one embodiment, the first-type UCI is different from the second-type UCI.

In one embodiment, the first-type UCI comprises a UCI corresponding to one of multiple Quality of Service (QoS) types.

In one embodiment, the first-type UCI comprises a UCI corresponding to URLLC service type.

In one embodiment, the first-type UCI comprises a UCI corresponding to eMBB service type.

In one embodiment, the first-type UCI comprises a high-priority UCI.

In one embodiment, the first-type UCI comprises a low-priority UCI.

In one embodiment, the first-type UCI comprises a UCI corresponding to priority index 1.

In one embodiment, the first-type UCI comprises a UCI corresponding to priority index 0.

In one embodiment, the first-type UCI comprises a sidelink UCI.

In one embodiment, the second-type UCI comprises a UCI corresponding to one of multiple QoS types.

In one embodiment, the second-type UCI comprises a UCI corresponding to URLLC traffic type.

In one embodiment, the second-type UCI comprises a UCI corresponding to eMBB traffic type.

In one embodiment, the second-type UCI comprises a high-priority UCI.

In one embodiment, the second-type UCI comprises a low-priority UCI.

In one embodiment, the second-type UCI comprises a UCI corresponding to priority index 1.

In one embodiment, the second-type UCI comprises a UCI corresponding to priority index 0.

In one embodiment, the second-type UCI comprises a sidelink UCI.

In one embodiment, the second-type UCI and the first-type UCI are respectively UCIs for different links.

In one embodiment, the different links comprise an uplink and a sidelink.

In one embodiment, the second-type UCI and the first-type UCI are respectively UCIs used for different traffic types.

In one embodiment, the second-type UCI and the first-type UCI are respectively UCIs of different types.

In one embodiment, the second-type UCI and the first-type UCI are respectively UCIs with different priorities.

In one embodiment, the second-type UCI and the first-type UCI are UCIs corresponding to different priority indexes.

In one embodiment, the second-type UCI comprises a UCI corresponding to priority index 1, and the first-type UCI comprises a UCI corresponding to priority index 0.

In one embodiment, the second-type UCI comprises a UCI corresponding to priority index 0, and the first-type UCI comprises a UCI corresponding to priority index 1.

In one embodiment, the first bit block comprises a first-type HARQ-ACK.

In one embodiment, the second bit block comprises a second-type HARQ-ACK.

In one embodiment, the first-type UCI comprises a first-type HARQ-ACK.

In one embodiment, the second-type UCI comprises a second-type HARQ-ACK.

In one embodiment, the HARQ-ACK in the present application comprises: an information bit indicating whether a signaling is correctly received, or an information bit indicating whether a bit block scheduled by a signaling (such as a TB or a CBG) is correctly received.

In one embodiment, the HARQ-ACK in the present application comprises: an information bit used to indicate whether a signaling indicating a Semi-Persistent Scheduling (SPS) release is correctly received, or, an information bit indicating whether a bit block transmitted on a Physical Downlink Shared Channel (PDSCH) scheduled by a signaling (such as a TB or a CBG) is correctly received.

In one embodiment, the first-type HARQ-ACK bit is different from the second-type HARQ-ACK bit.

In one embodiment, both the first-type HARQ-ACK bit and the second-type HARQ-ACK are HARQ-ACK information bits.

In one embodiment, the first-type HARQ-ACK bit comprises a HARQ-ACK bit corresponding to one of multiple Quality of Service (QoS) types.

In one embodiment, the first-type HARQ-ACK bit comprises a HARQ-ACK bit corresponding to URLLC traffic type.

In one embodiment, the first-type HARQ-ACK bit comprises a HARQ-ACK bit corresponding to eMBB traffic type.

In one embodiment, the first-type HARQ-ACK bit comprises a high-priority HARQ-ACK bit.

In one embodiment, the first-type HARQ-ACK bit comprises a low-priority HARQ-ACK bit.

In one embodiment, the first-type HARQ-ACK bit comprises a HARQ-ACK bit corresponding to priority index 1.

In one embodiment, the first-type HARQ-ACK bit comprises a HARQ-ACK bit corresponding to priority index 0.

In one embodiment, the first-type HARQ-ACK bit comprises a sidelink HARQ-ACK (SL HARQ-ACK) bit.

In one embodiment, the second-type HARQ-ACK bit comprises a HARQ-ACK bit corresponding to one of multiple QoS types.

In one embodiment, the second-type HARQ-ACK bit comprises a HARQ-ACK bit corresponding to URLLC service type.

In one embodiment, the second-type HARQ-ACK bit comprises a HARQ-ACK bit corresponding to eMBB service type.

In one embodiment, the second-type HARQ-ACK bit comprises a high-priority HARQ-ACK bit.

In one embodiment, the second-type HARQ-ACK bit comprises a low-priority HARQ-ACK bit.

In one embodiment, the second-type HARQ-ACK bit comprises a HARQ-ACK bit corresponding to priority index 1.

In one embodiment, the second-type HARQ-ACK bit comprises a HARQ-ACK bit corresponding to priority index 0.

In one embodiment, the second-type HARQ-ACK bit comprises a sidelink HARQ-ACK bit.

In one embodiment, the second-type HARQ-ACK bit(s) and the first-type HARQ-ACK bit(s) are respectively HARQ-ACK bits for different links.

In one embodiment, the different links comprise uplink and sidelink.

In one embodiment, the second-type HARQ-ACK bit(s) and the first-type HARQ-ACK bit(s) are respectively HARQ-ACK bits used for different service types.

In one embodiment, the second-type HARQ-ACK bit(s) and the first-type HARQ-ACK bit(s) are respectively HARQ-ACK bits with different types.

In one embodiment, the second-type HARQ-ACK bit(s) and the first-type HARQ-ACK bit(s) are respectively HARQ-ACK bits with different priorities.

In one embodiment, the second-type HARQ-ACK bit(s) and the first-type HARQ-ACK bit(s) are respectively HARQ-ACK bits corresponding to different priority indexes.

In one embodiment, the second-type HARQ-ACK bit comprises a HARQ-ACK bit corresponding to priority index 1, and the first-type HARQ-ACK bit comprises a HARQ-ACK bit corresponding to priority index 0.

In one embodiment, the second-type HARQ-ACK bit comprises a HARQ-ACK bit corresponding to priority index 0, and the first-type HARQ-ACK comprises a HARQ-ACK bit corresponding to priority index 1.

In one embodiment, the first bit block comprises K1 bit(s).

In one embodiment, a number of bit(s) comprised in the first bit block is equal to K1.

In one embodiment, K1 is equal to 1.

In one embodiment, K1 is equal to 2.

In one embodiment, K1 is not greater than 2.

In one embodiment, K1 is greater than 2.

In one embodiment, K1 is not greater than 1706.

In one embodiment, K1 is not greater than 17060.

In one embodiment, a number of bit(s) comprised in the first bit block is not less than 2.

In one embodiment, the second bit block comprises K2 bit(s).

In one embodiment, a number of bit(s) comprised in the second bit block is equal to K2.

In one embodiment, K2 is equal to 1.

In one embodiment, K2 is equal to 2.

In one embodiment, K2 is not greater than 1706.

In one embodiment, K2 is not greater than 17060.

In one embodiment, K2 is not greater than 2.

In one embodiment, K2 is greater than 2.

In one embodiment, a number of bit(s) comprised in the second bit block is not less than 2.

In one embodiment, a procedure of the third bit block being used to generate the first signal does not comprise related steps of channel coding.

In one embodiment, the channel coding in the present application comprises: channel coding executed by using Polar code.

In one embodiment, the channel coding in the present application comprises: channel coding executed by using LDPC code.

In one embodiment, the channel coding in the present application comprises: channel coding executed by using Simplex code.

In one embodiment, the channel coding in the present application comprises: channel coding executed by using Reed-Muller (RM) code.

In one embodiment, the channel coding in the present application comprises: channel coding executed by using repeated code.

In one embodiment, the first signal comprises an output after all or partial bits in the third bit block are sequentially through part or all of Scrambling, Modulation, Layer Mapping, Precoding, Mapping to Resource Element, Multicarrier symbol Generation and Modulation and Upconversion.

In one embodiment, a sum of a number of bit(s) comprised in the first bit block and a number of bit(s) comprised in the second bit block is used to determine the first radio resource pool set, and the first radio resource pool set comprises the first radio resource pool.

In one embodiment, a third number is used to determine a first radio resource pool set, the first radio resource pool set comprises the first radio resource pool, and the third number is not equal to a sum of a number of bit(s) comprised in the first bit block and a number of bit(s) comprised in the second bit block.

In one subembodiment of the above embodiment, the third number is equal to a number of bit(s) comprised in the first bit block plus a first intermediate quantity, and a number of bit(s) comprised in the second bit block is used to determine the first intermediate quantity.

In one embodiment, the first signaling in the present application indicates the first radio resource pool from the first radio resource pool set.

In one embodiment, the first signaling in the present application indicates an index of the first radio resource pool in the first radio resource pool set.

In one embodiment, the meaning of the phrase that whether the first condition is met is used to determine whether bit(s) in the first bit block and bit(s) in the second bit block are separately input into different channel codings to obtain the third bit block comprises: whether the first condition is met is used to determine whether the third bit block comprises outputs after bit(s) in the first bit block and bit(s) in the second bit block are separately input into different channel codings.

In one embodiment, the meaning of the phrase that whether the first condition is met is used to determine whether bit(s) in the first bit block and bit(s) in the second bit block are separately input into different channel codings to obtain the third bit block comprises: whether the first condition is met is used to determine whether the third bit block comprises an output obtained after all bits in the first bit block and all bits in the second bit block are input into a same channel coding or comprises an output obtained after bit(s) in the first bit block and bit(s) in the second bit block are separately input into different channel codings.

In one embodiment, the meaning of the phrase that whether the first condition is met is used to determine whether bit(s) in the first bit block and bit(s) in the second bit block are separately input into different channel codings to obtain the third bit block comprises: whether the first condition is met is used to determine whether the third bit block comprises an output after all bits in the first bit block and all bits in the second bit block or comprises an output after bit(s) in the first bit block and bit(s) in the second bit block are separately input into different channel codings.

In one embodiment, the meaning of the phrase that whether the first condition is met is used to determine whether bit(s) in the first bit block and bit(s) in the second bit block are separately input into different channel codings to obtain the third bit block comprises: whether the first condition is met is used to determine whether the third bit block comprises an output obtained after the second bit block is through a first processing and an output obtained after all bits in the first bit block are input into a same channel coding or comprises an output obtained after bit(s) in the first bit block and bit(s) in the second bit block are separately input into different channel codings.

In one embodiment, the meaning of the phrase that whether the first condition is met is used to determine whether bit(s) in the first bit block and bit(s) in the second bit block are separately input into different channel codings to obtain the third bit block comprises: whether the first condition is met is used to determine whether the third bit block comprises an output obtained after the second bit block is through a first processing and all bits in the first bit block or comprises an output after bit(s) in the first bit block and bit(s) in the second bit block are separately input into different channel codings.

In one embodiment, the first bit block comprises a Hybrid Automatic Repeat reQuest ACKnowledgement (HARQ-ACK) bit, the second bit block comprises a Scheduling Request (SR) bit, and the first condition comprises: a number of bit(s) comprised in the first bit block is not greater than the first threshold; when a number of bit(s) comprised in the first bit block is not greater than the first threshold, the third bit block comprises all bits in the first bit block and all bits in the second bit block; when a number of bit(s) comprised in the first bit block is greater than the first threshold, the third bit block comprises outputs after bit(s) in the first bit block and bit(s) in the second bit block are separately input into different channel codings.

### Embodiment 1B

Embodiment 1B illustrates a flowchart of the processing of a first node according to one embodiment of the present application, as shown in FIG. 1.

In embodiment 1B, the first node in the present application receives a first signaling in step 101B; transmits a first signal in a first time-frequency resource pool in step 102B.

In Embodiment 1B, the first signal carries a third bit block and a fourth bit block; the first signaling is used to determine the first time-frequency resource pool; the first time-frequency resource pool is reserved for the fourth bit block; a first bit block comprises first-type HARQ-ACK bit(s), and a second bit block comprises second-type HARQ-ACK bit(s); the second-type HARQ-ACK bit(s) comprised in the second bit block comprises CBG-based second-type HARQ-ACK bit(s); the first bit block and the second bit block are used to determine the third bit block; the first signaling is used to determine a first offset value; a first calculation amount is related to at least first two of a first offset value, a number of bit(s) comprised in the first bit block and a number of bit(s) comprised in the second bit block; when the first calculation amount is not greater than a second calculation amount, the third bit block comprises the CBG-based second-type HARQ-ACK bit(s) comprised in the second bit block; when the first calculation amount is greater than a second calculation amount, the third bit block does not comprise at least part of CBG-based second-type HARQ-ACK bit(s) in the second bit block and the third bit block comprises TB-based second-type HARQ-ACK bit(s) related to the second bit block.

In one embodiment, the first signal comprises a radio signal.

In one embodiment, the first signal comprises a radio-frequency signal.

In one embodiment, the first signal comprises a baseband signal.

In one embodiment, the first signaling is dynamically configured.

In one embodiment, the first signaling comprises an L1 signaling.

In one embodiment, the first signaling comprises an L1 control signaling.

In one embodiment, the first signaling comprises a physical-layer signaling.

In one embodiment, the first signaling comprises one or multiple fields in a physical-layer signaling.

In one embodiment, the first signaling comprises a higher-layer signaling.

In one embodiment, the first signaling comprises one or multiple fields in a higher-layer signaling.

In one embodiment, the first signaling comprises a Radio Resource Control (RRC) signaling.

In one embodiment, the first signaling comprises a Medium Access Control layer Control Element (MAC CE) signaling.

In one embodiment, the first signaling comprises one or multiple fields in an RRC signaling.

In one embodiment, the first signaling comprises one or multiple fields in a MAC CE signaling.

In one embodiment, the first signaling comprises Downlink Control Information (DCI).

In one embodiment, the first signaling comprises one or multiple fields in a DCI.

In one embodiment, the first signaling comprises Sidelink Control Information (SCI).

In one embodiment, the first signaling comprises one or multiple fields in an SCI.

In one embodiment, the first signaling comprises one or multiple Fields in an Information Element (IE).

In one embodiment, the first signaling is an UpLink Grant Signalling.

In one embodiment, the first signaling is transmitted on a downlink physical layer control channel (i.e., a downlink channel capable of bearing a physical-layer signaling).

In one embodiment, the downlink physical-layer control channel in the present application is a Physical Downlink Control CHannel (PDCCH).

In one subembodiment of the above embodiment, the downlink physical layer control channel in the present application is a short PDCCH (sPDCCH).

In one embodiment, the downlink physical layer control channel in the present application is a Narrow Band PDCCH (NB-PDCCH).

In one embodiment, the first signaling is DCI format 0_0, and for the specific meaning of the DCI format 0_0, refer to section 7.3.1.1 in 3GPP TS38.212.

In one embodiment, the first signaling is DCI format 0_1, and for the specific meaning of the DCI format 0_1, refer to section 7.3.1.1 in 3GPP TS38.212.

In one embodiment, the first signaling is DCI format 0_2, and for the specific meaning of the DCI format 0_2, refer to section 7.3.1.1 in 3GPP TS38.212.

In one embodiment, the meaning of the phrase that the first signal carry a third bit block and a fourth bit block comprises that: the first signal comprises an output after all or partial bits in the third bit block are sequentially through part or all of CRC Insertion, Segmentation, code-block level CRC Insertion, Channel Coding, Rate Matching, Concatenation, Scrambling, Modulation, Layer Mapping, Precoding, Mapping to Resource Element, generation of multi-carrier symbol and Modulation and Upconversion, and the first signal comprises an output after all or partial bits in the second bit block are sequentially through part or all of CRC Insertion, Segmentation, code-block level CRC Insertion, Channel Coding, Rate Matching, Concatenation, Scrambling, Modulation, Layer Mapping, Precoding, Mapping to Resource Element, generation of multi-carrier symbol and Modulation and Upconversion.

In one embodiment, the first time-frequency resource pool comprises a positive integer number of time-frequency resource element(s).

In one embodiment, the first time-frequency resource pool comprises a positive integer number of RE(s) in time frequency domain.

In one embodiment, the RE occupies a multicarrier symbol in time domain, and a subcarrier in frequency domain.

In one embodiment, the time-frequency resource element in the present application is an RE.

In one embodiment, the time-frequency resource element in the present application comprises a subcarrier in frequency domain.

In one embodiment, the time-frequency resource element in the present application comprises a multicarrier symbol in time domain.

In one embodiment, the multicarrier symbol in the present application is an Orthogonal Frequency Division Multiplexing (OFDM) symbol.

In one embodiment, the multicarrier symbol in the present application is a Single Carrier- Frequency Division Multiple Access (SC-FDMA) symbol.

In one embodiment, the multicarrier symbol in the present application is a Discrete Fourier Transform Spread OFDM (DFT-S-OFDM) symbol.

In one embodiment, the first time-frequency resource pool comprises a positive integer number of subcarrier(s) in frequency domain.

In one embodiment, the first time-frequency resource pool comprises a positive integer number of PRB(s) in frequency domain.

In one embodiment, the first time-frequency resource pool comprises a positive integer number of RB(s) in frequency domain.

In one embodiment, the first time-frequency resource pool comprises a positive integer number of multi-carrier symbol(s) in time domain.

In one embodiment, the first time-frequency resource pool comprises a positive integer number of slot(s) in time domain.

In one embodiment, the first time-frequency resource pool comprises a positive integer number of sub-slot(s) in time domain.

In one embodiment, the first time-frequency resource pool comprises a positive integer number of ms(s) in time domain.

In one embodiment, the first time-frequency resource pool comprises a positive integer number of continuous multi-carrier symbol(s) in time domain.

In one embodiment, the first time-frequency resource pool comprises a positive integer number of discontinuous slot(s) in time domain.

In one embodiment, the first time-frequency resource pool comprises a positive integer number of continuous slot(s) in time domain.

In one embodiment, the first time-frequency resource pool comprises a positive integer number of subframe(s) in time domain.

In one embodiment, the first time-frequency resource pool is configured by a physical-layer signaling.

In one embodiment, the first time-frequency resource pool is configured by a higher-layer signaling.

In one embodiment, the first time-frequency resource pool is configured by a Radio Resource Control (RRC) signaling.

In one embodiment, the first time-frequency resource pool is configured by a Medium Access Control layer Control Element (MAC CE) signaling.

In one embodiment, the first time-frequency resource pool is reserved for an uplink physical-layer channel.

In one embodiment, the first time-frequency resource pool comprises time-frequency resources reserved for an uplink physical layer channel.

In one embodiment, the first time-frequency resource pool comprises time-frequency resources occupied by an uplink physical layer channel.

In one embodiment, the first time-frequency resource pool is reserved for a Physical Uplink Shared CHannel (PUSCH).

In one embodiment, the first time-frequency resource pool comprises time-frequency resources reserved for a PUSCH.

In one embodiment, the first time-frequency resource pool comprises time-frequency resources occupied by a PUSCH.

In one embodiment, the first time-frequency resource pool is reserved for a Physical Sidelink Shared CHannel (PSSCH).

In one embodiment, the first signaling indicates the first time-frequency resource pool.

In one embodiment, the first signaling explicitly indicates the first time-frequency resource pool.

In one embodiment, the first signaling implicitly indicates the first time-frequency resource pool.

In one embodiment, the first signaling indicates frequency-domain resources comprised in the first time-frequency resource pool.

In one embodiment, the first signaling indicates time-domain resources comprised in the first time-frequency resource pool.

In one embodiment, the first signaling is used to configure a period characteristic associated with the first time-frequency resource pool.

In one embodiment, the implicitly indicating in the present application comprises: it is indicated implicitly via a signaling format.

In one embodiment, the implicitly indicating in the present application comprises: it is indicated implicitly via an RNTI.

In one embodiment, the first signaling comprises scheduling information of the fourth bit block.

In one embodiment, the first signaling comprises first scheduling information; the first scheduling information comprises at least one of occupied time-domain resources, occupied frequency-domain resources, a Modulation and Coding Scheme (MCS), configuration information of DeModulation Reference Signals (DMRS), a Hybrid Automatic Repeat request (HARQ) process number, a Redundancy Version (RV), a New Data Indicator (NDI), a periodicity, a transmission antenna port, or a corresponding Transmission Configuration Indicator (TCI) state.

In one embodiment, the phrase of being used for in the present application comprises: being used by the first node for.

In one embodiment, the phrase of being used for in the present application comprises: being used by a transmitting end of the first signal for.

In one embodiment, the phrase of being used for in the present application comprises: being used by a receiving end of the first signal for.

In one embodiment, the HARQ-ACK bit in the present application comprises: an information bit indicating whether a signaling is correctly received, or an information bit indicating whether a bit block scheduled by a signaling (such as a TB or a CBG) is correctly received.

In one embodiment, the HARQ-ACK bit in the present application comprises: an information bit indicating whether a signaling used to indicate a Semi-Persistent Scheduling (SPS) release is correctly received, or, an information bit indicating whether a bit transmitted on a Physical Downlink Shared Channel (PDSCH) scheduled by a signaling (such as a TB or a CBG) is correctly received.

In one embodiment, the first-type HARQ-ACK bit is different from the second-type HARQ-ACK bit.

In one embodiment, both the first-type HARQ-ACK bit and the second-type HARQ-ACK are HARQ-ACK information bits.

In one embodiment, the first-type HARQ-ACK bit comprises a HARQ-ACK bit corresponding to one of multiple Quality of Service (QoS) types.

In one embodiment, the first-type HARQ-ACK bit comprises a HARQ-ACK bit corresponding to URLLC traffic type.

In one embodiment, the first-type HARQ-ACK bit comprises a HARQ-ACK bit corresponding to eMBB traffic type.

In one embodiment, the first-type HARQ-ACK bit comprises a high-priority HARQ-ACK bit.

In one embodiment, the first-type HARQ-ACK bit comprises a low-priority HARQ-ACK bit.

In one embodiment, the first-type HARQ-ACK bit comprises a HARQ-ACK bit corresponding to priority index 1.

In one embodiment, the first-type HARQ-ACK bit comprises a HARQ-ACK bit corresponding to priority index 0.

In one embodiment, the first-type HARQ-ACK bit comprises sidelink HARQ-ACK (SL HARQ-ACK) bit.

In one embodiment, the second-type HARQ-ACK bit comprises a HARQ-ACK bit corresponding to one of multiple QoS types.

In one embodiment, the second-type HARQ-ACK bit comprises a HARQ-ACK bit corresponding to URLLC traffic type.

In one embodiment, the second-type HARQ-ACK bit comprises a HARQ-ACK bit corresponding to eMBB traffic type.

In one embodiment, the second-type HARQ-ACK bit comprises a high-priority HARQ-ACK bit.

In one embodiment, the second-type HARQ-ACK bit comprises a low-priority HARQ-ACK bit.

In one embodiment, the second-type HARQ-ACK bit comprises a HARQ-ACK bit corresponding to priority index 1.

In one embodiment, the second-type HARQ-ACK bit comprises a HARQ-ACK bit corresponding to priority index 0.

In one embodiment, the second-type HARQ-ACK bit comprises a sidelink HARQ-ACK bit.

In one embodiment, the second-type HARQ-ACK bit(s) and the first-type HARQ-ACK bit(s) are respectively HARQ-ACK bits for different links.

In one embodiment, the different links comprise uplink and sidelink.

In one embodiment, the second-type HARQ-ACK bit(s) and the first-type HARQ-ACK bit(s) are respectively HARQ-ACK bits used for different traffic types.

In one embodiment, the second-type HARQ-ACK bit(s) and the first-type HARQ-ACK bit(s) are respectively HARQ-ACK bits with different types.

In one embodiment, the second-type HARQ-ACK bit(s) and the first-type HARQ-ACK bit(s) are respectively HARQ-ACK bits with different priorities.

In one embodiment, the second-type HARQ-ACK bit(s) and the first-type HARQ-ACK bit(s) are respectively HARQ-ACK bits corresponding to different priority indexes.

In one embodiment, the second-type HARQ-ACK bit comprises a HARQ-ACK bit corresponding to priority index 1, and the first-type HARQ-ACK bit comprises a HARQ-ACK bit corresponding to priority index 0.

In one embodiment, the second-type HARQ-ACK bit comprises a HARQ-ACK bit corresponding to priority index 0, and the first-type HARQ-ACK comprises a HARQ-ACK bit corresponding to priority index 1.

In one embodiment, the first bit block comprises a UCI.

In one embodiment, the first bit block comprises a HARQ-ACK bit.

In one embodiment, the first bit block comprises a positive integer number of bit(s).

In one embodiment, the first bit block comprises a positive integer number of ACK(s) or NACK(s).

In one embodiment, the first bit block comprises a HARQ-ACK codebook.

In one embodiment, the first bit block comprises a HARQ-ACK sub-codebook.

In one embodiment, the second bit block comprises a UCI.

In one embodiment, the second bit block comprises a HARQ-ACK bit.

In one embodiment, the second bit block comprises a positive integer number of bit(s).

In one embodiment, the second bit block comprises a positive integer number of ACK(s) or NACK(s).

In one embodiment, the second bit block comprises a HARQ-ACK codebook.

In one embodiment, the second bit block comprises a HARQ-ACK sub-codebook.

In one embodiment, the third bit block comprises a HARQ-ACK bit.

In one embodiment, the third bit block comprises a positive integer number of bit(s).

In one embodiment, the third bit block comprises a positive integer number of ACK(s) or NACK(s).

In one embodiment, the third bit block comprises a HARQ-ACK codebook.

In one embodiment, the third bit block comprises a HARQ-ACK sub-codebook.

In one embodiment, the fourth bit block comprises a positive integer number of bit(s).

In one embodiment, the fourth bit block comprises a Transport Block (TB).

In one embodiment, the fourth bit block comprises a Code Block (CB).

In one embodiment, the fourth bit block comprises a Code Block Group (CBG).

In one embodiment, the first signaling indicates transmitting the fourth bit block in the first time-frequency resource pool.

In one embodiment, the first signaling indicates that the first time-frequency resource pool is time-frequency resources reserved for transmitting the fourth bit block.

In one embodiment, the first time-frequency resource pool comprises time-frequency resources reserved for transmitting a PUSCH of the fourth bit block.

In one embodiment, the first signal comprises an output after all or partial bits in the third bit block group and the fourth bit block are sequentially through part or all of CRC Insertion, Segmentation, Code Block-level CRC Insertion, Channel Coding, Rate Matching, Concatenation, Scrambling, Modulation, Layer Mapping, Precoding, Mapping to Resource Element, Multicarrier symbol Generation and Modulation and Upconversion.

In one embodiment, the first bit block comprises one or multiple the first-type HARQ-ACK bits.

In one embodiment, the first bit block comprises multiple CBG-based first-type HARQ-ACK bits.

In one embodiment, the first bit block comprises one or multiple TB-based first-type HARQ-ACK bits.

In one embodiment, the second bit block comprises one or multiple second-type HARQ-ACK bits.

In one embodiment, the second bit block comprises multiple CBG-based second-type HARQ-ACK bits.

In one embodiment, the second bit block comprises one or multiple TB-based second-type HARQ-ACK bits.

In one embodiment, the first bit block comprises: part or all of a CBG-based HARQ-ACK code-book (or sub-codebook) comprising the first-type HARQ-ACK bit.

In one embodiment, the first bit block comprises: part or all of a TB-based HARQ-ACK code-book (or sub-codebook) comprising the first-type HARQ-ACK bit.

In one embodiment, the second bit block comprises: part or all of a CBG-based HARQ-ACK code-book (or sub-codebook) comprising the second-type HARQ-ACK bit.

In one embodiment, the second bit block comprises: part or all of a TB-based HARQ-ACK code-book (or sub-codebook) comprising the second-type HARQ-ACK bit.

In one embodiment, the CBG-based second-type HARQ-ACK comprises: the second-type HARQ-ACK bit in a CBG-based HARQ-ACK codebook.

In one embodiment, the CBG-based second-type HARQ-ACK comprises: the second-type HARQ-ACK bit in a CBG-based HARQ-ACK sub-codebook.

In one embodiment, the CBG-based second-type HARQ-ACK comprises: the second-type HARQ-ACK bit used to indicate whether CBG(s) in CBG-based Physical Downlink Shared CHannel (PDSCH) reception(s) is(are) correctly received.

In one embodiment, the CBG-based second-type HARQ-ACK bit indicates whether a CBG in a TB is correctly received.

In one embodiment, a CBG being correctly received refers to: all code block(s) in the code-block group is(are) correctly received.

In one embodiment, the TB-based second-type HARQ-ACK comprises: the second-type HARQ-ACK bit in a TB-based HARQ-ACK codebook.

In one embodiment, the TB-based second-type HARQ-ACK comprises: the second-type HARQ-ACK bit in a TB-based HARQ-ACK sub-codebook.

In one embodiment, the TB-based second-type HARQ-ACK comprises: the second-type HARQ-ACK bit used to indicate whether an SPS PDSCH release, an SPS PDSCH reception, or a TB-based PDSCH reception is correctly received.

In one embodiment, the TB-based second-type HARQ-ACK bit indicates whether an SPS PDSCH release or a TB is correctly received.

In one embodiment, the TB in the present application comprises one or multiple code-block groups.

In one embodiment, the CBG in the present application comprises one or multiple code blocks.

In one embodiment, the third bit block comprises the first bit block; the third bit block comprises the second bit block or the second-type HARQ-ACK bit related to the second bit block.

In one embodiment, the third bit block comprises the first bit block or the first-type HARQ-ACK bit related to the first bit block; the third bit block comprises the second bit block or the second-type HARQ-ACK bit related to the second bit block.

In one embodiment, the third bit block comprises an output after the first bit block is through one or multiple of logical AND, logical OR, XOR, deleting bits, precoding, inserting repeated bits, or zero padding operations.

In one embodiment, when the first calculation amount is not greater than a second calculation amount: the third bit block comprises all CBG-based second-type HARQ-ACK bits comprised in the second bit block.

In one embodiment, the meaning of the expression that the third bit block does not comprise at least part of CBG-based second-type HARQ-ACK bits in the second bit block comprises: the third bit block does not comprise the CBG-based second-type HARQ-ACK bit.

In one embodiment, the meaning of the expression that the third bit block does not comprise at least part of CBG-based second-type HARQ-ACK bits in the second bit block comprises: the CBG-based second-type HARQ-ACK bit is not transmitted in the first time-frequency resource pool.

In one embodiment, the meaning of the expression that the third bit block does not comprise at least part of CBG-based second-type HARQ-ACK bits in the second bit block comprises: all or partial CBG-based second-type HARQ-ACK bits in the second bit block are not transmitted in the first time-frequency resource pool.

In one embodiment, the meaning of the expression that the third bit block comprises the TB-based second-type HARQ-ACK bit related to the second bit block comprises: the second bit block comprises multiple CBG-based second-type HARQ-ACK bits generated for a first TB, and a number of the second-type HARQ-ACK bit(s) generated for the first TB comprised in the third bit block is equal to 1.

In one embodiment, the meaning of the expression that the third bit block comprises the TB-based second-type HARQ-ACK bit related to the second bit block comprises: a first TB comprises multiple CBGs, the second bit block comprises multiple second-type HARQ-ACK bits indicating whether the multiple CBGs in the first TB are correctly received, and a number of the second-type HARQ-ACK bit(s) indicating whether the first TB is correctly received comprised in the third bit block is equal to 1.

In one embodiment, the TB-based second-type HARQ-ACK bit related to the second bit block comprised in the third bit block indicates whether a signaling indicating a Semi-Persistent Scheduling (SPS) PDSCH release or a TB is correctly received.

In one embodiment, when the first calculation amount is greater than the second calculation amount: any second-type HARQ-ACK bit comprised in the third bit block indicates whether a signaling indicating an SPS PDSCH release or a TB is correctly received.

In one embodiment, when the first calculation amount is greater than the second calculation amount: the third bit block comprises a first bit group; the first bit group comprised in the third bit block indicates whether the third bit block comprises the CBG-based second-type HARQ-ACK bit.

In one embodiment, when the first calculation amount is greater than the second calculation amount: a number of the CBG-based second-type HARQ-ACK bit(s) comprised in the third bit block is less than the CBG-based second-type HARQ-ACK comprised in the second bit block.

In one embodiment, the second calculation amount is related to a higher-layer parameter scaling.

In one embodiment, the second calculation amount is equal to a parameter multiplied by a second resource amount.

In one embodiment, the second resource amount in the present application is equal to a number of time-frequency resource element(s) that can be used for UCI transmission on one or multiple multicarrier symbols.

In one embodiment, the parameter used to determine the second calculation amount is configured by a higher-layer signaling.

In one embodiment, the parameter used to determine the second calculation amount is a value configured by a higher-layer parameter scaling.

In one embodiment, the second calculation amount is equal to a seventh calculation amount minus a first difference value, and a priority corresponding to the fourth bit block is used to determine the first difference value.

In one subembodiment of the above embodiment, the first difference value is not negative.

In one subembodiment of the above embodiment, a first difference value is equal to a rounded result obtained by multiplying a number of bit(s) comprised in the first bit block by a first multiplication value; a priority corresponding to the fourth bit block is used to determine the first multiplication value.

In one subembodiment of the above embodiment, a first difference value is equal to a rounded result obtained by multiplying a number of bit(s) comprised in the first bit block by a first multiplication value; the priority corresponding to the fourth bit block is a priority in a first priority set, and the first multiplication value is a multiplication value in a first multiplication value set; multiple priorities in the first priority set respectively correspond to multiple multiplication values in the first multiplication value set, and a multiplication value in the first multiplication value set corresponding to the priority corresponding to the fourth bit block is the first multiplication value; a priority in the first priority set is higher-layer-signaling-configured or default, and a multiplication value in the first multiplication value set is higher-layer-signaling-configured or default or calculated through calculation.

In one subembodiment of the above embodiment, the priority corresponding to the fourth bit block is a priority in a first priority set, and the first difference value is a difference value in a first difference value set; multiple priorities in the first priority set respectively correspond to multiple difference values in the first difference value set, and a difference value in the first difference value corresponding to the priority corresponding to the fourth bit block is the first difference value; a priority in the first priority set is higher-layer-signaling-configured or default, and a difference value in the first difference value set is higher-layer-signaling-configured or default.

In one subembodiment of the above embodiment, the seventh calculation amount is related to a higher-layer parameter scaling.

In one subembodiment of the above embodiment, the seventh calculation amount is equal to a parameter value multiplied by a second resource amount; the second resource amount is equal to a number of time-frequency resource element(s) that can be used for a UCI transmission on one or multiple multicarrier symbols, and the parameter value used to determine the seventh calculation amount is configured by a higher-layer signaling.

In one subembodiment of the above embodiment, the seventh calculation amount is equal to a parameter value multiplied by a second resource amount; the second resource amount is equal to a number of time-frequency resource element(s) that can be used for a UCI transmission on one or multiple multicarrier symbols, and the parameter value used to determine the seventh calculation amount is a value configured by a higher-layer parameter scaling.

### Embodiment 2

Embodiment 2 illustrates a schematic diagram of a network architecture according to the present application, as shown in FIG. 2.

FIG. 2 illustrates a network architecture 200 of 5G NR, Long-Term Evolution (LTE) and Long-Term Evolution Advanced (LTE-A) systems. The NR 5G or LTE network architecture 200 may be called an Evolved Packet System (EPS) 200 or other appropriate terms. The EPS 200 may comprise one or multiple UEs 201, an NG-RAN 202, an Evolved Packet Core/ 5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201 –oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow-band Internet of Things (loT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/ Authentication Management Field (AMF)/ User Plane Function (UPF) 211, other MMEs/ AMFs/ UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212, the S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 241 corresponds to the second node in the present application.

In one embodiment, the gNB 203 corresponds to the second node in the present application.

In one embodiment, the UE 241 corresponds to the first node in the present application.

In one embodiment, the UE 201 corresponds to the second node in the present application.

In one embodiment, the UE 201 corresponds to the first node in the present application, and the gNB 203 corresponds to the second node in the present application.

In one embodiment, the gNB 203 is a MarcoCellular base station.

In one embodiment, the gNB 203 is a Micro Cell base station.

In one embodiment, the gNB 203 is a PicoCell base station.

In one embodiment, the gNB 203 is a Femtocell.

In one embodiment, the gNB 203 is a base station supporting large delay differences.

In one embodiment, the gNB 203 is a flight platform.

In one embodiment, the gNB 203 is satellite equipment.

In one embodiment, both the first node and the second node in the present application correspond to the UE 201, for example, V2X communications are executed between the first node and the second node.

### Embodiment 3

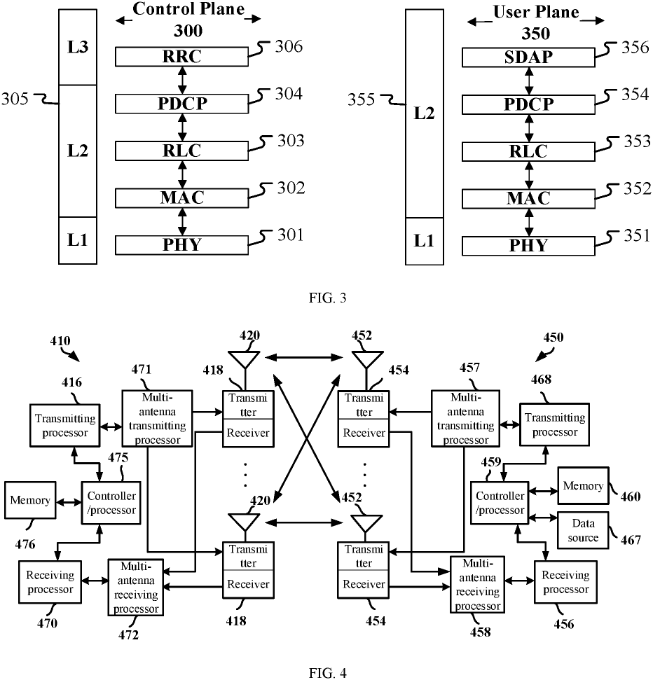

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first communication node and a second communication node, as well as two UEs via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first bit block in the present application is generated by the RRC sublayer 306.

In one embodiment, the first bit block in the present application is generated by the MAC sublayer 302.

In one embodiment, the first bit block in the present application is generated by the MAC sublayer 352.

In one embodiment, the first bit block in the present application is generated by the PHY 301.

In one embodiment, the first bit block in the present application is generated by the PHY 351.

In one embodiment, the second bit block in the present application is generated by the RRC sublayer 306.

In one embodiment, the second bit block in the present application is generated by the SDAP sublayer 356.

In one embodiment, the second bit block in the present application is generated by the MAC sublayer 302.

In one embodiment, the second bit block in the present application is generated by the MAC sublayer 352.

In one embodiment, the second bit block in the present application is generated by the PHY 301.

In one embodiment, the second bit block in the present application is generated by the PHY 351.

In one embodiment, the third bit block in the present application is generated by the RRC sublayer 306.

In one embodiment, the third bit block in the present application is generated by the MAC sublayer 302.

In one embodiment, the third bit block in the present application is generated by the MAC sublayer 352.

In one embodiment, the third bit block in the present application is generated by the PHY 301.

In one embodiment, the third bit block in the present application is generated by the PHY 351.

In one embodiment, the fourth bit block in the present application is generated by the SDAP sublayer 356.

In one embodiment, the fourth bit block in the present application is generated by the RRC sublayer 306.

In one embodiment, the fourth bit block in the present application is generated by the MAC sublayer 302.

In one embodiment, the fourth bit block in the present application is generated by the MAC sublayer 352.

In one embodiment, the fourth bit block in the present application is generated by the PHY 301.

In one embodiment, the fourth bit block in the present application is generated by the PHY 351.

In one embodiment, the first signaling in the present application is generated by the RRC sublayer 306.

In one embodiment, the first signaling in the present application is generated by the MAC sublayer 302.

In one embodiment, the first signaling in the present application is generated by the MAC sublayer 352.

In one embodiment, the first signaling in the present application is generated by the PHY 301.

In one embodiment, the first signaling in the present application is generated by the PHY 351.

In one embodiment, a signaling in the first signaling group in the present application is generated by the RRC sublayer 306.

In one embodiment, a signaling in the first signaling in the present application is generated by the MAC sublayer 302.

In one embodiment, a signaling in the first signaling in the present application is generated by the MAC sublayer 352.

In one embodiment, a signaling in the first signaling group in the present application is generated by the PHY 301.

In one embodiment, a signaling in the first signaling group in the present application is generated by the PHY 351.

In one embodiment, the first bit block in the present application is generated by the RRC sublayer 306.

In one embodiment, the first bit block in the present application is generated by the MAC sublayer 302.

In one embodiment, the first bit block in the present application is generated by the MAC sublayer 352.

In one embodiment, the first bit block in the present application is generated by the PHY 301.

In one embodiment, the first bit block in the present application is generated by the PHY 351.

In one embodiment, the second bit block in the present application is generated by the RRC sublayer 306.

In one embodiment, the second bit block in the present application is generated by the SDAP sublayer 356.

In one embodiment, the second bit block in the present application is generated by the MAC sublayer 302.

In one embodiment, the second bit block in the present application is generated by the MAC sublayer 352.

In one embodiment, the second bit block in the present application is generated by the PHY 301.

In one embodiment, the second bit block in the present application is generated by the PHY 351.

In one embodiment, the third bit block in the present application is generated by the RRC sublayer 306.

In one embodiment, the third bit block in the present application is generated by the MAC sublayer 302.

In one embodiment, the third bit block in the present application is generated by the MAC sublayer 352.

In one embodiment, the third bit block in the present application is generated by the PHY 301.

In one embodiment, the third bit block in the present application is generated by the PHY 351.

In one embodiment, the fourth bit block in the present application is generated by the SDAP sublayer 356.

In one embodiment, the fourth bit block in the present application is generated by the RRC sublayer 306.

In one embodiment, the fourth bit block in the present application is generated by the MAC sublayer 302.

In one embodiment, the fourth bit block in the present application is generated by the MAC sublayer 352.

In one embodiment, the fourth bit block in the present application is generated by the PHY 301.

In one embodiment, the fourth bit block in the present application is generated by the PHY 351.

In one embodiment, the first TB in the present application is generated by the SDAP sublayer 356.

In one embodiment, the first TB in the present application is generated by the RRC sublayer 306.

In one embodiment, the first TB in the present application is generated by the MAC sublayer 302.

In one embodiment, the first TB in the present application is generated by the MAC sublayer 352.

In one embodiment, the first TB in the present application is generated by the PHY 301.

In one embodiment, the first TB in the present application is generated by the PHY 351.

In one embodiment, a TB in the second TB group in the present application is generated by the SDAP sublayer 356.

In one embodiment, a TB in the second TB group in the present application is generated by RRC sublayer 306.

In one embodiment, a TB in the second TB group in the present application is generated by MAC sublayer 302.

In one embodiment, a TB in the second TB group in the present application is generated by MAC sublayer 352.

In one embodiment, a TB in the second TB group in the present application is generated by the PHY 301.

In one embodiment, a TB in the second TB group in the present application is generated by the PHY 351.

In one embodiment, the first signaling in the present application is generated by the RRC sublayer 306.

In one embodiment, the first signaling in the present application is generated by the MAC sublayer 302.

In one embodiment, the first signaling in the present application is generated by the MAC sublayer 352.

In one embodiment, the first signaling in the present application is generated by the PHY 301.

In one embodiment, the first signaling in the present application is generated by the PHY 351.

In one embodiment, the second signaling in the present application is generated by the RRC sublayer 306.

In one embodiment, the second signaling in the present application is generated by the MAC sublayer 302.

In one embodiment, the second signaling in the present application is generated by the MAC sublayer 352.

In one embodiment, the second signaling in the present application is generated by the PHY 301.

In one embodiment, the second signaling in the present application is generated by the PHY 351.

In one embodiment, the third signaling in the present application is generated by the RRC sublayer 306.

In one embodiment, the third signaling in the present application is generated by the MAC sublayer 302.

In one embodiment, the third signaling in the present application is generated by the MAC sublayer 352.

In one embodiment, the third signaling in the present application is generated by the PHY 301.

In one embodiment, the third signaling in the present application is generated by the PHY 351.

### Embodiment 4

Embodiment 4 illustrates a schematic diagram of a first communication device and a second communication device in the present application, as shown in FIG. 4. FIG. 4 is a block diagram of a first communication device 410 in communication with a second communication device 450 in an access network.

The first communication device 410 comprises a controller/ processor 475, a memory 476, a receiving processor 470, a transmitting processor 416, a multi-antenna receiving processor 472, a multi-antenna transmitting processor 471, a transmitter/ receiver 418 and an antenna 420.

The second communication device 450 comprises a controller/ processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/ processor 475. The controller/processor 475 provides a function of the L2 layer. In the transmission from the first communication device 410 to the first communication device 450, the controller/ processor 475 provides header compression, encryption, packet segmentation and reordering, and multiplexing between a logical channel and a transport channel, and radio resources allocation to the second communication device 450 based on various priorities. The controller/ processor 475 is also responsible for retransmission of a lost packet and a signaling to the second communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or multiple spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the second communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the first communication device 410 to the second communication device 450, the controller/ processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication device 410 to the second communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the second communication device 450 to the first communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first node in the present application comprises the second communication device 450, and the second node in the present application comprises the first communication device 410.

In one subembodiment of the above embodiment, the first node is a UE, and the second node is a UE.

In one subembodiment of the above embodiment, the first node is a UE, and the second node is a relay node.

In one subembodiment of the above embodiment, the first node is a relay node, and the second node is a UE.

In one subembodiment of the above embodiment, the first node is a UE, and the second node is a base station.

In one subembodiment of the above embodiment, the first node is a relay node, and the second node is a base station.

In one subembodiment of the above embodiment, the second communication device 450 comprises: at least one controller/ processor; the at least one controller/ processor is responsible for HARQ operation.

In one subembodiment of the above embodiment, the first communication device 410 comprises: at least one controller/ processor; the at least one controller/ processor is responsible for HARQ operation.

In one subembodiment of the above embodiment, the first communication device 410 comprises: at least one controller/ processor; the at least one controller/ processor is responsible for error detection using ACK and/ or NACK protocols as a way to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: receives the first signaling in the present application; and transmits the first signal in the present application in the first radio resource pool in the present application, and the first signal carries the first bit block in the present application and the second bit block in the present application; herein, the first signaling is used to determine the first radio resource pool; the first condition in the present application is a condition related to a size relation between a first number in the present application and a first threshold in the present application, and at least one of a number of bit(s) comprised in the first bit block or a number of bit(s) comprised in the second bit block is used to determine the first number; the third bit block in the present application is used to generate the first signal, the first bit block and the second bit block are used to generate the third bit block, and whether the first condition is met is used to determine whether bit(s) in the first bit block and bit(s) in the second bit block are separately input into different channel codings to obtain the third bit block.

In one subembodiment of the above embodiment, the second communication device 450 corresponds to the first node in the present application.

In one embodiment, the second communication device 450 comprises a memory that stores a computer readable instruction program. The computer readable instruction program generates an action when executed by at least one processor. The action includes: receiving the first signaling in the present application; and transmitting the first signal in the present application in the first radio resource pool in the present application, and the first signal carrying the first bit block in the present application and the second bit block in the present application; herein, the first signaling is used to determine the first radio resource pool; the first condition in the present application is a condition related to a size relation between a first number in the present application and a first threshold in the present application, and at least one of a number of bit(s) comprised in the first bit block or a number of bit(s) comprised in the second bit block is used to determine the first number; the third bit block in the present application is used to generate the first signal, the first bit block and the second bit block are used to generate the third bit block, and whether the first condition is met is used to determine whether bit(s) in the first bit block and bit(s) in the second bit block are separately input into different channel codings to obtain the third bit block.

In one subembodiment of the above embodiment, the second communication device 450 corresponds to the first node in the present application.

In one embodiment, the first communication device 410 comprises at least one processor and at least one memory. The at least one memory comprises computer program codes; the at least one memory and the computer program codes are configured to be used in collaboration with the at least one processor. The first communication device 410 at least: transmits the first signaling in the present application; and receives the first signal in the present application in the first radio resource pool in the present application, and the first signal carries the first bit block in the present application and the second bit block in the present application; herein, the first signaling is used to determine the first radio resource pool; the first condition in the present application is a condition related to a size relation between a first number in the present application and a first threshold in the present application, and at least one of a number of bit(s) comprised in the first bit block or a number of bit(s) comprised in the second bit block is used to determine the first number; the third bit block in the present application is used to generate the first signal, the first bit block and the second bit block are used to generate the third bit block, and whether the first condition is met is used to determine whether bit(s) in the first bit block and bit(s) in the second bit block are separately input into different channel codings to obtain the third bit block.

In one subembodiment of the above embodiment, the first communication device 410 corresponds to the second node in the present application.

In one embodiment, the first communication device 410 comprises a memory that stores a computer readable instruction program. The computer readable instruction program generates an action when executed by at least one processor. The action includes: transmitting the first signaling in the present application; and receiving the first signal in the present application in the first radio resource pool in the present application, and the first signal carrying the first bit block in the present application and the second bit block in the present application; herein, the first signaling is used to determine the first radio resource pool; the first condition in the present application is a condition related to a size relation between a first number in the present application and a first threshold in the present application, and at least one of a number of bit(s) comprised in the first bit block or a number of bit(s) comprised in the second bit block is used to determine the first number; the third bit block in the present application is used to generate the first signal, the first bit block and the second bit block are used to generate the third bit block, and whether the first condition is met is used to determine whether bit(s) in the first bit block and bit(s) in the second bit block are separately input into different channel codings to obtain the third bit block.

In one subembodiment of the above embodiment, the first communication device 410 corresponds to the second node in the present application.

In one embodiment, at least one of the antenna 452, the receiver 454, the multi-antenna receiving processor 458, the receiving processor 456, the controller / processor 459, the memory 460, or the data source 467 is used to receive the first signaling in the present application.

In one embodiment, at least one of the antenna 420, the transmitter 418, the multi-antenna transmitting processor 471, the transmitting processor 416, the controller/ processor 475, or the memory 476 is used to transmit the first signaling in the present application.

In one embodiment, at least one of the antenna 452, the receiver 454, the multi-antenna receiving processor 458, the receiving processor 456, the controller / processor 459, the memory 460 or the data source 467 is used to receive the first signaling group in the present application.

In one embodiment, at least one of the antenna 420, the transmitter 418, the multi-antenna transmitting processor 471, the transmitting processor 416, the controller/ processor 475 or the memory 476 is used to transmit the first signaling group in the present application.

In one embodiment, at least one of the antenna 452, the transmitter 454, the multi-antenna transmission processor 458, the transmitting processor 468, the controller/ processor 459, the memory 460, or the data source 467 is used to transmit the first signal in the present application in the first radio resource pool in the present application.

In one embodiment, at least one of the antenna 420, the receiver 418, the multi-antenna receiving processor 472, the receiving processor 470, the controller/ processor 475, or the memory 476 is used to receive the first signal in the present application in the first radio resource pool in the present application.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: receives the first signaling in the present application; and transmits the first signal in the present application in the first time-frequency resource pool in the present application, the first signal carries the third bit block in the present application and the fourth bit block in the present application; herein, the first signaling is used to determine the first time-frequency resource pool; the first time-frequency resource pool is reserved for the fourth bit block; the first bit block in the present application comprises the first-type HARQ-ACK bit in the present application, and the second bit block in the present application comprises the second-type HARQ-ACK bit in the present application; the second-type HARQ-ACK bit(s) comprised in the second bit block comprises CBG-based second-type HARQ-ACK bit(s); the first bit block and the second bit block are used to determine the third bit block; the first signaling is used to determine the first offset value in the present application; the first calculation amount in the present application is related to at least first two of the first offset value, a number of bit(s) comprised in the first bit block or a number of bit(s) comprised in the second bit block; when the first calculation amount is not greater than the second calculation amount in the present application, the third bit block comprises the CBG-based second-type HARQ-ACK bit(s) comprised in the second bit block; when the first calculation amount is greater than the second calculation amount in the present application, the third bit block does not comprise at least part of CBG-based second-type HARQ-ACK bit(s) in the second bit block and the third bit block comprises TB-based second-type HARQ-ACK bit(s) related to the second bit block.

In one subembodiment of the above embodiment, the second communication device 450 corresponds to the first node in the present application.

In one embodiment, the second communication device 450 comprises a memory that stores a computer readable instruction program. The computer readable instruction program generates an action when executed by at least one processor. The action includes: receiving the first signaling in the present application; and transmitting the first signal in the present application in the first time-frequency resource pool in the present application, the first signal carrying the third bit block in the present application and the fourth bit block in the present application; herein, the first signaling is used to determine the first time-frequency resource pool; the first time-frequency resource pool is reserved for the fourth bit block; the first bit block in the present application comprises the first-type HARQ-ACK bit in the present application, and the second bit block in the present application comprises the second-type HARQ-ACK bit in the present application; the second-type HARQ-ACK bit(s) comprised in the second bit block comprises CBG-based second-type HARQ-ACK bit(s); the first bit block and the second bit block are used to determine the third bit block; the first signaling is used to determine the first offset value in the present application; the first calculation amount in the present application is related to at least first two of the first offset value, a number of bit(s) comprised in the first bit block or a number of bit(s) comprised in the second bit block; when the first calculation amount is not greater than a second calculation amount in the present application, the third bit block comprises the CBG-based second-type HARQ-ACK bit(s) comprised in the second bit block; when the first calculation amount is greater than the second calculation amount in the present application, the third bit block does not comprise at least part of CBG-based second-type HARQ-ACK bit(s) in the second bit block and the third bit block comprises TB-based second-type HARQ-ACK bit(s) related to the second bit block.

In one subembodiment of the above embodiment, the second communication device 450 corresponds to the first node in the present application.

In one embodiment, the first communication device 410 comprises at least one processor and at least one memory. The at least one memory comprises computer program codes; the at least one memory and the computer program codes are configured to be used in collaboration with the at least one processor. The first communication device 410 at least: transmits the first signaling in the present application; and receives the first signal in the present application in the first time-frequency resource pool in the present application, the first signal carries the third bit block in the present application and the fourth bit block in the present application; herein, the first signaling is used to determine the first time-frequency resource pool; the first time-frequency resource pool is reserved for the fourth bit block; the first bit block in the present application comprises the first-type HARQ-ACK bit in the present application, and the second bit block in the present application comprises the second-type HARQ-ACK bit in the present application; the second-type HARQ-ACK bit(s) comprised in the second bit block comprises CBG-based second-type HARQ-ACK bit(s); the first bit block and the second bit block are used to determine the third bit block; the first signaling is used to determine the first offset value in the present application; the first calculation amount in the present application is related to at least first two of the first offset value, a number of bit(s) comprised in the first bit block or a number of bit(s) comprised in the second bit block; when the first calculation amount is not greater than the second calculation amount in the present application, the third bit block comprises the CBG-based second-type HARQ-ACK bit(s) comprised in the second bit block; when the first calculation amount is greater than the second calculation amount in the present application, the third bit block does not comprise at least part of CBG-based second-type HARQ-ACK bit(s) in the second bit block and the third bit block comprises TB-based second-type HARQ-ACK bit(s) related to the second bit block.

In one subembodiment of the above embodiment, the first communication device 410 corresponds to the second node in the present application.

In one embodiment, the first communication device 410 comprises a memory that stores a computer readable instruction program. The computer readable instruction program generates an action when executed by at least one processor. The action includes: transmitting the first signaling in the present application; and receiving the first signal in the present application in the first time-frequency resource pool in the present application, the first signal carrying the third bit block in the present application and the fourth bit block in the present application; herein, the first signaling is used to determine the first time-frequency resource pool; the first time-frequency resource pool is reserved for the fourth bit block; the first bit block in the present application comprises the first-type HARQ-ACK bit in the present application, and the second bit block in the present application comprises the second-type HARQ-ACK bit in the present application; the second-type HARQ-ACK bit(s) comprised in the second bit block comprises CBG-based second-type HARQ-ACK bit(s); the first bit block and the second bit block are used to determine the third bit block; the first signaling is used to determine the first offset value in the present application; the first calculation amount in the present application is related to at least first two of the first offset value, a number of bit(s) comprised in the first bit block or a number of bit(s) comprised in the second bit block; when the first calculation amount is not greater than the second calculation amount in the present application, the third bit block comprises the CBG-based second-type HARQ-ACK bit(s) comprised in the second bit block; when the first calculation amount is greater than the second calculation amount in the present application, the third bit block does not comprise at least part of CBG-based second-type HARQ-ACK bit(s) in the second bit block and the third bit block comprises TB-based second-type HARQ-ACK bit(s) related to the second bit block.

In one subembodiment of the above embodiment, the first communication device 410 corresponds to the second node in the present application.

In one embodiment, at least one of the antenna 452, the receiver 454, the multi-antenna receiving processor 458, the receiving processor 456, the controller / processor 459, the memory 460, or the data source 467 is used to receive the first signaling in the present application.

In one embodiment, at least one of the antenna 420, the transmitter 418, the multi-antenna transmitting processor 471, the transmitting processor 416, the controller/ processor 475, or the memory 476 is used to transmit the first signaling in the present application.

In one embodiment, at least one of the antenna 452, the receiver 454, the multi-antenna receiving processor 458, the receiving processor 456, the controller / processor 459, the memory 460, or the data source 467 is used to receive the second signaling in the present application.

In one embodiment, at least one of the antenna 420, the transmitter 418, the multi-antenna transmitting processor 471, the transmitting processor 416, the controller/ processor 475, or the memory 476 is used to transmit the second signaling in the present application.

In one embodiment, at least one of the antenna 452, the receiver 454, the multi-antenna receiving processor 458, the receiving processor 456, the controller / processor 459, the memory 460, or the data source 467 is used to receive the third signaling in the present application.

In one embodiment, at least one of the antenna 420, the transmitter 418, the multi-antenna transmitting processor 471, the transmitting processor 416, the controller/ processor 475, or the memory 476 is used to transmit the third signaling in the present application.

In one embodiment, at least one of the antenna 452, the receiver 454, the multi-antenna receiving processor 458, the receiving processor 456, the controller / processor 459, the memory 460 or the data source 467 is used to monitor the first TB in the present application.

In one embodiment, at least one of the antenna 420, the transmitter 418, the multi-antenna transmitting processor 471, the transmitting processor 416, the controller/ processor 475 or the memory 476 is used to transmit the first TB in the present application.

In one embodiment, at least one of the antenna 452, the transmitter 454, the multi-antenna transmission processor 458, the transmitting processor 468, the controller/ processor 459, the memory 460, or the data source 467 is used to transmit the first signal in the present application in the first time-frequency resource pool in the present application.

In one embodiment, at least one of the antenna 420, the receiver 418, the multi-antenna receiving processor 472, the receiving processor 470, the controller/ processor 475, or the memory 476 is used to receive the first signal in the present application in the first time-frequency resource pool in the present application.

### Embodiment 5A

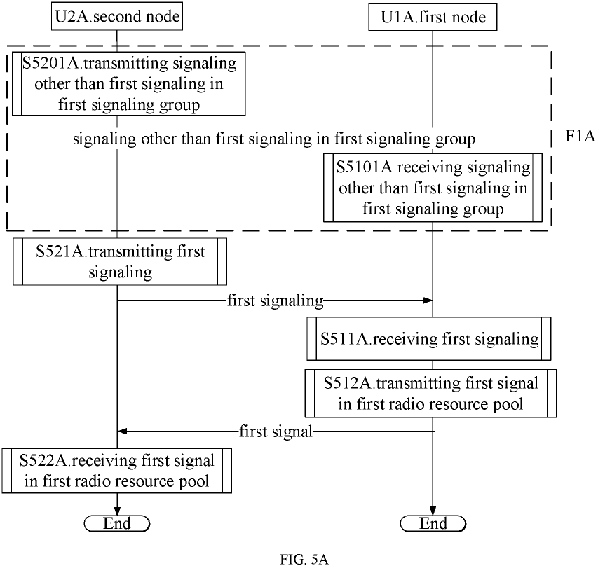

Embodiment 5A illustrates a flowchart of radio signal transmission according to one embodiment in the present application, as shown in FIG. 5A. In FIG. 5A, a first node U1A and a second node U2A are in communications via an air interface. In FIG. 5A, steps in dotted box F1A are optional. Specifically, the sequence of steps {S521A, S5101A} and {S521A, S511A} does not represent a specific chronological order.

The first node U1A receives a signaling other than a first signaling in a first signaling group in step S5101A; receives a first signaling in step S511A; transmits a first signal in a first radio resource pool in step S512A.

The second node U2A transmits a signaling other than a first signaling in a first signaling group in step S5201A; transmits a first signaling in step S521A; receives a first signal in a first radio resource pool in step S522A.

In embodiment 5A, the first signal carries a first bit block and a second bit block; the first signaling is used to determine the first radio resource pool; a first condition is a condition related to a size relation between a first number and a first threshold, and at least one of a number of bit(s) comprised in the first bit block or a number of bit(s) comprised in the second bit block is used to determine the second number; a third bit block is used to generate the first signal, the first bit block and the second bit block are used to generate the third bit block, and whether the first condition is met is used to determine whether bit(s) in the first bit block and bit(s) in the second bit block are separately input into different channel codings to obtain the third bit block; a second condition is a condition related to a size relation between a second number and a second threshold, and at least one of a number of bit(s) comprised in the first bit block or a number of bit(s) comprised in the second bit block is used to determine the first number; whether the second condition is met is used to determine whether a sum of a number of bit(s) comprised in the first bit block and a number of bit(s) comprised in the second bit block or a third number is used to determine a first radio resource pool set, the third number is equal to a number of bit(s) comprised in the first bit block plus a first intermediate quantity, and a number of bit(s) comprised in the second bit block is used to determine the first intermediate quantity; the first radio resource pool set comprises the first radio resource pool; the first signaling group comprises the first signaling; herein, two signalings in the first signaling group are respectively used to determine the first bit block and the second bit block; a third radio resource pool is reserved for the first bit block, and a second radio resource pool is reserved for the second bit block; the third radio resource pool and the second radio resource pool are overlapping in time domain.

In one subembodiment of embodiment 5A, the first number is equal to a number of bit(s) comprised in the second bit block; the first condition comprises: the number of bit(s) comprised in the second bit block is not greater than the first threshold.

In one subembodiment of embodiment 5A, when the first condition is met, the third bit block comprises outputs after all bits in the first bit block and all bits in the second bit block are input into a same channel coding; when the first condition is not met, the third bit block comprises outputs after bit(s) in the first bit block and bit(s) in the second bit block are separately input into different channel codings.

In one subembodiment of embodiment 5A, when the first condition is met, the third bit block comprises all bits in the first bit block and all bits in the second bit block; when the first condition is not met, the third bit block comprises outputs after bit(s) in the first bit block and bit(s) in the second bit block are separately input into different channel codings.

In one embodiment, the first node U1A is the first node in the present application.

In one embodiment, the second node U2A is the second node in the present application.

In one embodiment, the first node U1A is a UE.

In one embodiment, the second node U2A is a base station.

In one embodiment, the second node U2A is a UE.

In one embodiment, an air interface between the second node U2A and the first node U1A is a Uu interface.

In one embodiment, an air interface between the second node U2A and the first node U1A comprises a cellular link.

In one embodiment, an air interface between the second node U2A and the first node U1A is a PC5 interface.

In one embodiment, an air interface between the second node U2A and the first node U1A comprises a sidelink.

In one embodiment, an air interface between the second node U2A and the first node U1A comprises a radio interface between a base station and a UE.

In one embodiment, when the first condition is met, the third bit block comprises an output after the second bit block is through a first processing and an output after all bits in the first bit block are input into a same channel coding; when the first condition is not met, the third bit block comprises outputs after bit(s) in the first bit block and bit(s) in the second bit block are separately input into different channel codings.

In one embodiment, when the first condition is met, the third bit block comprises an output after the second bit block is through a first processing and all bits in the first bit block; when the first condition is not met, the third bit block comprises outputs after bit(s) in the first bit block and bit(s) in the second bit block are separately input into different channel codings.

In one embodiment, when the first condition is met: an output after the second bit block is through a first processing and all bits in the first bit block are used to generate the first signal through sequence modulation.

In one embodiment, when the first condition is met: a sequence jointly generated by an output after the second bit block is through a first processing and all bits in the first bit block is used to generate the first signal.

In one subembodiment of the above embodiment, the sequence jointly generated by an output after the second bit block is through a first processing and all bits in the first bit block comprises a sequence used to carry a UCI in PUCCH format 0 or PUCCH format 1.

In one embodiment, when the first condition is met, the third bit block comprises an output after a bit in the second bit block is input into a channel coding and all bits in the first bit block; when the first condition is not met, the third bit block comprises outputs after bit(s) in the first bit block and bit(s) in the second bit block are separately input into different channel codings.

In one embodiment, when the first condition is met: all bits in the first bit block are directly used to generate the first signal not through channel coding.

In one embodiment, when the first condition is met, the third bit block comprises an output after a bit in the first bit block is input into a channel coding and all bits in the second bit block; when the first condition is not met, the third bit block comprises outputs after bit(s) in the first bit block and bit(s) in the second bit block are separately input into different channel codings.

In one subembodiment of above embodiment, when the first condition is met: all bits in the second bit block are directly used to generate the first signal not through channel coding.

In one embodiment, the meaning of the expression that bit(s) in the first bit block and bit(s) in the second bit block are separately input into different channel codings comprises: bit(s) in the first bit block and bit(s) in the second bit block are separately encoded instead of jointly encoded.

In one embodiment, the third bit comprises a bit indicating whether bit(s) in the first bit block and bit(s) in the second bit block are separately input into different channel codings.

In one embodiment, the phrase of bit(s) in the first bit block comprises: all bits in the first bit block.

In one embodiment, the phrase of bit(s) in the second bit block comprises: all bits in the second bit block.

In one embodiment, the phrase of bit(s) in the second bit block comprises: an output after the second bit block is through a first processing.

In one embodiment, the first processing comprises one or multiple operations of logical AND, logical OR, XOR, deleting bit, precoding, inserting repeated bit or zero-padding.

In one embodiment, the first radio resource pool is reserved for a second channel.

In one embodiment, the first radio resource pool comprises radio resources occupied by the second channel.

In one embodiment, the second channel comprises a physical-layer channel.

In one embodiment, the second channel comprises a PUCCH.

In one embodiment, in the present application, all conditions in a third condition set are met.

In one embodiment, the third condition set comprises: conditions needed to be met when the first bit block and the second bit block are multiplexed into the second channel.

In one embodiment, the third condition set comprises: timeline condition(s) needed to be met when the first bit block and the second bit block are multiplexed into the second channel.

In one embodiment, the third condition set comprises: all timeline conditions needed to be met when the first bit block and the second bit block are multiplexed into the second channel.

In one embodiment, the third condition set comprises a condition related to delay requirement.

In one embodiment, the third condition set comprises all timeline conditions related to delay requirement.

In one embodiment, for the specific meaning of the timeline condition in the present application, refer to section 9.2.5 in 3GPP TS38.213.

In one embodiment, conditions in the third condition set comprise: a timeline condition related to a first one of multicarrier symbols in an earliest radio resource pool in a second radio resource pool group.

In one embodiment, conditions in the third condition set comprise: a time interval between a second time and a start time of a first one of multicarrier symbols in an earliest radio resource pool in a second radio resource pool group is not less than a third value; the second time is earlier than the start time of the first one of multicarrier symbols in the earliest radio resource pool in the second radio resource pool group.

In one subembodiment of the above embodiment, the third value is related to processing time of a UE.

In one subembodiment of the above embodiment, the third value is related to processing capability of a UE.

In one subembodiment of the above embodiment, the third value is related to PDSCH processing capability of a UE.

In one subembodiment of the above embodiment, the third value is related to PUSCH processing capability of a UE.

In one subembodiment of the above embodiment, the third value is related to at least one of

$${T}_{p r o c , 1}^{m u x} ,$$

$${T}_{p r o c , r e l e a s e}^{m u x} , {T}_{p r o c , C S I}^{m u x} \text{or} {T}_{p r o c , 2}^{m u x} ,$$

, and for the specific meaning of the

$${T}_{p r o c , 1}^{m u x} , \text{the} {T}_{p r o c , r e l e a s e}^{m u x} , \text{the} {T}_{p r o c , C S I}^{m u x}$$

and the

$${T}_{p r o c , 2}^{m u x}$$

refer to section 9.2.5 in 3GPP TS38.213.

In one subembodiment of the above embodiment, the third value is equal to one of

$${T}_{p r o c , 1}^{m u x} , {T}_{p r o c , r e l e a s e}^{m u x} ,$$

$${T}_{p r o c , C S I}^{m u x} \text{or} {T}_{p r o c , 2}^{m u x} ,$$

and for the specific meaning of the

$${T}_{p r o c , 1}^{m u x} , \text{the} {T}_{p r o c , r e l e a s e}^{m u x} , \text{the} {T}_{p r o c , C S I}^{m u x} \text{and the} {T}_{p r o c , 2}^{m u x} ,$$

refer to section 9.2.5 in 3GPP TS38.213.

In one subembodiment of the above embodiment, the second time is not earlier than an end time of time-domain resources occupied by a transmission of the first signaling.

In one subembodiment of the above embodiment, the second time is not earlier than an end time of time-domain resources occupied by a PDCCH used to transmit the first signaling.

In one subembodiment of the above embodiment, the second time is not earlier than an end time of time-domain resources occupied by a transmission of a bit block scheduled by the first signaling.

In one subembodiment of the above embodiment, the second time is not earlier than an end time of time-domain resources occupied by a PDSCH of a bit block scheduled by the first signaling.

In one embodiment, the second radio resource pool group in the present application comprises the first radio resource pool.

In one embodiment, the second radio resource pool group in the present application comprises the second radio resource pool and the third radio resource pool.

In one embodiment, steps in dotted box F1A exist.

In one embodiment, steps in dotted box F1A do not exist.

### Embodiment 5B

Embodiment 5B illustrates a flowchart of radio signal transmission according to one embodiment in the present application, as shown in FIG. 5B. In FIG. 5B, a first node U1B and a second node U2B are in communications via an air interface. In FIG. 5B, steps in dotted box F1B are optional.

The first node U1B monitors a first TB in step S5101B; receives a first signaling in step S511B; transmits a first signal in a first time-frequency resource pool in step S512B.

The second node U2B transmits a first TB in step S5201B; transmits a first signaling in step S521B; receives a first signal in a first time-frequency resource pool in step S522B.

In Embodiment 5B, the first signal carries a third bit block and a fourth bit block; the first signaling is used to determine the first time-frequency resource pool; the first time-frequency resource pool is reserved for the fourth bit block; a first bit block comprises first-type HARQ-ACK bit(s), and a second bit block comprises second-type HARQ-ACK bit(s); the second-type HARQ-ACK bit(s) comprised in the second bit block comprises CBG-based second-type HARQ-ACK bit(s); the first bit block and the second bit block are used to determine the third bit block; the first signaling is used to determine a first offset value; a first calculation amount is related to at least first two of a first offset value, a number of bit(s) comprised in the first bit block and a number of bit(s) comprised in the second bit block; when the first calculation amount is not greater than a second calculation amount, the third bit block comprises the CBG-based second-type HARQ-ACK bit(s) comprised in the second bit block; when the first calculation amount is greater than a second calculation amount, the third bit block does not comprise at least part of CBG-based second-type HARQ-ACK bit(s) in the second bit block and the third bit block comprises TB-based second-type HARQ-ACK bit(s) related to the second bit block; the first TB comprises multiple CBGs, the second bit block comprises multiple CBG-based second-type HARQ-ACK bits indicating whether the multiple CBGs in the first TB are correctly received; when the first calculation amount is not greater than the second calculation amount, the third bit block comprises the multiple CBG-based second-type HARQ-ACK bits indicating whether the multiple CBGs in the first TB are correctly received comprised in the second bit block; when the first calculation amount is greater than the second calculation amount, a number of the second-type HARQ-ACK bit(s) generated for the first TB comprised in the third bit block is equal to 1; the second calculation amount is equal to a minimum value between a result after a first intermediate quantity is rounding to an integer and a result after a second intermediate quantity is rounding to an integer; the first intermediate quantity is linearly associated with a number of bit(s) comprised in the first bit block; a priority corresponding to the fourth bit block is used to determine the first intermediate quantity; the first-type HARQ-ACK bit corresponds to a first priority, and the second-type HARQ-ACK bit corresponds to a second priority; the first priority is different from the second priority; a first radio resource pool is reserved for at least one of the first bit block or the second bit block; the first radio resource pool overlaps with the first time-frequency resource pool in time domain.

In one subembodiment of embodiment 5B, the first calculation amount is greater than the second calculation amount; the first bit block comprises a CBG-based first-type HARQ-ACK bit; the first offset value is used to determine a third calculation amount; when the third calculation amount is not greater than the second calculation amount, the third bit block comprises the CBG-based first-type HARQ-ACK bit comprised in the first bit block, and a number of the first-type HARQ-ACK bit(s) comprised in the third bit block is equal to a number of the first-type HARQ-ACK bit(s) comprised in the first bit block; when the third calculation amount is greater than the second calculation amount, a number of the first-type HARQ-ACK bit(s) comprised in the third bit block is less than a number of the first-type HARQ-ACK bit(s) comprised in the first bit block.

In one embodiment, the first node U1B is the first node in the present application.

In one embodiment, the second node U2B is the second node in the present application.

In one embodiment, the first node U1B is a UE.

In one embodiment, the second node U2B is a base station.

In one embodiment, the second node U2B is a UE.

In one embodiment, an air interface between the second node U2B and the first node U1B is a Uu interface.

In one embodiment, an air interface between the second node U2B and the first node U1B comprises a cellular link.

In one embodiment, an air interface between the second node U2B and the first node U1B is a PC5 interface.

In one embodiment, an air interface between the second node U2B and the first node U1B comprises sidelink link.

In one embodiment, an air interface between the second node U2B and the first node U1B comprises a radio interface between a base station and a UE.

In one embodiment, the first signaling is used to determine a second offset value; the second offset value and a number of bit(s) comprised in the first bit block are used to determine a fifth calculation amount; the fifth calculation amount is not greater than the second calculation amount.

In one embodiment, the second offset value is equal to the first offset value.

In one embodiment, the second offset value is not equal to the first offset value.

In one embodiment, the first signaling indicates the second offset value.

In one embodiment, the first signaling explicitly indicates the second offset value.

In one embodiment, the first signaling implicitly indicates the second offset value.

In one embodiment, a field comprised in the first signaling indicates the second offset.

In one embodiment, the first signaling determines the second offset value from an offset value set comprising multiple offset values.

In one embodiment, the first signaling indicates an offset value index corresponding to the second offset value from an offset value index set comprising multiple offset value indexes.

In one embodiment, a field comprised in the first signaling indicates an offset value index corresponding to the second offset value from an offset value index set comprising multiple offset value indexes.

In one embodiment, the fifth calculation amount is equal to a fifth number multiplied by the second offset value multiplied by a first resource amount divided by a first payload size.

In one embodiment, the fifth calculation amount is equal to a fifth number multiplied by the second offset value divided by a first code rate divided by a first modulation order.

In one embodiment, the fifth number is equal to a number of bit(s) comprised in the first bit block.

In one embodiment, the fifth number is equal to a number of bit(s) comprised in the first bit block plus a number of CRC bit(s).

In one embodiment, a number of time-frequency resource element(s) occupied by a modulation symbol generated by the third bit block being transmitted in the first time-frequency resource pool is not greater than the second calculation amount.

In one embodiment, in the present application, timeline conditions needed to be met for a transmission of the third bit block in the first time-frequency resource pool after being multiplexed are all met.

In one subembodiment of the above embodiment, the timeline conditions comprise one or multiple timeline conditions described in section 9.2.5 in 3GPP TS38.213.

In one embodiment, the first signaling comprises two Downlink Assignment Index (DAI) fields.

In one embodiment, the two DAI fields in the first signaling are used together to generate a same HARQ-ACK sub-codebook.

In one embodiment, a first TB comprises multiple CBGs, the second bit block comprises multiple CBG-based second-type HARQ-ACK bits indicating whether the multiple CBGs in the first TB are correctly received; when the first calculation amount is not greater than the second calculation amount, the third bit block comprises the multiple CBG-based second-type HARQ-ACK bits indicating whether the multiple CBGs in the first TB are correctly received comprised in the second bit block; when the first calculation amount is greater than the second calculation amount, a number of the second-type HARQ-ACK bit(s) generated for the first TB comprised in the third bit block is equal to 1.

In one embodiment, steps in dotted box F1B exist.

In one embodiment, steps in dotted box F1B do not exist.

### Embodiment 6A

Embodiment 6A illustrates a schematic diagram of a relation between a first condition and a size relation of a first number and a first threshold according to one embodiment of the present application, as shown in FIG. 6A.

In embodiment 6A, a first condition is related to a size relation of a first number and a first threshold.

In one embodiment, the first threshold is indicated by a DCI signaling.

In one embodiment, the first threshold is configured by a higher-layer signaling.

In one embodiment, the first threshold is configured by an RRC signaling.

In one embodiment, the first threshold is configured by a MAC CE signaling.

In one embodiment, the first threshold is default.

In one embodiment, the first threshold is greater than 0.

In one embodiment, the first threshold is equal to 1.

In one embodiment, the first threshold is equal to 2.

In one embodiment, the first threshold is equal to 3.

In one embodiment, the first threshold is equal to 4.

In one embodiment, the first threshold is greater than 2.

In one embodiment, the first threshold is greater than 4.

In one embodiment, the first threshold is not greater than 1706.

In one embodiment, the first threshold is not greater than 17060.

In one embodiment, the first threshold is equal to a first parameter value minus a number of bit(s) comprised in the first bit block.

In one embodiment, the first parameter value is indicated by a DCI signaling.

In one embodiment, the first parameter is configured by a higher layer signaling.

In one embodiment, the first parameter is configured by an RRC signaling.

In one embodiment, the first parameter value is configured by a MAC CE signaling.

In one embodiment, the first parameter value is default.

In one embodiment, the first parameter value is greater than 0.

In one embodiment, the first reference value is not greater than 1706.

In one embodiment, the first reference value is not greater than 17060.

In one embodiment, at least one of a number of bit(s) comprised in the first bit block or a number of bit(s) comprised in the second bit block is used to determine whether the first condition is met.

In one embodiment, the first condition comprises: the first number is not greater than the first threshold.

In one embodiment, the first condition comprises: the first number is greater than the first threshold.

In one embodiment, the first condition comprises: the first number is greater than the first threshold and a fourth number is greater than a fourth threshold.

In one embodiment, the first condition comprises: the first number is not greater than the first threshold or a fourth number is not greater than a fourth threshold.

In one embodiment, the expression of the first condition being met comprises: all conditions in a first condition set are met.

In one embodiment, the expression of the first condition not being met comprises: at least one condition in a first condition set is not met.

In one embodiment, the expression of the first condition being met comprises: at least one condition in a first condition set is met.

In one embodiment, the expression of the first condition not being met comprises: all conditions in a first condition set are not met.

In one embodiment, the expression of the first condition being met comprises: all conditions in a first condition set are met, and at least one condition in a second condition set is met.

In one embodiment, the expression of the first condition not being met comprises: at least one condition in a first condition set is not met, or all conditions in a second condition set are not met.

In one embodiment, the first condition set comprises one or multiple conditions.

In one embodiment, the second condition set comprises one or multiple conditions.

In one embodiment, a condition in the first condition set comprise: the first number is not greater than the first threshold.

In one embodiment, a condition in the first condition set comprise: the first number is greater than the first threshold.

In one embodiment, a condition in the first condition set comprise: a fourth number is not greater than a fourth threshold.

In one embodiment, a condition in the first condition set comprise: a fourth number is greater than a fourth threshold.

In one embodiment, a condition in the first condition set comprise: a fifth number is not greater than a third threshold.

In one embodiment, a condition in the first condition set comprise: a fifth number is greater than a third threshold.

In one embodiment, a condition in the second condition set comprise: the first number is not greater than the first threshold.

In one embodiment, a condition in the second condition set comprise: the first number is greater than the first threshold.

In one embodiment, a condition in the second condition set comprise: a fourth number is not greater than a fourth threshold.

In one embodiment, a condition in the second condition set comprise: a fourth number is greater than a fourth threshold.

In one embodiment, a condition in the second condition set comprise: a fifth number is not greater than a third threshold.

In one embodiment, a condition in the second condition set comprise: a fifth number is greater than a third threshold.

In one embodiment, at least one of a number of bit(s) comprised in the first bit block or a number of bit(s) comprised in the second bit block is used to determine the fourth number.

In one embodiment, the fourth number is equal to a number of bit(s) comprised in the first bit block.

In one embodiment, the fourth number is equal to a number of bit(s) comprised in the second bit block.

In one embodiment, the fourth number is equal to a sum of a number of bit(s) comprised in the first bit block and a number of bit(s) comprised in the second bit block.

In one embodiment, at least one of a number of bit(s) comprised in the first bit block or a number of bit(s) comprised in the second bit block is used to determine the fifth number.

In one embodiment, the fifth number is equal to a number of bit(s) comprised in the first bit block.

In one embodiment, the fifth number is equal to a number of bit(s) comprised in the second bit block.

In one embodiment, the fifth number is equal to a sum of a number of bit(s) comprised in the first bit block and a number of bit(s) comprised in the second bit block.

In one embodiment, the third threshold is indicated by a DCI signaling.

In one embodiment, the third threshold is configured by a higher-layer signaling.

In one embodiment, the third threshold is configured by an RRC signaling.

In one embodiment, the third threshold is configured by a MAC CE signaling.

In one embodiment, the third threshold is default.

In one embodiment, the third threshold is greater than 0.

In one embodiment, the third threshold is equal to 1.

In one embodiment, the third threshold is equal to 2.

In one embodiment, the third threshold is equal to 3.

In one embodiment, the third threshold is equal to 4.

In one embodiment, the third threshold is greater than 2.

In one embodiment, the third threshold is greater than 4.

In one embodiment, the third threshold is not greater than 1706.

In one embodiment, the third threshold is not greater than 17060.

In one embodiment, the fourth threshold is indicated by a DCI signaling.

In one embodiment, the fourth threshold is configured by a higher-layer signaling.

In one embodiment, the fourth threshold is configured by an RRC signaling.

In one embodiment, the fourth threshold is configured by a MAC CE signaling.

In one embodiment, the fourth threshold is default.

In one embodiment, the fourth threshold is greater than 0.

In one embodiment, the fourth threshold is equal to 1.

In one embodiment, the fourth threshold is equal to 2.

In one embodiment, the fourth threshold is equal to 3.

In one embodiment, the fourth threshold is equal to 4.

In one embodiment, the fourth threshold is greater than 2.

In one embodiment, the fourth threshold is greater than 4.

In one embodiment, the fourth threshold is not greater than 1706.

In one embodiment, the fourth threshold is not greater than 17060.

### Embodiment 6B

Embodiment 6B illustrates a schematic diagram of relations among a first node, a second TB group and a second bit block according to one embodiment of the present application, as shown in FIG. 6B.

In embodiment 6B, the first node in the present application monitors a second TB group; the second TB group comprises K TBs; a CBG-based second-type HARQ-ACK bit comprised in a second bit block is used to indicate whether a CBG comprised in a TB in the second TB group is correctly received.

In one embodiment, the multiple CBG-based second-type HARQ-ACK bits comprised in the second bit block are used to indicate whether multiple CBGs comprised in a TB in the second TB group are correctly received.

In one embodiment, the first TB in the present application is one of the K TBs comprised in the second TB group.

In one embodiment, for any TB in the second TB group, the second bit block comprises multiple CBG-based second-type HARQ-ACK bits generated for any TB in the second TB group.

In one embodiment, the second TB group comprises a first TB; the second bit block comprises multiple CBG-based second-type HARQ-ACK bits generated for the first TB.

In one embodiment, the second node in the present application transmits the second TB group.

In one embodiment, a priority corresponding to any TB in the second transport block group is a second priority.

In one embodiment, a fourth calculation amount is not greater than the second calculation amount in the present application.

In one embodiment, a fourth calculation amount is equal to the second calculation amount in the present application.

In one embodiment, a fourth calculation amount is greater than the second calculation amount in the present application.

In one embodiment, the first offset value in the present application is used to determine the fourth calculation amount.

In one embodiment, the fourth calculation amount is equal to a fourth quantity multiplied by the first offset value multiplied by a first resource amount divided by a first payload size.

In one embodiment, the fourth calculation amount is equal to a fourth number multiplied by the first offset value divided by a first code rate divided by a first modulation order.

In one embodiment, the fourth number is equal to a number of bit(s) comprised in the first bit block in the present application plus K.

In one embodiment, the fourth number is equal to a number of bit(s) comprised in the first bit block in the present application plus K and then plus a number of CRC bit(s).

In one embodiment, the fourth number is not less than a number of bit(s) comprised in the first bit block in the present application plus K.

In one embodiment, the fourth number is not less than a number of bit(s) comprised in the first bit block in the present application plus K and then plus a number of CRC bit(s).

In one embodiment, the fourth number is equal to a number of bit(s) comprised in the first bit block in the present application plus K and then plus K2.

In one embodiment, the fourth number is equal to a number of bit(s) comprised in the first bit block in the present application plus K then plus K2 and then plus a number of CRC bit(s).

In one embodiment, the first bit block in the present application comprises a Cyclic Redundancy Check (CRC) bit.

In one embodiment, the first bit block in the present application does not comprise any CRC bit.

In one embodiment, the second bit block in the present application comprises a CRC bit.

In one embodiment, the second bit block in the present application does not comprise any CRC bit.

In one embodiment, K is a positive integer.

In one embodiment, K is not greater than 4096.

In one embodiment, K2 is non-negative.

In one embodiment, K2 is not greater than 4096.

In one embodiment, K2 is related to a signaling received by the first node indicating an SPS PDSCH release.

In one embodiment, the first node receives a second signaling group; K2 is equal to a number of signaling(s) in the second signaling group.

In one embodiment, the second node in the present application transmits the second signaling group.

In one embodiment, each signaling in the second signaling group indicates an SPS PDSCH release.

In one embodiment, each signaling in the second signaling group indicates a second priority.

In one embodiment, each signaling in the second signaling group comprises a DCI.

In one embodiment, a signaling in the second signaling group comprises one or multiple fields in a DCI.

In one embodiment, when the first calculation amount in the present application is not greater than the second calculation amount in the present application: a number of the second-type HARQ-ACK bit(s) in the present application comprised in the third bit block in the present application is equal to a number of the second-type HARQ-ACK bit(s) comprised in the second bit block in the present application.

In one embodiment, when the first calculation amount in the present application is greater than the second calculation amount in the present application: a number of the second-type HARQ-ACK bit(s) in the present application comprised in the third bit block in the present application is less than a number of the second-type HARQ-ACK bit(s) comprised in the second bit block in the present application.

In one embodiment, when the first calculation amount in the present application is greater than the second calculation amount in the present application: a number of the second-type HARQ-ACK bit(s) in the present application comprised in the third bit block in the present application is less than a number of the second-type HARQ-ACK bit(s) comprised in the second bit block in the present application, and a number of the second-type HARQ-ACK bit(s) comprised in the third bit block is not less than K.

In one embodiment, when the first calculation amount in the present application is greater than the second calculation amount in the present application: a number of the second-type HARQ-ACK bit(s) in the present application comprised in the third bit block in the present application is less than a number of the second-type HARQ-ACK bit(s) comprised in the second bit block in the present application, and a number of the second-type HARQ-ACK bit(s) comprised in the third bit block is not less than K plus K2.

In one embodiment, when the first calculation amount in the present application is greater than the second calculation amount in the present application: a number of the second-type HARQ-ACK bit(s) in the present application comprised in the third bit block in the present application is equal to K.

In one embodiment, when the first calculation amount in the present application is greater than the second calculation amount in the present application: a number of the second-type HARQ-ACK bit(s) in the present application comprised in the third bit block in the present application is less than a number of the second-type HARQ-ACK bit(s) comprised in the second bit block in the present application and is equal to K plus K2.

In one embodiment, when the first calculation amount in the present application is greater than the second calculation amount in the present application: for any TB in the second TB group, a number of the second-type HARQ-ACK bit(s) in the present application used to indicate whether any TB in the second TB group is correctly received comprised in the third bit block in the present application is equal to 1.

In one embodiment, when the first calculation amount in the present application is greater than the second calculation amount in the present application: for any TB in the second TB group, a number of the second-type HARQ-ACK bit(s) in the present application generated for the any TB in the second TB group comprised in the third bit block in the present application is equal to 1.

In one embodiment, when the first calculation amount in the present application is greater than the second calculation amount in the present application: for any TB in the second TB group, a number of the second-type HARQ-ACK bit(s) in the present application used to indicate whether any TB in the second TB group is correctly received comprised in the third bit block in the present application is not greater than 1.

In one embodiment, when the first calculation amount in the present application is greater than the second calculation amount in the present application: for any TB in the second TB group, a number of the second-type HARQ-ACK bit(s) in the present application generated for any TB in the second TB group comprised in the third bit block in the present application is not greater than 1.

In one embodiment, the second TB group comprises a first TB, and the second bit block comprises multiple CBG-based second-type HARQ-ACK bits generated for the first TB; when the first calculation amount in the present application is greater than the second calculation amount in the present application: a number of the second-type HARQ-ACK bit(s) in the present application generated for the first TB comprised in the third bit block in the present application is equal to 1.

### Embodiment 7A

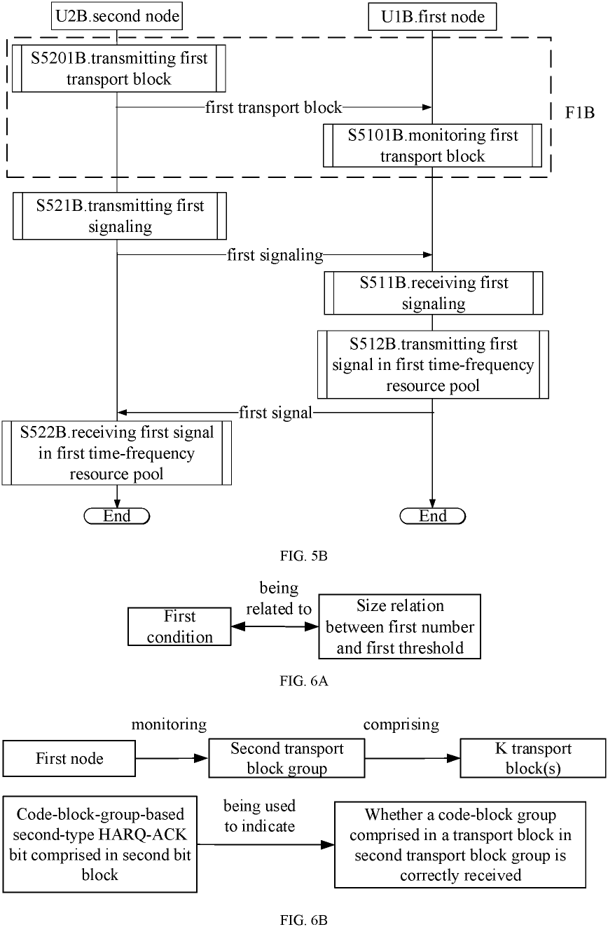

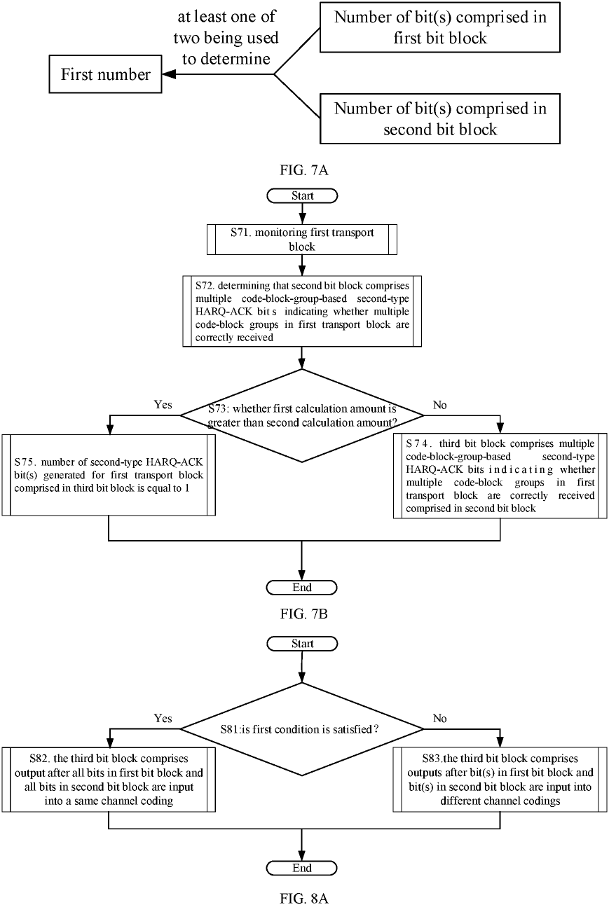

Embodiment 7A illustrates a schematic diagram of relations among a number of bit(s) comprised in a first bit block, a number of bit(s) comprised in a second bit block and a first number according to one embodiment of the present application, as shown in FIG. 7A.

In embodiment 7A, at least one of a number of bit(s) comprised in a first bit block or a number of bit(s) comprised in a second bit block is used to determine a first number.

In one embodiment, the first number is greater than 0.

In one embodiment, the first number is equal to a number of bit(s) comprised in the first bit block.

In one embodiment, the first number is equal to a number of bit(s) comprised in the second bit block.

In one embodiment, the first number is equal to a sum of a number of bit(s) comprised in the first bit block and a number of bit(s) comprised in the second bit block.

In one embodiment, the first number is equal to a product of a number of bit(s) comprised in the first bit block and a number of bit(s) comprised in the second bit block.

In one embodiment, the first number is not less than a number of bit(s) comprised in the first bit block plus a second value multiplied by a number of bit(s) comprised in the second bit block, the second value is related to at least one of a first code rate or a second code rate, and the first code rate is different from the second code rate.

In one embodiment, the first number is equal to a number of bit(s) comprised in the first bit block plus a second value multiplied by a number of bit(s) comprised in the second bit block, the second value is related to at least one of a first code rate or a second code rate, and the first code rate is different from the second code rate.

In one embodiment, the first number is equal to a result obtained by multiplying a second value by a number of bit(s) comprised in the second bit block rounding to an integer then plus a number of bit(s) comprised in the first bit block, the second value is related to at least one of a first code rate or a second code rate, and the first code rate is different from the second code rate.

In one embodiment, the rounding to an integer in the present application comprises: rounding up to an integer.

In one embodiment, the rounding to an integer in the present application comprises: rounding down to an integer.

In one embodiment, a result of rounding up a value to an integer is: a minimum integer not less than the value.

In one embodiment, a result of rounding down a value to an integer is: a maximum integer not greater than the value.

In one embodiment, the second value is equal to the first code rate divided by the second code rate.

In one embodiment, the second value is equal to the second code rate divided by the first code rate.

In one embodiment, the second value is equal to the first code rate.

In one embodiment, the second value is equal to the second code rate.

In one embodiment, the second value is equal to 1 divided by the first code rate.

In one embodiment, the second value is equal to 1 divided by the second code rate.

In one embodiment, the first code rate is a code rate corresponding to the first radio resource pool.

In one embodiment, the first code rate is a maximum code rate configured to a PUCCH resource comprised in the first radio resource pool.

In one embodiment, the first code rate and the second code rate are respectively two different code rates corresponding to the first radio resource pool.

In one embodiment, the first code rate and the second code rate are respectively two different maximum code rates configured to a PUCCH resource comprised in the first radio resource pool.

In one embodiment, based on a configuration of a higher-layer signaling or an RRC signaling or a MAC CE signaling, different priorities correspond to different code rates; the first code rate and the second code rate respectively correspond to a priority corresponding to the first bit block and a priority corresponding to the second bit block.

In one embodiment, the first code rate is not less than code rate of channel coding executed on the first bit block.

In one embodiment, the second code rate is not less than code rate of channel coding executed on the second bit block.

In one embodiment, when bit(s) in the first bit block and bit(s) in the second bit block are separately input into different channel codings to obtain the third bit block in the present application: the second code rate is not less than code rate of channel coding executed on the second bit block.

In one embodiment, when all bits in the first bit block and all bits in the second bit block are input into a same channel coding to obtain the third bit block in the present application; the first code rate is not less than code rate of channel coding executed on the first bit block.

### Embodiment 7B

Embodiment 7B illustrates a schematic diagram of a procedure of a relation between a third bit block and a first TB according to one embodiment of the present application, as shown in FIG. 7B.

In Embodiment 7B, the first node in the present application monitors a first TB in step S71; determines whether a second bit block comprises multiple CBG-based second-type HARQ-ACK bits indicating whether multiple CBGs in a first TB are correctly received; judges whether a first calculation amount is greater than a second calculation amount in step S73; if yes, determines in step S75: a number of the second-type HARQ-ACK bit(s) generated for the first TB comprised in a third bit block is equal to 1; otherwise, enters into the step S74 to determine: a third bit block comprises multiple CBG-based second-type HARQ-ACK bits indicating whether the multiple CBGs in the first TB are correctly received comprised in the second bit block.

In one embodiment, the meaning of the expression of monitoring a first TB comprises: monitoring a signal carrying the first TB.

In one embodiment, the meaning of the expression of monitoring a first TB comprises: monitoring and trying to receive the first TB.

In one embodiment, the meaning of the expression of monitoring a first TB comprises: monitoring a signal in a physical-layer channel, and trying to detect and receive the first TB in the physical-layer channel.

In one embodiment, the meaning of the expression of whether being correctly received comprises: whether it is correctly decoded.

In one embodiment, a priority corresponding to the first transport is the second priority in the present application.

In one embodiment, when the first calculation amount is greater than the second calculation amount, the third bit block does not comprise any CBG-based second-type HARQ-ACK bit generated for a CBG in the first TB.

### Embodiment 8A

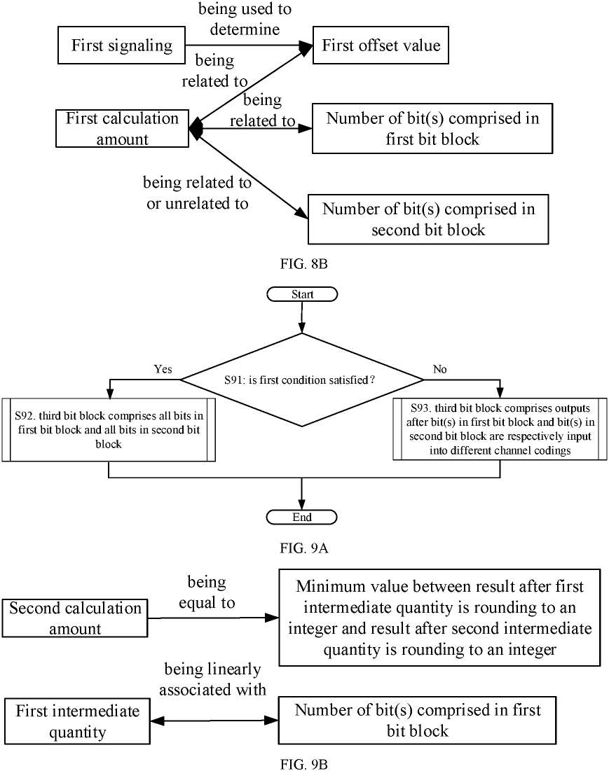

Embodiment 8A illustrates a schematic diagram of a first condition being used to determine a third bit block according to one embodiment of the present application, as shown in FIG. 8A.

In embodiment 8A, the first node in the present application judges whether a first condition is met in step S81; if yes, determines in step S82: a third bit block comprises an output after all bits in a first bit block and all bits in a second bit block are input into a same channel coding; otherwise, enters into the step S83 to determine: a third bit block comprises outputs after bit(s) in a first bit block and bit(s) in the second bit block are separately input into different channel codings.

In one embodiment, when the first condition is met, an output after all bits in the first bit block and all bits in the second bit block are input into a same channel coding is used to generate the first signal; when the first condition is not met, an output after bit(s) in the first bit block and bit(s) in the second bit block are separately input into different channel codings to generate the first signal.

In one embodiment, an output after one or multiple bit blocks are input into a channel coding comprises: a coded bit sequence.

In one embodiment, when the third bit block comprises outputs after all bits in the first bit block and all bits in the second bit block are input into a same channel coding: a same code rate is used to execute channel coding on all bits in the first bit block and all bits in the second bit block.

In one embodiment, when the third bit block comprises outputs after bit(s) in the first bit block and bit(s) in the second bit block are separately input into different channel codings: two different code rates are respectively used to execute channel codings in the first bit block and the second bit block.

In one embodiment, the meaning of the phrase that the third bit block comprises outputs after bit(s) in the first bit block and bit(s) in the second bit block are separately input into different channel codings comprises: the third bit block comprises a first coded bit sequence and a second coded bit sequence, all bits in the first bit block are input into a channel coding to obtain the first coded bit sequence, and all bits in the second bit block are input into another channel coding to obtain the second coded bit sequence.

In one embodiment, the meaning of the phrase that the third bit block comprises outputs after bit(s) in the first bit block and bit(s) in the second bit block are separately input into different channel codings comprises: the third bit block comprises a first coded bit sequence and a second coded bit sequence, all bits in the first bit block are input into a channel coding to obtain the first coded bit sequence, and an output after the second bit block is through a first processing is input into another channel coding to obtain the second coded bit sequence.

In one embodiment, the first bit block comprises a HARQ-ACK bit, the second bit block comprises an SR bit, and the first condition comprises: a number of bit(s) comprised in the first bit block is not greater than the first threshold; when a number of bit(s) comprised in the first bit block is not greater than the first threshold, the third bit block comprises all bits in the first bit block and all bits in the second bit block; when a number of bit(s) comprised in the first bit block is greater than the first threshold, the third bit block comprises a first coded bit sequence and a second coded bit sequence, all bits in the first bit block are input into a channel coding to obtain the first coded bit sequence, an output after the second bit block is through a first processing is input into another channel coding to obtain the second coded bit sequence, and the first processing comprises one or multiple of logical AND, logical OR, XOR, deleting bit, precoding, inserting repeated bits, or zero padding operations.

In one subembodiment of the above embodiment, when a number of bit(s) comprised in the first bit block is not greater than the first threshold: bit(s) in the third bit block is(are) used to generate the first signal after determining a sequence cyclic shift based on a mapping relation.

In one subembodiment of the above embodiment, the first processing only comprises zero padding operation.

In one subembodiment of the above embodiment, the first processing only comprises deleting bit operation.

In one subembodiment of the above embodiment, the first processing only comprises logical AND operation.

In one embodiment, in the present application, for the procedure of one or multiple bit blocks being input into a channel coding to obtain an output, refer to the description in section 6.3.1.3 in 3GPP TS38.212.

### Embodiment 8B

Embodiment 8B illustrates a schematic diagram of relations among a first signaling, a first offset value, a first calculation amount, a first bit block and a second bit block according to one embodiment of the present application, as shown in FIG. 8B.

In Embodiment 8B, a first signaling is used to determine an offset value; a first calculation amount is related to at least first two of the first offset value, a number of bit(s) comprised in a first bit block, or a number of bit(s) comprised in a second bit block.

In one embodiment, the first signaling indicates the first offset value.

In one embodiment, the first signaling explicitly indicates the first offset value.

In one embodiment, the first signaling implicitly indicates the first offset value.

In one embodiment, a field comprised in the first signaling indicates the first offset value.

In one embodiment, the first signaling determines the first offset value from an offset value set comprising multiple offset values.

In one embodiment, the first signaling indicates an offset value index corresponding to the first offset value from an offset value index set comprising multiple offset value indexes.

In one embodiment, a field comprised in the first signaling indicates an offset value index corresponding to the first offset value from an offset value index set comprising multiple offset value indexes.

In one embodiment, the offset value in the present application is a

$${β}_{\text{offset}}^{\text{HARQ-ACK}}$$

value.

In one embodiment, the offset value in the present application is a beta-offset value.

In one embodiment, a name of the offset value in the present application comprises β .

In one embodiment, a name of the offset value in the present application comprises at least one of HARQ or ACK.

In one embodiment, a name of the offset value in the present application comprises offset.

In one embodiment, a symbol used to represent the offset value in the present application comprises β.

In one embodiment, a symbol used to represent the offset value in the present application comprises at least one of HARQ or ACK.

In one embodiment, a symbol used to represent the offset value in the present application comprises offset.

In one embodiment, the first calculation amount is related to a first offset value, a number of bit(s) comprised in the first bit block, and a number of bit(s) comprised in a second bit block.

In one embodiment, at least first two of the first offset value, a number of bit(s) comprised in the first bit block or a number of bit(s) comprised in the second bit block are used to determine the first calculation amount.

In one embodiment, the first offset value, a number of bit(s) comprised in the first bit block and a number of bit(s) comprised in the second bit block are used to determine the first calculation amount.

In one embodiment, the first calculation amount is equal to a first number multiplied by the first offset value multiplied by a first resource amount divided by the first payload size.

In one embodiment, the first calculation amount is equal to a first number multiplied by the first offset value divided by a first code rate divided by a first modulation order.

In one embodiment, the first number is equal to a number of bit(s) comprised in the first bit block.

In one embodiment, the first number is equal to a number of bit(s) comprised in the first bit block plus a number of CRC bit(s).

In one embodiment, the first number is equal to a sum of a number of bit(s) comprised in the first bit block and a number of bit(s) comprised in the second bit block.

In one embodiment, the first number is equal to a sum of a number of bit(s) comprised in the first bit block and a number of bit(s) comprised in the second bit block plus a number of CRC bit(s).

In one embodiment, the first number is equal to a positive integer less than 1706.

In one embodiment, the first number is equal to a positive integer less than 170600.

In one embodiment, the first number is default.

In one embodiment, the first number is configured by a higher-layer signaling.

In one embodiment, the first number is configured by an RRC signaling.

In one embodiment, the first number is configured by a MAC CE signaling.

In one embodiment, the first resource amount in the present application is equal to a number of time-frequency resource element(s) that can be used for UCI transmission on one or multiple multicarrier symbols.

In one embodiment, the first payload amount in the present application is equal to a size of payload of uplink data.

In one embodiment, a first PUSCH comprises a PUSCH.

In one embodiment, the first time-frequency resource pool in the present application is reserved for the first PUSCH.

In one embodiment, the first time-frequency resource pool in the present application comprises time-frequency resources reserved for the first PUSCH.

In one embodiment, the first time-frequency resource pool in the present application comprises time-frequency resources occupied by the first PUSCH.

In one embodiment, the first payload amount in the present application is equal to a number of bit(s) comprised in a UL-SCH transmitted on the first PUSCH.

In one embodiment, the first code rate in the present application is a code rate of the first PUSCH.

In one embodiment, the first modulation order in the present application is a modulation order of the first PUSCH.

In one embodiment, the first signaling is used to determine the first code rate in the present application.

In one embodiment, the first signaling is used to determine the first modulation order in the present application.

In one embodiment, an MCS indicated by the first signaling is used for the first code rate in the present application.

In one embodiment, an MCS indicated by the first signaling is used for the first modulation order in the present application.

In one embodiment, a priority corresponding to the fourth bit block in the present application is used to determine the first offset value.

In one embodiment, the priority corresponding to the fourth bit block is a priority in a first priority set, and the first offset value is an offset value in a first offset value set; multiple priorities in the first priority set respectively correspond to multiple offset values in the first offset value set, and an offset value in the first offset value corresponding to the priority corresponding to the fourth bit block is the first offset value; a priority in the first priority set is higher-layer-signaling-configured or default, and an offset value in the first offset value set is higher-layer-signaling-configured or default.

### Embodiment 9A

Embodiment 9A illustrates a schematic diagram of a procedure of a first condition being used to determine a third bit block according to one embodiment of the present application, as shown in FIG. 9A.

In embodiment 9A, the first node in the present application judges whether a first condition is met in step S91; if yes, determines in step S92; a third bit block comprises all bits in a first bit block and all bits in a second bit block; otherwise, enters into the step S93 to determine: a third bit block comprises outputs after bit(s) in a first bit block and bit(s) in the second bit block are separately input into different channel codings.

In one embodiment, when the first condition is met: all bits in the first bit block and all bits in the second bit block are directly used to generate the first signal not through channel coding.

In one embodiment, when the first condition is met: all bits in the first bit block and all bits in the second bit block are used to generate the first signal after being used to determine a sequence cyclic shift based on a mapping relation.

In one subembodiment of the above embodiment, for the mapping relation, refer to Table 9.2.3-3 or table 9.2.3-4 in 3GPP TS38.213.

In one embodiment, when the first condition is met: all bits in the first bit block and all bits in the second bit block are used to generate the first signal after through sequence modulation.

In one embodiment, when the first condition is met: a sequence jointly generated by all bits in the first bit block and all bits in the second bit block is used to generate the first signal.

In one subembodiment of the above embodiment, the sequence jointly generated by all bits in the first bit block and all bits in the second bit block comprises a sequence used to carry a UCI in PUCCH format 0 or PUCCH format 1.

In one embodiment, the first radio resource pool is reserved for a PUCCH, and the first signal is transmitted in the PUCCH; the PUCCH adopts PUCCH format 1, or one of PUCCH format 2, PUCCH format 3, or PUCCH format 4.

In one embodiment, the first radio resource pool is reserved for a PUCCH, the first signal is transmitted in the PUCCH, and the PUCCH adopts PUCCH format 0, or one of PUCCH format 2, PUCCH format 3, or PUCCH format 4; when the first condition is met, the PUCCH adopts PUCCH format 0; when the first condition is not met, the PUCCH adopts one of PUCCH format 2, PUCCH format 3, or PUCCH format 4.

In one embodiment, the first radio resource pool is reserved for a PUCCH, and the first signal is transmitted in the PUCCH; the PUCCH adopts PUCCH format 1, or one of PUCCH format 2, PUCCH format 3, or PUCCH format 4.

In one embodiment, the first radio resource pool is reserved for a PUCCH, the first signal is transmitted in the PUCCH, and the PUCCH adopts PUCCH format 1, or one of PUCCH format 2, PUCCH format 3, or PUCCH format 4; when the first condition is met, the PUCCH adopts PUCCH format 0; when the first condition is not met, the PUCCH adopts one of PUCCH format 2, PUCCH format 3, or PUCCH format 4.

### Embodiment 9B

Embodiment 9B illustrates a schematic diagram of relations among a second calculation amount, a first intermediate quantity, a second intermediate quantity and a first bit block according to one embodiment of the present application, as shown in FIG. 9B.

In embodiment 9B, a second calculation amount is equal to a minimum value between a result after a first intermediate quantity is rounding to an integer and a result after a second intermediate quantity is rounding to an integer; the first intermediate quantity is linearly associated with a number of bit(s) comprised in a first bit block.

In one subembodiment of embodiment 9B, a priority corresponding to the fourth bit block in the present application is used to determine the first intermediate quantity.

In one embodiment, the rounding to an integer in the present application comprises: rounding up to an integer.

In one embodiment, the rounding to an integer in the present application comprises: rounding down to an integer.

In one embodiment, the second intermediate quantity is related to a higher-layer parameter scaling.

In one embodiment, the second intermediate quantity is equal to a parameter multiplied by a second resource amount.

In one embodiment, the parameter value used to determine the second intermediate number is configured by a higher-layer signaling.

In one embodiment, the parameter value used to determine the second intermediate number is configured by a higher-layer parameter scaling.

In one embodiment, the first intermediate quantity is equal to a second parameter value multiplied by a number of bit(s) comprised in the first bit block.

In one embodiment, the first intermediate quantity is equal to a sum of a number of bit(s) comprised in the first bit block plus a number of CRC bit(s) then multiplied by a second parameter value.

In one embodiment, the first intermediate quantity is equal to a second parameter value multiplied by the fifth calculation amount in the present application.

In one embodiment, the second parameter is configured by a higher-layer signaling.

In one embodiment, the second parameter is obtained through calculation.

In one embodiment, the priority corresponding to the fourth bit block is used to determine the second parameter value.

In one embodiment, the second parameter value is equal to a first parameter value.

In one embodiment, the second parameter value is linearly associated with a first parameter value.

In one embodiment, the priority corresponding to the fourth bit block is used to determine the first parameter value.

In one embodiment, the priority corresponding to the fourth bit block is a priority in a first priority set, and the first parameter value is a parameter value in a first parameter value set; multiple priorities in the first priority set respectively correspond to multiple parameter values in the first parameter value set, and a parameter value in the first parameter value set corresponding to the priority corresponding to the fourth bit block is the first parameter value.

In one subembodiment of the above embodiment, a priority in the first priority set is higher-layer-signaling-configured or default, and a parameter value in the first parameter value set is higher-layer-signaling-configured or default.

In one embodiment, when the priority corresponding to the fourth bit block is a first priority, the first parameter value is equal to a first value; when the priority corresponding to the fourth bit block is a second priority, the parameter value is equal to a second value; both the first value and the second value are higher-layer-signaling-configured or default.

In one embodiment, the priority corresponding to the fourth bit block is the same as a priority indicated by the first signaling in the present application.

In one embodiment, the priority corresponding to the fourth bit block is the first priority in the present application or the second priority in the present application.

### Embodiment 10A

Embodiment 10A illustrates a schematic diagram of relations among a number of bit(s) comprised in a first bit block, a number of bit(s) comprised in a second bit block, a second number, a second threshold, a second condition, a third number and a first radio resource pool set according to one embodiment of the present application, as shown in FIG. 10A.

In embodiment 10A, a second condition is a condition related to a size relation between a second number and a second threshold, and at least one of a number of bit(s) comprised in a first bit block or a number of bit(s) comprised in a second bit block is used to determine the first number; whether the second condition is met is used to determine whether a sum of a number of bit(s) comprised in the first bit block and a number of bit(s) comprised in the second bit block or a third number is used to determine a first radio resource pool set.

In one subembodiment of embodiment 10A, the first radio resource pool set comprises the first radio resource pool in the present application.

In one subembodiment of embodiment 10A, the third number is equal to a number of bit(s) comprised in the first bit block plus a first intermediate quantity, and a number of bit(s) comprised in the second bit block is used to determine the first intermediate quantity.

In one embodiment, the third number is not equal to a sum of a number of bit(s) comprised in the first bit block and a number of bit(s) comprised in the second bit block.

In one embodiment, the third number is less than a sum of a number of bit(s) comprised in the first bit block and a number of bit(s) comprised in the second bit block.

In one embodiment, the third number is greater than a sum of a number of bit(s) comprised in the first bit block and a number of bit(s) comprised in the second bit block.

In one embodiment, the second condition is the first condition in the present application.

In one embodiment, the second condition is not the first condition in the present application.

In one embodiment, the second condition comprises: the second number is not greater than the second threshold.

In one embodiment, the second condition comprises: the second number is greater than the second threshold.

In one embodiment, the second condition comprises: the second number is greater than the second threshold and a fourth number is greater than a fourth threshold.

In one embodiment, the second condition comprises: the second number is not greater than the second threshold or a fourth number is not greater than a fourth threshold.

In one embodiment, the expression of the second condition being met comprises: all conditions in a first condition set are met.

In one embodiment, the expression of the second condition not being met comprises: at least one condition in a first condition set is not met.

In one embodiment, the expression of the second condition being met comprises: at least one condition in a first condition set is met.

In one embodiment, the expression of the second condition not being met comprises: all conditions in a first condition set are not met.

In one embodiment, the expression of the second condition being met comprises: all conditions in a first condition set are met, and at least one condition in a second condition set is met.

In one embodiment, the expression of the second condition not being met comprises: at least one condition in a first condition set is not met, or all conditions in a second condition set are not met.

In one embodiment, a condition in the first condition set comprise: the second number is not greater than the second threshold.

In one embodiment, a condition in the first condition set comprise: the second number is greater than the second threshold.

In one embodiment, a condition in the second condition set comprise: the second number is not greater than the second threshold.

In one embodiment, a condition in the second condition set comprise: the second number is greater than the second threshold.

In one embodiment, the second number is equal to the first number in the present application.

In one embodiment, the second number is not equal to the first number in the present application.

In one embodiment, the second number is equal to a number of bit(s) comprised in the first bit block.

In one embodiment, the second number is equal to a number of bit(s) comprised in the second bit block.

In one embodiment, the second number is equal to a sum of a number of bit(s) comprised in the first bit block and a number of bit(s) comprised in the second bit block.

In one embodiment, the second number is equal to a product of a number of bit(s) comprised in the first bit block and a number of bit(s) comprised in the second bit block.

In one embodiment, the second number is equal to a number of bit(s) comprised in the first bit block plus a second value multiplied by a number of bit(s) comprised in the second bit block, the second value is related to at least one of the first code rate or a second code rate, and the first code rate is different from the second code rate.

In one embodiment, the second number is equal to a result obtained by multiplying a second value by a number of bit(s) comprised in the second bit block rounding to an integer then plus a number of bit(s) comprised in the first bit block, the second value is related to at least one of a first code rate or a second code rate, and the first code rate is different from the second code rate.

In one embodiment, the second threshold is the first threshold in the present application.

In one embodiment, the second threshold is not the first threshold in the present application.

In one embodiment, the second threshold is indicated by a DCI signaling.

In one embodiment, the second threshold is configured by a higher-layer signaling.

In one embodiment, the second threshold is configured by an RRC signaling.

In one embodiment, the second threshold is configured by a MAC CE signaling.

In one embodiment, the second threshold is default.

In one embodiment, the second threshold is greater than 0.

In one embodiment, the second threshold is equal to 1.

In one embodiment, the second threshold is equal to 2.

In one embodiment, the second threshold is equal to 3.

In one embodiment, the second threshold is equal to 4.

In one embodiment, the second threshold is greater than 2.

In one embodiment, the second threshold is greater than 4.

In one embodiment, the second threshold is not greater than 1706.

In one embodiment, the second threshold is not greater than 17060.

In one embodiment, the second threshold is equal to a first parameter value minus a number of bit(s) comprised in the first bit block.

In one embodiment, when the second condition is met, a sum of a number of bit(s) comprised in the first bit block and a number of bit(s) comprised in the second bit block is used to determine the first radio resource pool set; when the second condition is not met, the third number is used to determine the first radio resource pool set.

In one embodiment, when the second condition is not met, a sum of a number of bit(s) comprised in the first bit block and a number of bit(s) comprised in the second bit block is used to determine the first radio resource pool set; when the second condition is met, the third number is used to determine the first radio resource pool set.

In one embodiment, the meaning of the phrase that a sum of a number of bit(s) comprised in the first bit block and a number of bit(s) comprised in the second bit block is used to determine the first radio resource pool set comprises: N number ranges respectively correspond to N radio resource pool sets, a first number range is one of the N number ranges, and a sum of the number of bit(s) comprised in the first bit block and the number of bit(s) comprised in the second bit block is equal to a number in the first number range; the first radio resource pool set is a radio resource pool set corresponding to the first number range among the N radio resource pool set(s).

In one embodiment, the meaning of the phrase that the third number is used to determine the first radio resource pool comprises: N number ranges respectively correspond to N radio resource pool sets, a first number range is one of the N number ranges, and the third number is equal to a number in the first number range; the first radio resource pool set is a radio resource pool set corresponding to the first number range among the N radio resource pool set(s).

In one embodiment, N is a positive integer.

In one embodiment, N is equal to one of 1 to 2.

In one embodiment, N is equal to one of 1 to 4.

In one embodiment, N is equal to one of 1 to 8.

In one embodiment, N is equal to one of 1 to 16.

In one embodiment, N is equal to one of 1 to 32.

In one embodiment, N is not greater than 1024.

In one embodiment, the N radio resource pool set(s) is(are) configured by an RRC signaling.

In one embodiment, the N radio resource pool set(s) comprises(respectively comprise) N PUCCH resource set(s).

In one embodiment, the first radio resource pool set comprises a PUCCH resource set.

In one embodiment, the number range comprises a positive integer number of or multiple continuous positive integers.

In one embodiment, the first intermediate quantity is equal to a first value multiplied by a number of bit(s) comprised in the second bit block, the first value is related to at least one of a first code rate or a second code rate, and the first code rate is different from the second code rate.

In one embodiment, the first intermediate quantity is equal to a result after a first value multiplied by a number of bit(s) comprised in the second bit block rounding to an integer, the first value is related to at least one of a first code rate or a second code rate, and the first code rate is different from the second code rate.

In one embodiment, the first value is equal to the first code rate divided by the second code rate.

In one embodiment, the first value is equal to the second code rate divided by the first code rate.

In one embodiment, the first value is equal to the first code rate.

In one embodiment, the first value is equal to the second code rate.

In one embodiment, the first value is equal to 1 divided by the first code rate.

In one embodiment, the first value is equal to 1 divided by the second code rate.

In one embodiment, the first code rate and the second code rate are respectively two different code rates.

In one embodiment, the first code rate and the second code rate are configured by an RRC signaling.

### Embodiment 10B

Embodiment 10B illustrates a schematic diagram of a procedure of a relation between a third bit block and a first bit block according to one embodiment of the present application, as shown in FIG. 10B.

In embodiment 10B, the first node in the present application in step S101: determines that a first calculation amount is greater than a second calculation amount, and determines that a first bit block comprises a CBG-based first-type HARQ-ACK bit; judges whether a third calculation amount is greater than the second calculation amount in step S102; if yes, enters into step S104 to determine; a number of the first-type HARQ-ACK bit(s) comprised in a third bit block is less than a number of the first-type HARQ-ACK bit(s) comprised in the first bit block; otherwise, enters into the step S103 to determine: a third bit block comprises the CBG-based first-type HARQ-ACK bit comprised in the first bit block.

In one subembodiment of embodiment 10B, the first offset value in the present application is used to determine the third calculation amount.

In one embodiment, the third calculation amount is the fourth calculation amount in the present application.

In one embodiment, when the third calculation amount is greater than the second calculation amount: the third bit block does not comprise at least part of CBG-based first-type HARQ-ACK bits in the first bit block and the third bit block comprises the TB-based first-type HARQ-ACK bit related to the first bit block.

In one embodiment, when the third calculation amount is greater than the second calculation amount: the third bit block does not comprise the CBG-based first-type HARQ-ACK bit.

In one embodiment, the first bit block comprises multiple CBG-based first-type HARQ-ACK bits generated for a third TB, and when the third calculation amount is greater than the second calculation amount: a number of the first-type HARQ-ACK bit(s) generated for the third TB comprised in the third bit block is equal to 1.

In one embodiment, a third TB comprises multiple CBGs, and the first bit block comprises multiple first-type HARQ-ACK bits indicating whether the multiple CBGs in the third TB are correctly received; when the third calculation amount is greater than the second calculation amount: a number of the first-type HARQ-ACK bit(s) indicating whether the third TB is correctly received comprised in the third bit block is equal to 1.

In one embodiment, the CBG-based first-type HARQ-ACK comprises: the first-type HARQ-ACK bit in a CBG-based HARQ-ACK codebook.

In one embodiment, the CBG-based first-type HARQ-ACK comprises: the first-type HARQ-ACK bit in a CBG-based HARQ-ACK sub-codebook.

In one embodiment, the CBG-based first-type HARQ-ACK comprises: the first-type HARQ-ACK bit used to indicate whether CBG(s) in CBG-based Physical Downlink Shared CHannel (PDSCH) reception(s) is(are) correctly received.

In one embodiment, the CBG-based first-type HARQ-ACK bit indicates whether a CBG in a TB is correctly received.

In one embodiment, the TB-based first-type HARQ-ACK comprises: the first-type HARQ-ACK bit in a TB-based HARQ-ACK codebook.

In one embodiment, the TB-based first-type HARQ-ACK comprises: the first-type HARQ-ACK bit in a TB-based HARQ-ACK sub-codebook.

In one embodiment, the TB-based first-type HARQ-ACK comprises: the first-type HARQ-ACK bit used to indicate whether an SPS PDSCH release, an SPS PDSCH reception, or a TB-based PDSCH reception is correctly received.

In one embodiment, the TB-based first-type HARQ-ACK bit indicates whether an SPS PDSCH release or a TB is correctly received.

### Embodiment 11A

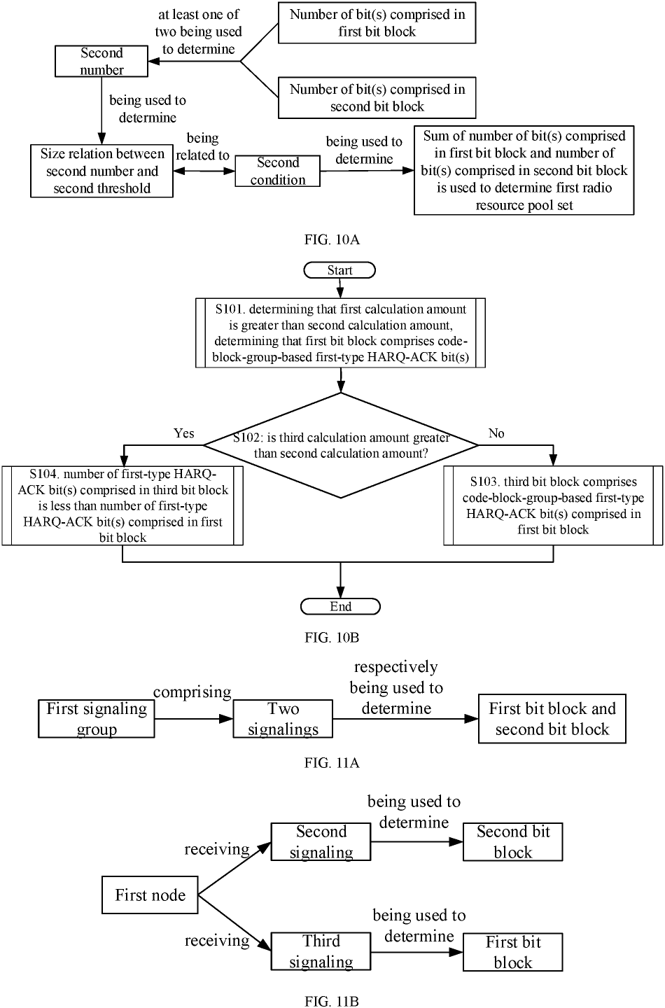

Embodiment 11A illustrates a schematic diagram of relations among a first signaling group, two signalings, a first bit block and a second bit block according to one embodiment of the present application, as shown in FIG. 11A.

In embodiment 11A, two signalings comprised in a first signaling group are respectively used to determine a first bit block and a second bit block.

In one subembodiment of embodiment 11A, the first signaling group comprises the first signaling in the present application.

In one embodiment, two signalings in the first signaling group are respectively used to determine the first bit block and the second bit block; the two signalings in the first signaling group comprise the first signaling.

In one embodiment, the first signaling is used to determine the first bit block.

In one embodiment, the first signaling is used to determine the second bit block.

In one embodiment, a signaling other than the first signaling is used to determine the first bit block, and another signaling other than the first signaling is used to determine the second bit block.

In one embodiment, a signaling in the first signaling group is dynamically configured.

In one embodiment, a signaling in the first signaling group comprises an L1 signaling.

In one embodiment, a signaling in the first signaling group comprises an L1 control signaling.

In one embodiment, a signaling in the first signaling group comprises a physical-layer signaling.

In one embodiment, a signaling in the first signaling group comprises one or multiple fields in a physical-layer signaling.

In one embodiment, a signaling in the first signaling group comprises a higher-layer signaling.

In one embodiment, a signaling in the first signaling group comprises one or multiple fields in a higher-layer signaling.

In one embodiment, a signaling in the first signaling group comprises an RRC signaling.

In one embodiment, a signaling in the first signaling group comprises a MAC CE signaling.

In one embodiment, a signaling in the first signaling group comprises one or multiple fields in an RRC signaling.

In one embodiment, a signaling in the first signaling group comprises one or multiple fields in a MAC CE signaling.

In one embodiment, a signaling in the first signaling group comprises a DCI.

In one embodiment, a signaling in the first signaling group comprises one or multiple fields in a DCI.

In one embodiment, a signaling in the first signaling group comprises an SCI.

In one embodiment, a signaling in the first signaling group comprises one or multiple fields in an SCI.

In one embodiment, a signaling in the first signaling group comprises one or multiple fields in an IE.

In one embodiment, a signaling in the first signaling group is a downlink grant signaling.

In one embodiment, a signaling in the first signaling group is an uplink grant signaling.

In one embodiment, a signaling in the first signaling group is transmitted on a downlink physical-layer control channel (i.e., a downlink channel only capable of bearing a physical-layer signaling).

In one embodiment, a signaling in the first signaling group is DCI format 1_0, and for specific meaning of the DCI format 1_0, refer to section 7.3.1.2 in 3GPP TS38.212.

In one embodiment, a signaling in the first signaling group is DCI format 1_1, and for specific meaning of the DCI format 1_1, refer to section 7.3.1.2 in 3GPP TS38.212.

In one embodiment, a signaling in the first signaling group is DCI format 1_2, for the specific meaning of the DCI format 1_2, refer to section 7.3.1.2 in 3GPP TS38.212.

In one embodiment, a signaling in the first signaling group is DCI format 0_0, and for the specific meaning of the DCI format 0_0, refer to section 7.3.1.1 in 3GPP TS38. 212.

In one embodiment, a signaling in the first signaling group is DCI format 0_1, and for the specific meaning of the DCI format 0_1, refer to section 7.3.1.1 in 3GPP TS38. 212.

In one embodiment, a signaling in the first signaling group is DCI format 0_2, and for the specific meaning of the DCI format 0_2, refer to section 7.3.1.1 in 3GPP TS38. 212.

In one embodiment, two signalings in the first signaling group are respectively used to determine the first bit block and the second bit block; the first bit block comprises indication information of whether one of the two signalings in the first signaling group is correctly received, or, the first bit block comprises indication information of whether a bit block scheduled by one of the two signalings in the first signaling group is correctly received; the second bit block comprises indication information of whether the other one of the two signalings in the first signaling group is correctly received, or, the second bit block comprises indication information of whether a bit block scheduled by the other one of the two signalings in the first signaling group is correctly received.

In one subembodiment of the above embodiment, the first bit block comprises the first-type HARQ-ACK in the present application, and the second bit block comprises the second-type HARQ-ACK in the present application.

### Embodiment 11B

Embodiment 11B illustrates a schematic diagram of relations among a first node, a second signaling, a third signaling, a second bit block and a first bit block according to one embodiment of the present application, as shown in FIG. 11B.

In embodiment 11B, the first node in the present application receives a second signaling and a third signaling; the second signaling is used to determine a second bit block; the third signaling is used to determine a first bit block.

In one embodiment, the second signaling comprises an L1 signaling.

In one embodiment, the second signaling comprises an L1 control signaling.

In one embodiment, the second signaling comprises a physical-layer signaling.

In one embodiment, the second signaling comprises one or multiple fields in a physical-layer signaling.

In one embodiment, the second signaling comprises a higher-layer signaling.

In one embodiment, the second signaling comprises one or multiple fields in a higher-layer signaling.

In one embodiment, the second signaling comprises an RRC signaling.

In one embodiment, the second signaling comprises a MAC CE signaling.

In one embodiment, the second signaling comprises one or multiple fields in an RRC signaling.

In one embodiment, the second signaling comprises one or multiple fields in a MAC CE signaling.

In one embodiment, the second signaling comprises a DCI.

In one embodiment, the second signaling comprises one or multiple fields of a DCI.

In one embodiment, the second signaling comprises an SCI.

In one embodiment, the second signaling comprises one or multiple fields of an SCI.

In one embodiment, the second signaling comprises one or multiple fields in an IE.

In one embodiment, the second signaling is a DownLink Grant Signalling.

In one embodiment, the second signaling is transmitted on a downlink physical-layer control channel (i.e., a downlink channel only capable of bearing a physical-layer signaling).

In one embodiment, the second signaling is DCI format 1_0, and for the specific meaning of the DCI format 1_0, refer to section 7.3.1.2 in 3GPP TS38.212.

In one embodiment, the second signaling is DCI format 1_1, and for the specific meaning of the DCI format 1_1, refer to section 7.3.1.2 in 3GPP TS38.212.

In one embodiment, the second signaling is DCI format 1_2, and for the specific meaning of the DCI format 1_2, refer to section 7.3.1.2 in 3GPP TS38.212.

In one embodiment, the third signaling comprises an L1 signaling.

In one embodiment, the third signaling comprises an L1 control signaling.

In one embodiment, the third signaling comprises a physical-layer signaling.

In one embodiment, the third signaling comprises one or multiple fields in a physical-layer signaling.

In one embodiment, the third signaling comprises a higher-layer signaling.

In one embodiment, the third signaling comprises one or multiple fields in a higher-layer signaling.

In one embodiment, the third signaling comprises an RRC signaling.

In one embodiment, the third signaling comprises a MAC CE signaling.

In one embodiment, the third signaling comprises one or multiple fields in an RRC signaling.

In one embodiment, the third signaling comprises one or multiple fields in a MAC CE signaling.

In one embodiment, the third signaling comprises a DCI.

In one embodiment, the third signaling comprises one or multiple fields of a DCI.

In one embodiment, the third signaling comprises an SCI.

In one embodiment, the third signaling comprises one or multiple fields in an SCI.

In one embodiment, the third signaling comprises one or multiple fields in an IE.

In one embodiment, the third signaling is a DownLink Grant Signalling.

In one embodiment, the third signaling is transmitted on a downlink physical-layer control channel (i.e., a downlink channel only capable of bearing a physical-layer signaling).

In one embodiment, the third signaling is DCI format 1_0, and for the specific meaning of the DCI format 1_0, refer to section 7.3.1.2 in 3GPP TS38.212.

In one embodiment, the third signaling is DCI format 1_1, and for the specific meaning of the DCI format 1_1, refer to section 7.3.1.2 in 3GPP TS38.212.

In one embodiment, the third signaling is DCI format 1_2, and for the specific meaning of the DCI format 1_0, refer to section 7.3.1.2 in 3GPP TS38.212.

In one embodiment, the second signaling indicates the second priority in the present application, and the third signaling indicates the first priority in the present application.

In one embodiment, the second signaling is used to schedule the first TB in the present application.

In one embodiment, the second signaling comprises second scheduling information; the second scheduling information comprises at least one of occupied time-domain resources, occupied frequency-domain resources, a Modulation and Coding Scheme (MCS), configuration information of DeModulation Reference Signals (DMRS), a Hybrid Automatic Repeat request (HARQ) process number, a Redundancy Version (RV), a New Data Indicator (NDI), a periodicity, a transmission antenna port, or a corresponding Transmission Configuration Indicator (TCI) state.

In one embodiment, the second bit block comprises the second-type HARQ-ACK bit corresponding to the second signaling.

In one embodiment, the first bit block comprises the first-type HARQ-ACK bit corresponding to the third signaling.

In one embodiment, the second bit block comprises: a HARQ-ACK bit indicating whether the second signaling is correctly received, or, a HARQ-ACK bit indicating whether a bit block (e.g., a TB or a CBG) scheduled by the second signaling is correctly received.

In one embodiment, the first bit block comprises: a HARQ-ACK bit indicating whether the third signaling is correctly received, or, a HARQ-ACK bit indicating whether a bit block (e.g., a TB or a CBG) scheduled by the third signaling is correctly received.

### Embodiment 12A

Embodiment 12A illustrates a schematic diagram of relations among a third radio resource pool, a second radio resource pool, a first bit block and a second bit block according to one embodiment of the present application, as shown in FIG. 12A.

In embodiment 12A, a third radio resource pool is reserved for a first bit block, and a second radio resource pool is reserved for a second bit block; the third radio resource pool and the second radio resource pool are overlapping in time domain.

In one embodiment, the third radio resource pool comprises a positive integer number of time-frequency resource element(s) in time-frequency domain.

In one embodiment, the third radio resource pool comprises a positive integer number of RE(s) in time-frequency domain.

In one embodiment, the third radio resource pool comprises a positive integer number of subcarrier(s) in frequency domain.

In one embodiment, the third radio resource pool comprises a positive integer number of PRB(s) in frequency domain.

In one embodiment, the third radio resource pool comprises a positive integer number of RB(s) in frequency domain.

In one embodiment, the third radio resource pool comprises a positive integer number of multi-carrier symbol(s) in time domain.

In one embodiment, the third radio resource pool comprises a positive integer number of slot(s) in time domain.

In one embodiment, the third radio resource pool comprises a positive integer number of sub-slot(s) in time domain.

In one embodiment, the third radio resource pool comprises a positive integer number of ms(s) in time domain.

In one embodiment, the third radio resource pool comprises a positive integer number of continuous multicarrier symbol(s) in time domain.

In one embodiment, the third radio resource pool comprises a positive integer number of discontinuous slot(s) in time domain.

In one embodiment, the third radio resource pool comprises a positive integer number of continuous slot(s) in time domain.

In one embodiment, the third radio resource pool comprises a positive integer number of subframe(s) in time domain.

In one embodiment, the third radio resource pool is configured by a physical-layer signaling.

In one embodiment, the third radio resource pool is configured by a higher-layer signaling.

In one embodiment, the third radio resource pool is configured by an RRC signaling.

In one embodiment, the third radio resource pool is configured by a MAC CE signaling.

In one embodiment, the third radio resource pool is reserved for an uplink physical-layer channel.

In one embodiment, the third radio resource pool comprises time-frequency resources reserved for an uplink physical-layer channel.

In one embodiment, the third radio resource pool comprises time-frequency resources occupied by an uplink physical-layer channel.

In one embodiment, the third radio resource pool is reserved for a PUCCH.

In one embodiment, the third radio resource pool comprises radio resources reserved for a PUCCH.

In one embodiment, the third radio resource pool comprises a PUCCH resource.

In one embodiment, the second radio resource pool comprises a positive integer number of time-frequency resource element(s) in time-frequency domain.

In one embodiment, the second radio resource pool comprises a positive integer number of RE(s) in time-frequency domain.

In one embodiment, the second radio resource pool comprises a positive integer number of subcarrier(s) in frequency domain.

In one embodiment, the second radio resource pool comprises a positive integer number of PRB(s) in frequency domain.

In one embodiment, the second radio resource pool comprises a positive integer number of RB(s) in frequency domain.

In one embodiment, the second radio resource pool comprises a positive integer number of multi-carrier symbol(s) in time domain.

In one embodiment, the second radio resource pool comprises a positive integer number of slot(s) in time domain.

In one embodiment, the second radio resource pool comprises a positive integer number of sub-slot(s) in time domain.

In one embodiment, the second radio resource pool comprises a positive integer number of ms(s) in time domain.

In one embodiment, the second radio resource pool comprises a positive integer number of continuous multicarrier symbol(s) in time domain.

In one embodiment, the second radio resource pool comprises a positive integer number of discontinuous slot(s) in time domain.

In one embodiment, the second radio resource pool comprises a positive integer number of continuous slot(s) in time domain.

In one embodiment, the second radio resource pool comprises a positive integer number of subframe(s) in time domain.

In one embodiment, the second radio resource pool is configured by a physical-layer signaling.

In one embodiment, the second radio resource pool is configured by a higher-layer signaling.

In one embodiment, the second radio resource pool is configured by an RRC signaling.

In one embodiment, the second radio resource pool is configured by a MAC CE signaling.

In one embodiment, the second radio resource pool is reserved for an uplink physical-layer channel.

In one embodiment, the second radio resource pool comprises time-frequency resources reserved for an uplink physical layer channel.

In one embodiment, the second radio resource pool comprises time-frequency resources occupied by an uplink physical-layer channel.

In one embodiment, the second radio resource pool is reserved for a PUCCH.

In one embodiment, the second radio resource pool comprises radio resources reserved for a PUCCH.

In one embodiment, the second radio resource pool comprises a PUCCH resource.

In one embodiment, two signalings in the first signaling group in the present application respectively indicate the third radio resource pool and the second radio resource pool.

In one embodiment, the phrase of being overlapping in time domain in the present application comprises: being overlapping in time domain, and being overlapping in frequency domain.

In one embodiment, the phrase of being overlapping in time domain in the present application comprises: being overlapping in time domain, and being overlapping and non-overlapping in frequency domain.

In one embodiment, the first code rate in the present application and the second code rate in the present application are respectively code rate corresponding to the third radio resource pool and code rate corresponding to the second radio resource pool.

In one embodiment, the first code rate in the present application and the second code rate in the present application are respectively maximum code rate corresponding to the third radio resource pool and maximum code rate corresponding to the second radio resource pool.

In one embodiment, the first code rate in the present application and the second code rate in the present application are respectively maximum code rate configured to a PUCCH comprised in the third radio resource pool and maximum code rate configured to a PUCCH comprised in the second radio resource pool.

In one embodiment, the first code rate in the present application and the second code rate in the present application are respectively two different maximum code rates configured to a PUCCH resource comprised in the second radio resource pool.

In one embodiment, the first code rate in the present application and the second code rate in the present application are respectively two different maximum code rates configured to a PUCCH resource comprised in the third radio resource pool.

In one embodiment, the first radio resource pool in the present application is the third radio resource pool.

In one embodiment, the first radio resource pool in the present application is the second radio resource pool.

In one embodiment, the first radio resource pool in the present application is different from a radio resource pool of the second radio resource pool and the third radio resource pool.

In one embodiment, the third radio resource pool overlaps with the first radio resource pool in the present application in time domain.

In one embodiment, the second radio resource pool overlaps with the first radio resource pool in the present application in time domain.

### Embodiment 12B

Embodiment 12B illustrates a schematic diagram of relations among a first time-frequency resource pool, a first radio resource pool, a first bit block and a second bit block according to one embodiment of the present application, as shown in FIG. 12B.

In embodiment 12B, a first radio resource pool is reserved for at least one of a first bit block or a second bit block; the first radio resource pool overlaps with a first time-frequency resource pool in time domain.

In one embodiment, the first radio resource pool is reserved for the first bit block.

In one embodiment, the first radio resource pool is reserved for the second bit block.

In one embodiment, the first radio resource pool is reserved for the first bit block and the second bit block.

In one embodiment, the phrase of being overlapping in time domain in the present application comprises: being overlapping in time domain, and being overlapping in frequency domain.

In one embodiment, the phrase of being overlapping in time domain in the present application comprises: being overlapping in time domain, and being overlapping and non-overlapping in frequency domain.

In one embodiment, the first radio resource pool comprises a positive integer number of time-frequency resource element(s) in time-frequency domain.

In one embodiment, the first radio resource pool comprises a positive integer number of RE(s) in time frequency domain.

In one embodiment, the first radio resource pool comprises a positive integer number of subcarrier(s) in frequency domain.

In one embodiment, the first radio resource pool comprises a positive integer number of PRB(s) in frequency domain.

In one embodiment, the first radio resource pool comprises a positive integer number of RB(s) in frequency domain.

In one embodiment, the first radio resource pool comprises a positive integer number of multi-carrier symbol(s) in time domain.

In one embodiment, the first radio resource pool comprises a positive integer number of slot(s) in time domain.

In one embodiment, the first radio resource pool comprises a positive integer number of sub-slot(s) in time domain.

In one embodiment, the first radio resource pool comprises a positive integer number of ms(s) in time domain.

In one embodiment, the first radio resource pool comprises a positive integer number of continuous multi-carrier symbol(s) in time domain.

In one embodiment, the first radio resource pool comprises a positive integer number of discontinuous slot(s) in time domain.

In one embodiment, the first radio resource pool comprises a positive integer number of continuous slot(s) in time domain.

In one embodiment, the first radio resource pool comprises a positive integer number of sub-frame(s) in time domain.

In one embodiment, the first radio resource pool is configured by a physical-layer signaling.

In one embodiment, the first radio resource pool is configured by a higher-layer signaling.

In one embodiment, the first radio resource pool is configured by a Radio Resource Control (RRC) signaling.

In one embodiment, the first radio resource pool is configured by a Medium Access Control layer Control Element (MAC CE) signaling.

In one embodiment, the first radio resource pool is reserved for a Physical Uplink Control CHannel (PUCCH).

In one embodiment, the first radio resource pool comprises radio resources reserved for a PUCCH.

In one embodiment, the first radio resource pool comprises radio resources occupied by a PUCCH.

In one embodiment, the first radio resource pool comprises a PUCCH resource.

In one embodiment, the first radio resource pool comprises a PUCCH resource in a PUCCH resource set.

In one embodiment, the second signaling in the present application indicates the first radio resource pool.

In one embodiment, the third signaling in the present application indicates the first radio resource pool.

### Embodiment 13A

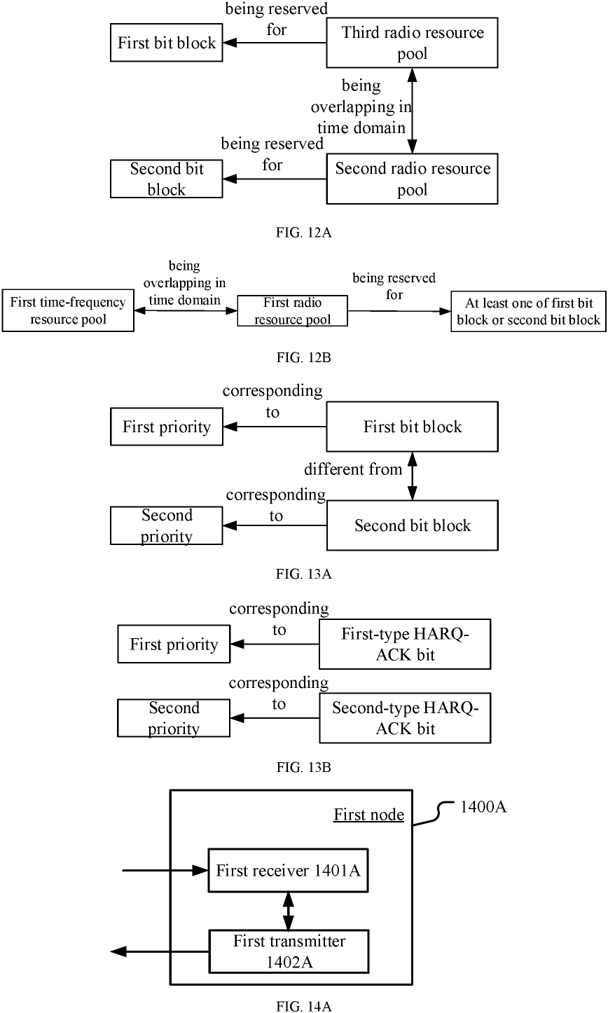

Embodiment 13A illustrates a schematic diagram of a relation between a first bit block and a first priority as well as a relation between a second bit block and a second priority according to one embodiment of the present application, as shown in FIG. 13A.

In embodiment 13A, a first bit block corresponds to a first priority, and a second bit block corresponds to a second priority; the first priority is different from the second priority.

In one embodiment, the first signaling in the present application indicates the first priority.

In one embodiment, the first signaling in the present application indicates the second priority.

In one embodiment, the fourth bit block in the present application corresponds to one of a first priority or a second priority.

In one embodiment, a priority corresponding to the fourth bit block in the present application is a priority indicated by the first signaling.

In one embodiment, both the first priority index in the present application and the second priority index in the present application are priority indexes.

In one embodiment, a first priority index indicates the first priority, and a second priority index indicates the second priority.

In one embodiment, an index of the first priority is a first priority index, and an index of the second priority is a second priority index.

In one embodiment, the first signaling in the present application indicates one of a first priority index or a second priority index.

In one embodiment, the first signaling in the present application comprises a priority indicator field.

In one embodiment, a priority index comprised in a priority indicator field comprised in the first signaling is one of a first priority index or a second priority index.

In one embodiment, the first bit block comprises a first-type HARQ-ACK; the first-type HARQ-ACK is: a HARQ-ACK indicating whether a bit block carried by a PDSCH transmission scheduled by a signaling of the first priority is correctly received or indicating whether a signaling of the first priority itself is correctly received.

In one embodiment, the second bit block comprises a second-type HARQ-ACK; the second-type HARQ-ACK is: a HARQ-ACK indicating whether a bit block carried by a PDSCH transmission scheduled by a signaling of the second priority is correctly received or indicating whether a signaling of the second priority itself is correctly received.

In one embodiment, the first bit block comprises a first-type HARQ-ACK; the first-type HARQ-ACK is: a HARQ-ACK indicating whether a bit block carried by a PDSCH transmission scheduled by a signaling of a first priority index is correctly received or indicating whether a signaling of a first priority index itself is correctly received.

In one embodiment, the second bit block comprises a second-type HARQ-ACK; the second-type HARQ-ACK is: a HARQ-ACK indicating whether a bit block carried by a PDSCH transmission scheduled by a signaling of a second priority index is correctly received or indicating whether a signaling of a second priority index itself is correctly received.

In one embodiment, a priority corresponding to the first bit block is the same as a priority corresponding to the first-type HARQ-ACK bit.

In one embodiment, a priority corresponding to the second bit block is the same as a priority corresponding to the second-type HARQ-ACK bit.

In one embodiment, a priority indicated by the first signaling in the present application is the same as a priority corresponding to the first-type HARQ-ACK bit.

In one embodiment, a priority indicated by the first signaling in the present application is the same as a priority corresponding to the second-type HARQ-ACK bit.

In one embodiment, the first priority index is priority index 1, and the second priority index is priority index 0.

In one embodiment, the first priority index is priority index 0, and the second priority index is priority index 1.

In one embodiment, a priority indicated by the second signaling in the present application is the same as a priority corresponding to the second-type HARQ-ACK bit.

In one embodiment, a priority indicated by the third signaling in the present application is the same as a priority corresponding to the first-type HARQ-ACK bit.

In one embodiment, the first bit block comprises a first-type UCI, and the second bit block comprises a second-type UCI; the first-type UCI corresponds to the first priority based on default or higher-layer-signaling-configured rules, and the second-type UCI corresponds to the second priority based on default or higher-layer-signaling-configured rules.

In one embodiment, a signaling in the first signaling group in the present application indicates the first priority.

In one embodiment, a signaling in the first signaling group in the present application indicates the second priority.

In one embodiment, a signaling in the first signaling group in the present application comprises a priority indicator field.

In one embodiment, a priority index comprised in a priority indicator field comprised in a signaling in the first signaling group in the present application is a first priority index or a second priority index.

In one embodiment, the third radio resource pool in the present application corresponds to the first priority based on default or higher-layer-signaling-configured rules.

In one embodiment, the second radio resource pool in the present application corresponds to the second priority based on default or higher-layer-signaling-configured rules.

In one embodiment, the first radio resource pool in the present application corresponds to the first priority or the second priority based on default or higher-layer-signaling-configured rules.

### Embodiment 13B

Embodiment 13B illustrates a schematic diagram of a relation between a first-type HARQ-ACK bit and a first priority as well as a relation between a second-type HARQ-ACK bit and a second priority according to one embodiment of the present application, as shown in FIG. 13B.

In embodiment 13B, a first-type HARQ-ACK bit corresponds to a first priority, and a second-type HARQ-ACK bit corresponds to a second priority; the first priority is different from the second priority.

In one embodiment, the first signaling in the present application indicates the first priority.

In one embodiment, the first signaling in the present application indicates the second priority.

In one embodiment, the fourth bit block in the present application corresponds to one of a first priority or a second priority.

In one embodiment, a priority corresponding to the fourth bit block in the present application is a priority indicated by the first signaling.

In one embodiment, both the first priority index in the present application and the second priority index in the present application are priority indexes.

In one embodiment, a first priority index indicates the first priority, and a second priority index indicates the second priority.

In one embodiment, a priority of the first priority is a first priority index, and a priority of the second priority is a second priority index.

In one embodiment, the first signaling in the present application indicates one of a first priority index or a second priority index.

In one embodiment, a priority indicated by the first signaling in the present application is the same as a priority corresponding to the first-type HARQ-ACK bit.

In one embodiment, a priority indicated by the first signaling in the present application is the same as a priority corresponding to the second-type HARQ-ACK bit.

In one embodiment, the first signaling in the present application comprises a priority indicator field.

In one embodiment, a priority index comprised in a priority indicator field comprised in the first signaling is one of a first priority index or a second priority index.

In one embodiment, the first-type HARQ-ACK bit is: a HARQ-ACK bit indicating whether a bit block carried by a PDSCH transmission scheduled by a signaling of the first priority is correctly received or indicating whether a signaling of the first priority itself is correctly received.

In one embodiment, the second-type HARQ-ACK bit is: a HARQ-ACK bit indicating whether a bit block carried by a PDSCH transmission scheduled by a signaling of the second priority is correctly received or indicating whether a signaling of the second priority itself is correctly received.

In one embodiment, the first-type HARQ-ACK bit is: a HARQ-ACK bit indicating whether a bit block carried by a PDSCH transmission scheduled by a signaling of a first priority index is correctly received or indicating whether a signaling of a first priority index itself is correctly received.

In one embodiment, the second-type HARQ-ACK bit is: a HARQ-ACK bit indicating whether a bit block carried by a PDSCH transmission scheduled by a signaling of a second priority index is correctly received or indicating whether a signaling of a second priority index itself is correctly received.

In one embodiment, the first priority index is priority index 1, and the second priority index is priority index 0.

In one embodiment, the first priority index is priority index 0, and the second priority index is priority index 1.

In one embodiment, a priority indicated by the second signaling in the present application is the same as a priority corresponding to the second-type HARQ-ACK bit.

In one embodiment, a priority indicated by the third signaling in the present application is the same as a priority corresponding to the first-type HARQ-ACK bit.

In one embodiment, the second signaling in the present application comprises a priority indicator field.

In one embodiment, a priority index comprised in a priority indicator field comprised in the second signaling is a second priority index.

In one embodiment, the third signaling in the present application comprises a priority indicator field.

In one embodiment, a priority index comprised in a priority indicator field comprised in the third signaling is a first priority index.

In one embodiment, a priority corresponding to the first bit block in the present application is the same as a priority corresponding to the first-type HARQ-ACK bit.

In one embodiment, a priority corresponding to the second bit block in the present application is the same as a priority corresponding to the second-type HARQ-ACK bit.

### Embodiment 14A

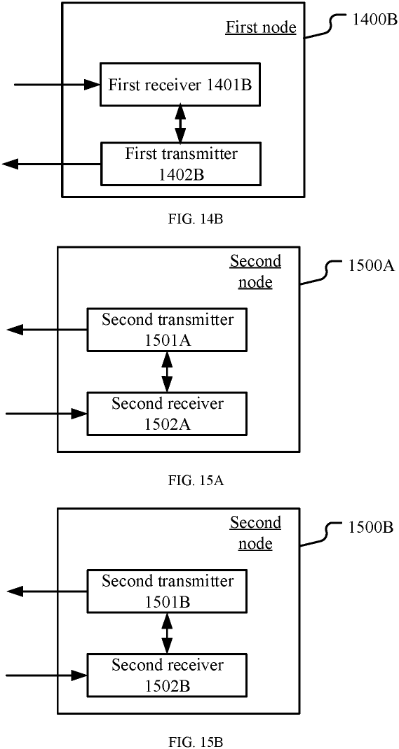

Embodiment 14A illustrates a structure block diagram of a processor in a first node, as shown in FIG. 14A. In FIG. 14A, a processor 1400A in a first node comprises a first receiver 1401A and a first transmitter 1402A.

In one embodiment, the first node 1400A is a UE.

In one embodiment, the first node 1400A is a relay node.

In one embodiment, the first node 1400A is a vehicle-mounted communication device.

In one embodiment, the first node 1400A is a UE that supports V2X communications.

In one embodiment, the first node 1400A is a relay node that supports V2X communications.

In one embodiment, the first receiver 1401A comprises at least one of the antenna 452, the receiver 454, the multi-antenna receiving processor 458, the receiving processor 456, the controller/ processor 459, the memory 460 or the data source 467 in FIG. 4 of the present application.

In one embodiment, the first receiver 1401A comprises at least the first five of the antenna 452, the receiver 454, the multi-antenna receiving processor 458, the receiving processor 456, the controller/ processor 459, the memory 460 and the data source 467 in FIG. 4 of the present application.

In one embodiment, the first receiver 1401A comprises at least the first four of the antenna 452, the receiver 454, the multi-antenna receiving processor 458, the receiving processor 456, the controller/ processor 459, the memory 460 and the data source 467 in FIG. 4 of the present application.

In one embodiment, the first receiver 1401A comprises at least the first three of the antenna 452, the receiver 454, the multi-antenna receiving processor 458, the receiving processor 456, the controller/ processor 459, the memory 460 and the data source 467 in FIG. 4 of the present application.

In one embodiment, the first receiver 1401A comprises at least the first two of the antenna 452, the receiver 454, the multi-antenna receiving processor 458, the receiving processor 456, the controller/ processor 459, the memory 460 and the data source 467 in FIG. 4 of the present application.

In one embodiment, the first transmitter 1402A comprises at least one of the antenna 452, the transmitter 454, the multi-antenna transmitting processor 457, the transmitting processor 468, the controller/ processor 459, the memory 460, and the data source 467 in FIG. 4 of the present application.

In one embodiment, the first transmitter 1402A comprises at least first five of the antenna 452, the transmitter 454, the multi-antenna transmitting processor 457, the transmitting processor 468, the controller/ processor 459, the memory 460, and the data source 467 in FIG. 4 of the present application.

In one embodiment, the first transmitter 1402A comprises at least first four of the antenna 452, the transmitter 454, the multi-antenna transmitting processor 457, the transmitting processor 468, the controller/ processor 459, the memory 460, and the data source 467 in FIG. 4 of the present application.

In one embodiment, the first transmitter 1402A comprises at least first three of the antenna 452, the transmitter 454, the multi-antenna transmitting processor 457, the transmitting processor 468, the controller/ processor 459, the memory 460, and the data source 467 in FIG. 4 of the present application.

In one embodiment, the first transmitter 1402A comprises at least first two of the antenna 452, the transmitter 454, the multi-antenna transmitting processor 457, the transmitting processor 468, the controller/ processor 459, the memory 460, and the data source 467 in FIG. 4 of the present application.

In embodiment 14A, the first receiver 1401A receives a first signaling; the first transmitter 1402A transmits a first signal in a first radio resource pool, the first signal carries a first bit block and a second bit block; herein, the first signaling is used to determine the first radio resource pool; a first condition is a condition related to a size relation between a first number and a first threshold, and at least one of a number of bit(s) comprised in the first bit block or a number of bit(s) comprised in the second bit block is used to determine the first number; a third bit block is used to generate the first signal, the first bit block and the second bit block are used to generate the third bit block, and whether the first condition is met is used to determine whether bit(s) in the first bit block and bit(s) in the second bit block are separately input into different channel codings to obtain the third bit block.

In one embodiment, the first number is equal to a number of bit(s) comprised in the second bit block; the first condition comprises: the number of bit(s) comprised in the second bit block is not greater than the first threshold.

In one embodiment, when the first condition is met, the third bit block comprises outputs after all bits in the first bit block and all bits in the second bit block are input into a same channel coding; when the first condition is not met, the third bit block comprises outputs after bit(s) in the first bit block and bit(s) in the second bit block are separately input into different channel codings.

In one embodiment, when the first condition is met, the third bit block comprises all bits in the first bit block and all bits in the second bit block; when the first condition is not met, the third bit block comprises outputs after bit(s) in the first bit block and bit(s) in the second bit block are separately input into different channel codings.

In one embodiment, a second condition is a condition related to a size relation between a second number and a second threshold, and at least one of a number of bit(s) comprised in the first bit block or a number of bit(s) comprised in the second bit block is used to determine the second number; whether the second condition is met is used to determine whether a sum of a number of bit(s) comprised in the first bit block and a number of bit(s) comprised in the second bit block or a third number is used to determine a first radio resource pool set, the third number is equal to a number of bit(s) comprised in the first bit block plus a first intermediate quantity, and a number of bit(s) comprised in the second bit block is used to determine the first intermediate quantity; the first radio resource pool set comprises the first radio resource pool.

In one embodiment, the first receiver 1401A receives a first signaling group; herein, the first signaling group comprises the first signaling; herein, two signalings in the first signaling group are respectively used to determine the first bit block and the second bit block.

In one embodiment, a third radio resource pool is reserved for the first bit block, and a second radio resource pool is reserved for the second bit block; the third radio resource pool and the second radio resource pool are overlapping in time domain.

In one embodiment, the second bit block comprises a Hybrid Automatic Repeat reQuest ACKnowledgement (HARQ-ACK) bit(s), the first bit block comprises Scheduling Request (SR) bit(s), and the first condition comprises: a number of bit(s) comprised in the second bit block is not greater than the first threshold; when a number of bit(s) comprised in the second bit block is not greater than the first threshold, the third bit block comprises all bits in the first bit block and all or partial bits in the second bit block; when a number of bit(s) comprised in the second bit block is greater than the first threshold, the third bit block comprises outputs after bit(s) in the first bit block and bit(s) in the second bit block are separately input into different channel codings.

In one subembodiment of the above embodiment, when a number of bit(s) comprised in the second bit block is not greater than the first threshold: bits in the third bit block are used to generate the first signal after being used to determine a sequence cyclic shift based on a mapping relation.

In one embodiment, the first threshold is equal to 2.

### Embodiment 14B

Embodiment 14B illustrates a structure block diagram of a processor in a first node, as shown in FIG. 14B. In FIG. 14B, a processor 1400B in a first node comprises a first receiver 1401B and a first transmitter 1402B.

In one embodiment, the first node 1400B is a UE.

In one embodiment, the first node 1400B is a relay node.

In one embodiment, the first node 1400B is a vehicle-mounted communication device.

In one embodiment, the first node 1400B is a UE that supports V2X communications.

In one embodiment, the first node 1400B is a relay node that supports V2X communications.

In one embodiment, the first receiver 1401B comprises at least one of the antenna 452, the receiver 454, the multi-antenna receiving processor 458, the receiving processor 456, the controller/ processor 459, the memory 460 or the data source 467 in FIG. 4 of the present application.

In one embodiment, the first receiver 1401B comprises at least the first five of the antenna 452, the receiver 454, the multi-antenna receiving processor 458, the receiving processor 456, the controller/ processor 459, the memory 460 and the data source 467 in FIG. 4 of the present application.

In one embodiment, the first receiver 1401B comprises at least the first four of the antenna 452, the receiver 454, the multi-antenna receiving processor 458, the receiving processor 456, the controller/ processor 459, the memory 460 and the data source 467 in FIG. 4 of the present application.

In one embodiment, the first receiver 1401B comprises at least the first three of the antenna 452, the receiver 454, the multi-antenna receiving processor 458, the receiving processor 456, the controller/ processor 459, the memory 460 and the data source 467 in FIG. 4 of the present application.

In one embodiment, the first receiver 1401B comprises at least the first two of the antenna 452, the receiver 454, the multi-antenna receiving processor 458, the receiving processor 456, the controller/ processor 459, the memory 460 and the data source 467 in FIG. 4 of the present application.

In one embodiment, the first transmitter 1402B comprises at least one of the antenna 452, the transmitter 454, the multi-antenna transmitting processor 457, the transmitting processor 468, the controller/ processor 459, the memory 460, or the data source 467 in FIG. 4 of the present application.

In one embodiment, the first transmitter 1402B comprises at least first five of the antenna 452, the transmitter 454, the multi-antenna transmitting processor 457, the transmitting processor 468, the controller/ processor 459, the memory 460, and the data source 467 in FIG. 4 of the present application.

In one embodiment, the first transmitter 1402B comprises at least first four of the antenna 452, the transmitter 454, the multi-antenna transmitting processor 457, the transmitting processor 468, the controller/ processor 459, the memory 460, and the data source 467 in FIG. 4 of the present application.

In one embodiment, the first transmitter 1402B comprises at least first three of the antenna 452, the transmitter 454, the multi-antenna transmitting processor 457, the transmitting processor 468, the controller/ processor 459, the memory 460, and the data source 467 in FIG. 4 of the present application.

In one embodiment, the first transmitter 1402B comprises at least first two of the antenna 452, the transmitter 454, the multi-antenna transmitting processor 457, the transmitting processor 468, the controller/ processor 459, the memory 460, and the data source 467 in FIG. 4 of the present application.

In embodiment 14B, the first receiver 1401B receives a first signaling; the first transmitter 1402B transmits a first signal in a first time-frequency resource pool, and the first signal carries a third bit block and a fourth bit block; herein, the first signaling is used to determine the first time-frequency resource pool; the first time-frequency resource pool is reserved for the fourth bit block; a first bit block comprises first-type HARQ-ACK bit(s), and a second bit block comprises second-type HARQ-ACK bit(s); the second-type HARQ-ACK bit(s) comprised in the second bit block comprises CBG-based second-type HARQ-ACK bit(s); the first bit block and the second bit block are used to determine the third bit block; the first signaling is used to determine a first offset value; a first calculation amount is related to at least first two of a first offset value, a number of bit(s) comprised in the first bit block and a number of bit(s) comprised in the second bit block; when the first calculation amount is not greater than a second calculation amount, the third bit block comprises the CBG-based second-type HARQ-ACK bit(s) comprised in the second bit block; when the first calculation amount is greater than a second calculation amount, the third bit block does not comprise at least part of CBG-based second-type HARQ-ACK bit(s) in the second bit block and the third bit block comprises TB-based second-type HARQ-ACK bit(s) related to the second bit block.

In one embodiment, the first receiver 1401B monitors a first TB; herein, the first TB comprises multiple CBGs, the second bit block comprises multiple CBG-based second-type HARQ-ACK bits indicating whether the multiple CBGs in the first TB are correctly received; when the first calculation amount is not greater than the second calculation amount, the third bit block comprises the multiple CBG-based second-type HARQ-ACK bits indicating whether the multiple CBGs in the first TB are correctly received comprised in the second bit block; when the first calculation amount is greater than the second calculation amount, a number of the second-type HARQ-ACK bit(s) generated for the first TB comprised in the third bit block is equal to 1.

In one embodiment, the second calculation amount is equal to a minimum value between a result after a first intermediate quantity is rounding to an integer and a result after a second intermediate quantity is rounding to an integer; the first intermediate quantity is linearly associated with a number of bit(s) comprised in the first bit block.

In one embodiment, a priority corresponding to the fourth bit block is used to determine the first intermediate quantity.

In one embodiment, the first calculation amount is greater than the second calculation amount; the first bit block comprises a CBG-based first-type HARQ-ACK bit; the first offset value is used to determine a third calculation amount; when the third calculation amount is not greater than the second calculation amount, the third bit block comprises the CBG-based first-type HARQ-ACK bit comprised in the first bit block, and a number of the first-type HARQ-ACK bit(s) comprised in the third bit block is equal to a number of the first-type HARQ-ACK bit(s) comprised in the first bit block; when the third calculation amount is greater than the second calculation amount, a number of the first-type HARQ-ACK bit(s) comprised in the third bit block is less than a number of the first-type HARQ-ACK bit(s) comprised in the first bit block.

In one embodiment, the first-type HARQ-ACK bit corresponds to a first priority, and the second-type HARQ-ACK bit corresponds to a second priority; the first priority is different from the second priority.

In one embodiment, a first radio resource pool is reserved for at least one of the first bit block or the second bit block; the first radio resource pool overlaps with the first time-frequency resource pool in time domain.

In one embodiment, the first receiver 1401B monitors the first TB; the first receiver 1401B receives the first signaling; the first transmitter 1402B transmits the first signal in the first time-frequency resource pool, and the first signal carries the third bit block and the fourth bit block; the first signaling is used to determine the first time-frequency resource pool; the first time-frequency resource pool is reserved for the fourth bit block; the first bit block comprises the first-type HARQ-ACK bit, and the second bit block comprises the second-type HARQ-ACK bit; the second-type HARQ-ACK bit(s) comprised in the second bit block comprises CBG-based second-type HARQ-ACK bit(s); the first bit block and the second bit block are used to determine the third bit block; the first signaling is used to determine the first offset value; the first calculation amount is related to at least first two of a first offset value, a number of bit(s) comprised in the first bit block and a number of bit(s) comprised in the second bit block; the first TB comprises multiple CBGs, the second bit block comprises multiple CBG-based second-type HARQ-ACK bits indicating whether the multiple CBGs in the first TB are correctly received; when the first calculation amount is not greater than the second calculation amount, the third bit block comprises all CBG-based second-type HARQ-ACK bits comprised in the second bit block, and the third bit block comprises the multiple CBG-based second-type HARQ-ACK bits indicating whether the multiple CBGs in the first TB are correctly received comprised in the second bit block; when the first calculation amount is greater than the second calculation amount, the third bit block does not comprise at least partial the CBG-based second-type HARQ-ACK bit(s) in the second bit block, and a number of the HARQ-ACK bit(s) generated for the first TB comprised in the third bit block is equal to 1; the first-type HARQ-ACK bit corresponds to the first priority, and the second-type HARQ-ACK bit corresponds to the second priority; the first priority is different from the second priority.

In one subembodiment of the above embodiment, a priority index of the first priority is equal to 1, and a priority index of the second priority is equal to 0.

In one subembodiment of the above embodiment, a priority index of the first priority is equal to 0, and a priority index of the second priority is equal to 1.

In one subembodiment of the above embodiment, the first signal is transmitted in a PUSCH.

### Embodiment 15A

Embodiment 15A illustrates a structural block diagram of a processor in a second node, as shown in FIG. 15A. In FIG. 15A, a processor 1500A in a second node comprises a second transmitter 1501A and a second receiver 1502A.

In one embodiment, the second node 1500A is a UE.

In one embodiment, the second node 1500A is a base station.

In one embodiment, the second node 1500A is a relay node.

In one embodiment, the second node 1500A is a vehicle-mounted communication device.

In one embodiment, the second node 1500A is a UE supporting V2X communications.

In one embodiment, the second transmitter 1501A comprises at least one of the antenna 420, the transmitter 418, the multi-antenna transmitting processor 471, the transmitting processor 416, the controller/ processor 475 or the memory 476 in FIG. 4 of the present application.

In one embodiment, the second transmitter 1501A comprises at least the first five of the antenna 420, the transmitter 418, the multi-antenna transmitting processor 471, the transmitting processor 416, the controller/ processor 475 and the memory 476 in FIG. 4 of the present application.

In one embodiment, the second transmitter 1501A comprises at least the first four of the antenna 420, the transmitter 418, the multi-antenna transmitting processor 471, the transmitting processor 416, the controller/ processor 475 and the memory 476 in FIG. 4 of the present application.

In one embodiment, the second transmitter 1501A comprises at least the first three of the antenna 420, the transmitter 418, the multi-antenna transmitting processor 471, the transmitting processor 416, the controller/ processor 475 and the memory 476 in FIG. 4 of the present application.

In one embodiment, the second transmitter 1501A comprises at least the first two of the antenna 420, the transmitter 418, the multi-antenna transmitting processor 471, the transmitting processor 416, the controller/ processor 475 and the memory 476 in FIG. 4 of the present application.

In one embodiment, the second receiver 1502A comprises at least one of the antenna 420, the receiver 418, the multi-antenna receiving processor 472, the receiving processor 470, the controller/ processor 475 or the memory 476 in FIG. 4 of the present application.

In one embodiment, the second receiver 1502A comprises at least first five of the antenna 420, the receiver 418, the multi-antenna receiving processor 472, the receiving processor 470, the controller/ processor 475 and the memory 476 in FIG. 4 of the present application.

In one embodiment, the second receiver 1502A comprises at least first four of the antenna 420, the receiver 418, the multi-antenna receiving processor 472, the receiving processor 470, the controller/ processor 475 and the memory 476 in FIG. 4 of the present application.

In one embodiment, the second receiver 1502A comprises at least first three of the antenna 420, the receiver 418, the multi-antenna receiving processor 472, the receiving processor 470, the controller/ processor 475 and the memory 476 in FIG. 4 of the present application.

In one embodiment, the second receiver 1502A comprises at least first two of the antenna 420, the receiver 418, the multi-antenna receiving processor 472, the receiving processor 470, the controller/ processor 475 and the memory 476 in FIG. 4 of the present application.

In embodiment 15A, the second transmitter 1501A transmits a first signaling; the second receiver 1502A, receives a first signal in a first radio resource pool, and the first signal carries a first bit block and a second bit block; herein, the first signaling is used to determine the first radio resource pool; a first condition is a condition related to a size relation between a first number and a first threshold, and at least one of a number of bit(s) comprised in the first bit block or a number of bit(s) comprised in the second bit block is used to determine the first number; a third bit block is used to generate the first signal, the first bit block and the second bit block are used to generate the third bit block, and whether the first condition is met is used to determine whether bit(s) in the first bit block and bit(s) in the second bit block are separately input into different channel codings to obtain the third bit block.

In one embodiment, the first number is equal to a number of bit(s) comprised in the second bit block; the first condition comprises: the number of bit(s) comprised in the second bit block is not greater than the first threshold.

In one embodiment, when the first condition is met, the third bit block comprises outputs after all bits in the first bit block and all bits in the second bit block are input into a same channel coding; when the first condition is not met, the third bit block comprises outputs after bit(s) in the first bit block and bit(s) in the second bit block are separately input into different channel codings.

In one embodiment, when the first condition is met, the third bit block comprises all bits in the first bit block and all bits in the second bit block; when the first condition is not met, the third bit block comprises outputs after bit(s) in the first bit block and bit(s) in the second bit block are separately input into different channel codings.

In one embodiment, a second condition is a condition related to a size relation between a second number and a second threshold, and at least one of a number of bit(s) comprised in the first bit block or a number of bit(s) comprised in the second bit block is used to determine the second number; whether the second condition is met is used to determine whether a sum of a number of bit(s) comprised in the first bit block and a number of bit(s) comprised in the second bit block or a third number is used to determine a first radio resource pool set, the third number is equal to a number of bit(s) comprised in the first bit block plus a first intermediate quantity, and a number of bit(s) comprised in the second bit block is used to determine the first intermediate quantity; the first radio resource pool set comprises the first radio resource pool.

In one embodiment, the second transmitter 1501A transmits a first signaling group; herein, the first signaling group comprises the first signaling; herein, two signalings in the first signaling group are respectively used to determine the first bit block and the second bit block.

In one embodiment, a third radio resource pool is reserved for the first bit block, and a second radio resource pool is reserved for the second bit block; the third radio resource pool and the second radio resource pool are overlapping in time domain.

### Embodiment 15B

Embodiment 15B illustrates a structural block diagram of a processor in a second node, as shown in FIG. 15B. In FIG. 15B, a processor 1500B in a second node comprises a second transmitter 1501B and a second receiver 1502B.

In one embodiment, the second node 1500B is a UE.

In one embodiment, the second node 1500B is a base station.

In one embodiment, the second node 1500B is a relay node.

In one embodiment, the second node 1500B is a vehicle-mounted communication device.

In one embodiment, the second node 1500B is a UE that supports V2X communications.

In one embodiment, the second transmitter 1501B comprises at least one of the antenna 420, the transmitter 418, the multi-antenna transmitting processor 471, the transmitting processor 416, the controller/ processor 475 and the memory 476 in FIG. 4 of the present application.

In one embodiment, the second transmitter 1501B comprises at least first five of the antenna 420, the transmitter 418, the multi-antenna transmitting processor 471, the transmitting processor 416, the controller/ processor 475 and the memory 476 in FIG. 4 of the present application.

In one embodiment, the second transmitter 1501B comprises at least the first five of the antenna 420, the transmitter 418, the multi-antenna transmitting processor 471, the transmitting processor 416, the controller/ processor 475 and the memory 476 in FIG. 4 of the present application.

In one embodiment, the second transmitter 1501B comprises at least the first three of the antenna 420, the transmitter 418, the multi-antenna transmitting processor 471, the transmitting processor 416, the controller/ processor 475 and the memory 476 in FIG. 4 of the present application.

In one embodiment, the second transmitter 1501B comprises at least the first two of the antenna 420, the transmitter 418, the multi-antenna transmitting processor 471, the transmitting processor 416, the controller/ processor 475 and the memory 476 in FIG. 4 of the present application.

In one embodiment, the second receiver 1502B comprises at least one of the antenna 420, the receiver 418, the multi-antenna receiving processor 472, the receiving processor 470, the controller/ processor 475 or the memory 476 in FIG. 4 of the present application.

In one embodiment, the second receiver 1502B comprises at least first five of the antenna 420, the receiver 418, the multi-antenna receiving processor 472, the receiving processor 470, the controller/ processor 475 and the memory 476 in FIG. 4 of the present application.

In one embodiment, the second receiver 1502B comprises at least first four of the antenna 420, the receiver 418, the multi-antenna receiving processor 472, the receiving processor 470, the controller/ processor 475 and the memory 476 in FIG. 4 of the present application.

In one embodiment, the second receiver 1502B comprises at least first three of the antenna 420, the receiver 418, the multi-antenna receiving processor 472, the receiving processor 470, the controller/ processor 475 and the memory 476 in FIG. 4 of the present application.

In one embodiment, the second receiver 1502B comprises at least first two of the antenna 420, the receiver 418, the multi-antenna receiving processor 472, the receiving processor 470, the controller/ processor 475 and the memory 476 in FIG. 4 of the present application.

In embodiment 15B, the second transmitter 1501B transmits a first signaling; the second receiver 1502B, receives a first signal in a first time-frequency resource pool, and the first signal carries a third bit block and a fourth bit block; herein, the first signaling is used to determine the first time-frequency resource pool; the first time-frequency resource pool is reserved for the fourth bit block; a first bit block comprises first-type HARQ-ACK bit(s), and a second bit block comprises second-type HARQ-ACK bit(s); the second-type HARQ-ACK bit(s) comprised in the second bit block comprises CBG-based second-type HARQ-ACK bit(s); the first bit block and the second bit block are used to determine the third bit block; the first signaling is used to determine a first offset value; a first calculation amount is related to at least first two of a first offset value, a number of bit(s) comprised in the first bit block and a number of bit(s) comprised in the second bit block; when the first calculation amount is not greater than a second calculation amount, the third bit block comprises the CBG-based second-type HARQ-ACK bit(s) comprised in the second bit block; when the first calculation amount is greater than a second calculation amount, the third bit block does not comprise at least part of CBG-based second-type HARQ-ACK bit(s) in the second bit block and the third bit block comprises TB-based second-type HARQ-ACK bit(s) related to the second bit block.

In one embodiment, the second transmitter 1501B transmits a first TB; herein, the first TB comprises multiple CBGs, the second bit block comprises multiple CBG-based second-type HARQ-ACK bits indicating whether the multiple CBGs in the first TB are correctly received; when the first calculation amount is not greater than the second calculation amount, the third bit block comprises the multiple CBG-based second-type HARQ-ACK bits indicating whether the multiple CBGs in the first TB are correctly received comprised in the second bit block; when the first calculation amount is greater than the second calculation amount, a number of the second-type HARQ-ACK bit(s) generated for the first TB comprised in the third bit block is equal to 1.

In one embodiment, the second calculation amount is equal to a minimum value between a result after a first intermediate quantity is rounding to an integer and a result after a second intermediate quantity is rounding to an integer; the first intermediate quantity is linearly associated with a number of bit(s) comprised in the first bit block.

In one embodiment, a priority corresponding to the fourth bit block is used to determine the first intermediate quantity.

In one embodiment, the first calculation amount is greater than the second calculation amount; the first bit block comprises a CBG-based first-type HARQ-ACK bit; the first offset value is used to determine a third calculation amount; when the third calculation amount is not greater than the second calculation amount, the third bit block comprises the CBG-based first-type HARQ-ACK bit comprised in the first bit block, and a number of the first-type HARQ-ACK bit(s) comprised in the third bit block is equal to a number of the first-type HARQ-ACK bit(s) comprised in the first bit block; when the third calculation amount is greater than the second calculation amount, a number of the first-type HARQ-ACK bit(s) comprised in the third bit block is less than a number of the first-type HARQ-ACK bit(s) comprised in the first bit block.

In one embodiment, the first-type HARQ-ACK bit corresponds to a first priority, and the second-type HARQ-ACK bit corresponds to a second priority; the first priority is different from the second priority.

In one embodiment, a first radio resource pool is reserved for at least one of the first bit block or the second bit block; the first radio resource pool overlaps with the first time-frequency resource pool in time domain.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or multiple integrated circuits. Correspondingly, each module unit in the above embodiment may be realized in the form of hardware, or in the form of software function modules. The first node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts and other wireless communication devices. The second node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts and other wireless communication devices. The UE or terminal in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts, etc. The base station or network side equipment in the present application includes but is not limited to macro-cellular base stations, microcellular base stations, home base stations, relay base station, eNB, gNB, Transmitter Receiver Point (TRP), GNSS, relay satellites, satellite base stations, space base stations, test device, test equipment, test instrument and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling; and
a first transmitter, transmitting a first signal in a first radio resource pool, the first signal carrying a first bit block and a second bit block;
wherein the first signaling is used to determine the first radio resource pool; a first condition is a condition related to a size relation between a first number and a first threshold, and at least one of a number of bit(s) comprised in the first bit block or a number of bit(s) comprised in the second bit block is used to determine the first number; a third bit block is used to generate the first signal, the first bit block and the second bit block are used to generate the third bit block, and whether the first condition is met is used to determine whether bit(s) in the first bit block and bit(s) in the second bit block are separately input into different channel codings to obtain the third bit block.

2. The first node according to claim 1, wherein the first number is equal to a sum of a number of bit(s) comprised in the first bit block and a number of bit(s) comprised in the second bit block; the first condition comprises: the first number is not greater than the first threshold; the first threshold is equal to 2.

3. The first node according to claim 2, wherein when the first condition is met, the third bit block comprises all bits in the first bit block and all bits in the second bit block; when the first condition is not met, the third bit block comprises outputs after bit(s) in the first bit block and bit(s) in the second bit block are separately input into different channel codings.

4. The first node according to claim 3, wherein when the first condition is met: all bits in the first bit block and all bits in the second bit block are used to generate the first signal through sequence modulation.

5. The first node according to claim 4, wherein the first radio resource pool is reserved for a PUCCH, and the first signal is transmitted in the PUCCH; the PUCCH adopts PUCCH format 1, or one of PUCCH format 2, PUCCH format 3, or PUCCH format 4.

6. The first node according to claim 5, wherein the first bit block comprises a first-type HARQ-ACK, and the second bit block comprises a second-type HARQ-ACK; the second-type HARQ-ACK bit(s) and the first-type HARQ-ACK bit(s) are respectively HARQ-ACK bits corresponding to different priority indexes.

7. The first node according to claim 1, wherein the second bit block comprises Hybrid Automatic Repeat reQuest ACKnowledgement (HARQ-ACK) bit(s), the first bit block comprises Scheduling Request (SR) bit(s), and the first condition comprises: a number of bit(s) comprised in the second bit block is not greater than the first threshold; when a number of bit(s) comprised in the second bit block is not greater than the first threshold, the third bit block comprises all bits in the first bit block and all or partial bits in the second bit block; when a number of bit(s) comprised in the second bit block is greater than the first threshold, the third bit block comprises outputs after bit(s) in the first bit block and bit(s) in the second bit block are separately input into different channel codings.

8. A second node for wireless communications, comprising:
a second transmitter, transmitting a first signaling; and
a second receiver, receiving a first signal in a first radio resource pool, the first signal carrying a first bit block and a second bit block;
wherein the first signaling is used to determine the first radio resource pool; a first condition is a condition related to a size relation between a first number and a first threshold, and at least one of a number of bit(s) comprised in the first bit block or a number of bit(s) comprised in the second bit block is used to determine the first number; a third bit block is used to generate the first signal, the first bit block and the second bit block are used to generate the third bit block, and whether the first condition is met is used to determine whether bit(s) in the first bit block and bit(s) in the second bit block are separately input into different channel codings to obtain the third bit block.

9. The second node according to claims 8, wherein the first number is equal to a sum of a number of bit(s) comprised in the first bit block and a number of bit(s) comprised in the second bit block; the first condition comprises: the first number is not greater than the first threshold; the first threshold is equal to 2.

10. The second node according to claim 9, wherein when the first condition is met, the third bit block comprises all bits in the first bit block and all bits in the second bit block; when the first condition is not met, the third bit block comprises outputs after bit(s) in the first bit block and bit(s) in the second bit block are separately input into different channel codings.

11. The second node according to claim 10, wherein when the first condition is met: all bits in the first bit block and all bits in the second bit block are used to generate the first signal through sequence modulation.

12. The second node according to claim 11, wherein the first radio resource pool is reserved for a PUCCH, and the first signal is transmitted in the PUCCH; the PUCCH adopts PUCCH format 1, or one of PUCCH format 2, PUCCH format 3, or PUCCH format 4.

13. The second node according to claim 12, wherein the first bit block comprises a first-type HARQ-ACK, and the second bit block comprises a second-type HARQ-ACK; the second-type HARQ-ACK bit(s) and the first-type HARQ-ACK bit(s) are respectively HARQ-ACK bits corresponding to different priority indexes.

14. A method in a first node for wireless communications, comprising:
receiving a first signaling; and
transmitting a first signal in a first radio resource pool, the first signal carrying a first bit block and a second bit block;
wherein the first signaling is used to determine the first radio resource pool; a first condition is a condition related to a size relation between a first number and a first threshold, and at least one of a number of bit(s) comprised in the first bit block or a number of bit(s) comprised in the second bit block is used to determine the first number; a third bit block is used to generate the first signal, the first bit block and the second bit block are used to generate the third bit block, and whether the first condition is met is used to determine whether bit(s) in the first bit block and bit(s) in the second bit block are separately input into different channel codings to obtain the third bit block.

15. The method in a first node according to claim 14, wherein the first number is equal to a sum of a number of bit(s) comprised in the first bit block and a number of bit(s) comprised in the second bit block; the first condition comprises: the first number is not greater than the first threshold; the first threshold is equal to 2.

16. The method in a first node according to claim 15, wherein when the first condition is met, the third bit block comprises all bits in the first bit block and all bits in the second bit block; when the first condition is not met, the third bit block comprises outputs after bit(s) in the first bit block and bit(s) in the second bit block are separately input into different channel codings.

17. The method in a first node according to claim 16, wherein when the first condition is met: all bits in the first bit block and all bits in the second bit block are used to generate the first signal through sequence modulation.

18. The method in a first node according to claim 17, wherein the first radio resource pool is reserved for a PUCCH, and the first signal is transmitted in the PUCCH; the PUCCH adopts PUCCH format 1, or one of PUCCH format 2, PUCCH format 3, or PUCCH format 4.

19. The method in a first node according to claim 18, wherein the first bit block comprises a first-type HARQ-ACK, and the second bit block comprises a second-type HARQ-ACK; the second-type HARQ-ACK bit(s) and the first-type HARQ-ACK bit(s) are respectively HARQ-ACK bits corresponding to different priority indexes.

20. The method in a first node according to claim 14, wherein the second bit block comprises Hybrid Automatic Repeat reQuest ACKnowledgement (HARQ-ACK) bit(s), the first bit block comprises Scheduling Request (SR) bit(s), and the first condition comprises: a number of bit(s) comprised in the second bit block is not greater than the first threshold; when a number of bit(s) comprised in the second bit block is not greater than the first threshold, the third bit block comprises all bits in the first bit block and all or partial bits in the second bit block; when a number of bit(s) comprised in the second bit block is greater than the first threshold, the third bit block comprises outputs after bit(s) in the first bit block and bit(s) in the second bit block are separately input into different channel codings.
